(19) United States
(12) Patent Application Publication
(10) Pub. No.: US 2026/0252028 A1
(43) Pub. Date: Aug. 27, 2026

(54) DETACHABLE CARTRIDGE

(71) Applicant: CANON KABUSHIKI KAISHA, Tokyo (JP)

(72) Inventors: AKINOBU HIRAYAMA, Shizuoka (JP); TERUHIKO SASAKI, Shizuoka (JP); TAKANORI YAMAMOTO, Shizuoka (JP); YOSHIYUKI YAMAZAKI, Okinawa (JP); OSAMU NAGASAKI, Shizuoka (JP); MOTOHIRO FURUSAWA, Shizuoka (JP)

(21) Appl. No.: 19/549,452

(22) Filed: Feb. 25, 2026

(30) Foreign Application Priority Data
Feb. 27, 2025 (JP) 2025-030775

(51) Int. Cl. G03G 21/18

(52) U.S. Cl. CPC G03G 21/1814; G03G 21/1828; G03G 21/1857; G03G 21/1867

(57) ABSTRACT

A cartridge includes a frame; a photosensitive drum supported by the frame so as to be rotatable about a rotational axis thereof; a cleaning member for removing residual toner on the photosensitive drum; a charging roller for electrically charging a surface of the photosensitive drum; a developing roller for developing an electrostatic latent image on the photosensitive drum by supplying toner to the photosensitive drum; a residual toner conveying member for conveying the residual toner, removed by the cleaning member in a direction of the rotational axis; and a residual toner accommodating portion for accommodating the residual toner conveyed by the residual toner conveying member and detachably mounted to the frame. The residual toner accommodating portion includes a receiving opening, in a part thereof in the direction of the rotational axis, for receiving the residual toner conveyed by the residual toner conveying member.

### BACKGROUND

### Field of the Technology

The present disclosure relates to a cartridge detachably mountable to an electrophotographic image forming apparatus.

### Description of the Related Art

The electrophotographic image forming apparatus forms an image on a recording medium by using an electrophotographic image forming scheme. As an example of the electrophotographic image forming apparatus, for example, an electrophotographic copying machine, an electrophotographic printer (LED printer, laser beam printer, or the like), a facsimile apparatus, a word processor, and the like are included.

In the electrophotographic image forming apparatus (hereinafter, simply referred also to an "image forming apparatus"), a toner image is formed on an electrophotographic photosensitive member (photosensitive drum or drum), and the toner image is directly or indirectly transferred onto the recording medium, so that the image is formed on a recording material.

In general, in such an image forming apparatus, supply of toner (developer), maintenance of various members, and the like are performed. Therefore, there is an image forming apparatus of a cartridge type in which the supply of the toner, the maintenance, and the like are capable of being performed by employing a constitution in which a cartridge is detachably mountable to the image forming apparatus and then by exchanging the cartridge.

The cartridge includes the drum or at least one of a process means and is detachably (removably) mounted to a main assembly (apparatus main assembly) of the image forming apparatus. The process means is a means for carrying out image formation, and as the means acting on the drum, it is possible to cite a developing means, a charging means, a transfer means, a discharging means, a cleaning means, and the like, in the main. As an example of the cartridge, it is possible to cite a process cartridge including the drum and at least one of the process means and in which these are integrally made detachably mountable to the apparatus main assembly, a drum cartridge including the drum, a developing cartridge including the developing means, and the like cartridge. According to such a cartridge type, it becomes possible to simply perform toner supply and maintenance of the image forming apparatus.

According to U.S. Patent Application Publication No. US2023/0138063, a cartridge device constituted so that a toner accommodating portion for accommodating perpendicular to is made detachably mountable to a cartridge module is disclosed. The cartridge module includes a developing cartridge and a toner cartridge, and the toner accommodating portion is detachably mounted to a frame of the developing cartridge.

### SUMMARY

The present disclosure is directed to develop a cartridge.

According to some embodiments of the present disclosure, a cartridge includes a frame; a photosensitive drum supported by the frame so as to be rotatable about a rotational axis thereof; a cleaning member configured to remove residual toner on the photosensitive drum; a charging roller configured to electrically charge a surface of the photosensitive drum; a developing roller configured to develop an electrostatic latent image on the photosensitive drum by supplying toner to the photosensitive drum; a residual toner conveying member configured to convey the residual toner removed by the cleaning member in a direction of the rotational axis; and a residual toner accommodating portion configured to accommodate the residual toner conveyed by the residual toner conveying member and detachably mounted to the frame, wherein the residual toner accommodating portion includes a receiving opening, in a part thereof in the direction of the rotational axis, for receiving the residual toner conveyed by the residual toner conveying member.

According to another aspect of the present disclosure, a cartridge includes a frame; a photosensitive drum supported by the frame so as to be rotatable about a rotational axis thereof; a cleaning member configured to remove residual toner on the photosensitive member; a charging roller configured to electrically charge a surface of the photosensitive drum; a developing roller configured to develop an electrostatic latent image on the photosensitive drum by supplying toner to the photosensitive drum; a residual toner conveying member configured to convey the residual toner removed by the cleaning member in a direction of the rotational axis; and a residual toner accommodating portion configured to accommodate the residual toner conveyed by the residual toner conveying member and detachably mounted to the frame, wherein the residual toner accommodating portion includes a receiving opening for receiving the residual toner conveyed by the residual toner conveying member, and wherein as viewed in the direction of the rotational axis, of four regions obtained by division with a first rectilinear line passing through a center of the charging roller and a center of the photosensitive drum and a second rectilinear passing through a contact point between the charging roller and the photosensitive drum and perpendicular to the first rectilinear line, the receiving opening is provided only in the region in which the developing roller and the charging roller are absent.

According to the present disclosure, the cartridge is capable of being developed.

Features of the present disclosure will become apparent from the following description of embodiments with reference to the attached drawings. The following description of embodiments are described by way of example.

### BRIEF DESCRIPTION OF THE DRAWINGS

Part (a) of FIG. 1 is a perspective view showing an image forming apparatus according to an embodiment in a state in which a process cartridge and a toner cartridge are demounted from an apparatus main assembly, and part (b) of FIG. 1 is a perspective view showing the image forming apparatus in a state in which a front door is closed.

FIG. 2 is a sectional view showing an apparatus main assembly in which the process cartridge and the toner cartridge are mounted.

FIG. 3 is a sectional view showing the process cartridge and the toner cartridge.

FIG. 4 is a perspective view showing the process cartridge and the toner cartridge.

FIG. 5 is a side view showing a state in which the process cartridge and the toner cartridge are mounted in the apparatus main assembly.

FIG. 6 is a partially sectional view showing a contact (point) unit of the process cartridge.

FIG. 7 is a perspective view showing a main assembly contact (point) unit of the apparatus main assembly.

Part (a) of FIG. 8 is a partially sectional view showing a state during mounting of the contact unit to the main assembly contact unit, and part (b) of FIG. 8 is a sectional view showing a state in which the mounting of the contact unit to the main assembly contact unit is completed.

FIG. 9 is a sectional view showing the process cartridge.

Part (a) of FIG. 10 is a perspective view showing a cleaning frame, part (b) of FIG. 10 is another perspective view showing the cleaning frame, part (c) of FIG. 1 is another perspective view showing the cleaning frame, and part (d) of FIG. 10 is another perspective view showing the cleaning frame.

FIG. 11 is an enlarged perspective view in which a neighborhood of a discharge opening of the cleaning frame shown in part (c) of FIG. 10 is enlarged.

Part (a) of FIG. 12 is an exploded perspective view showing the cleaning frame and a leaf spring, and part (b) of FIG. 12 is a perspective view showing a state in which the leaf spring is assembled into the cleaning frame.

Part (a) of FIG. 13 is an exploded perspective view showing a state immediately before a first idler gear and a second idler gear are mounted to the cleaning frame, and part (b) of FIG. 13 is a perspective view showing a state in which the first idler gear and the second idler gear are mounted to the cleaning frame.

Part (a) of FIG. 14 is an exploded perspective view showing a state immediately before a discharge shutter is assembled to the cleaning frame, and part (b) of FIG. 14 is a perspective view showing a state in which the discharge shutter is assembled to the cleaning frame.

FIG. 15 is a perspective view showing a residual toner conveying member.

Part (a) of FIG. 16 is a sectional view showing a process in which the residual toner conveying member is assembled to the cleaning frame, part (b) of FIG. 16 is a sectional view showing the process in which the residual toner conveying member is assembled to the cleaning frame, and part (c) of FIG. 16 is a sectional view showing the process in which the residual toner conveying member is assembled to the cleaning frame.

FIG. 17 is an exploded perspective view showing a state in which a residual toner gear is assembled to the residual toner conveying member.

FIG. 18 is a perspective view showing a side cover.

FIG. 19 is a sectional view showing a cleaning unit including the residual toner conveying member.

Part (a) of FIG. 20 is a perspective view showing a residual toner frame, and part (b) of FIG. 20 is another perspective view showing the residual toner frame.

FIG. 21 is a perspective view showing a periphery of a receiving opening of the residual toner frame.

Part (a) of FIG. 22 is an exploded perspective view showing the residual toner frame, a residual toner shutter, and a torsion coil spring, and part (b) of FIG. 22 is a perspective view showing a state in which the residual toner shutter and the torsion coil spring are assembled to the residual toner frame.

FIG. 23 is a perspective view showing a stirring member to be mounted to the residual toner frame.

FIG. 24 is an exploded perspective view showing a state in which the stirring member is being mounted to the residual toner frame.

FIG. 25 is an exploded perspective view showing the residual toner frame, a cylindrical seal, a stirring gear, and the side cover.

FIG. 26 is an exploded perspective view showing a residual toner lid and respective (component) parts to be assembled to the residual toner lid.

FIG. 27 is an exploded perspective view for illustrating mounting of the residual toner lid to the residual toner frame.

FIG. 28 is an exploded perspective view showing mounting of a residual toner unit to the cleaning unit.

Part (a) of FIG. 29 is a sectional view for illustrating an operation in a mounting process of the residual toner unit to the cleaning unit, part (b) of FIG. 29 is a sectional view for illustrating the operation in the mounting process of the residual toner unit to the cleaning unit, part (c) of FIG. 29 is a sectional view for illustrating the operation in the mounting process of the residual toner unit to the cleaning unit, and part (d) of FIG. 29 is a sectional view showing a state in which mounting of the residual toner unit to the cleaning unit is completed.

FIG. 30 is a sectional view showing the residual toner unit in a state in which the residual toner unit is positioned to the cleaning unit.

FIG. 31 is a perspective view showing the residual toner unit in a state in which the residual toner lid is omitted.

Part (a) of FIG. 32 is a sectional view showing a 32A-32A cross section of FIGS. 31, and part (b) of 32, showing a 32B-32B cross sectional of FIG. 31.

Part (a) of FIG. 33 is a sectional view showing the residual toner unit during deposition of residual toner, and part (b) of FIG. 33 is a sectional view showing the residual toner unit in a full state of the residual toner.

FIG. 34 is a sectional view showing a cleaning frame of a cleaning unit according to a second embodiment.

Part (a) of FIG. 35 is a perspective view showing the cleaning frame, and part (b) of FIG. 35 is an enlarged perspective view showing a residual toner discharging member and a seal member.

FIG. 36 is a perspective view of the cleaning frame.

FIG. 37 is an exploded perspective view showing the residual toner discharging member and a discharging shutter.

Part (a) of FIG. 38 is a perspective view showing the discharging shutter, and part (b) of FIG. 38 is a sectional view showing the discharging shutter.

FIG. 39 is a perspective view showing a residual toner conveying member.

FIG. 40 is an exploded perspective view showing assembling of a conveying gear to the cleaning frame.

FIG. 41 is a sectional view showing the residual toner conveying member in a state in which the residual toner conveying member is assembled to a residual toner chamber.

FIG. 42 is an exploded perspective view showing a residual toner unit.

FIG. 43 is an exploded perspective view showing a state in which the residual toner unit is mounted to the cleaning unit in a Z2 direction.

Part (a) of FIG. 44 is a plan view showing a state in which the residual toner unit is being mounted to the cleaning unit in an X2 direction, and part (b) of FIG. 44 is a plan view showing a state in which mounting of the residual toner unit to the cleaning unit in the X2 direction is completed.

FIG. 45 is a sectional view showing a state in which the mounting of the residual toner unit to the cleaning unit is completed.

### DESCRIPTION OF THE EMBODIMENTS

### First embodiment

Part (a) of FIG. 1 is a perspective view showing an image forming apparatus 1 in a state in which a process cartridge B and a toner cartridge C according to this embodiment are demounted from an apparatus main assembly A. Part (b) of FIG. 1 is a perspective view showing the image forming apparatus 1 in a state in which a front door 600 is closed. In this embodiment, the image forming apparatus 1 is a monochromatic laser printer. Incidentally, dimensions, materials, shapes, relative arrangements, and the like of a constituent parts according to the image forming apparatus described in the following embodiments should be appropriately changed depending on constitution and various conditions of devices (apparatuses) to which the present disclosure is applied. Accordingly, the scope of the present disclosure is not limited thereto unless otherwise particularly specified.

In the following description and drawings, an up-down direction in the case where the image forming apparatus 1 is installed on a horizontal surface is referred to as a Z axis direction. A rotational axis direction of the photosensitive drum 43 provided in the image forming apparatus 1 is referred to as an X axis direction. A direction crossing the Z axis direction and the X axis direction is referred to as a Y axis direction. The X axis direction, the Y axis direction, and the Z axis direction may preferably be perpendicular to each other. Further, one side (direction from a right side toward a left side of the X axis direction is referred to as an X1 direction, and the other side (direction from the left side toward the right side of the X axis direction is referred to as an X2 direction. Similarly, one side (direction from a rear side toward a front side) of the Y axis direction is referred to as a Y1 direction, and the other side (direction from the front side toward the rear side) of the Y axis direction is referred to as a Y2 direction. One side (direction from a lower side toward an upper side) of the Z axis direction is referred to as a Z1 direction, and the other side (direction from the upper side toward the lower side) of the Z axis direction is referred to as a Z2 direction.

The Y1 direction can also be referred to as a front surface side (front side) of the image forming apparatus 1. Further, on the basis of a state in which the image forming apparatus 1 is viewed from the front surface side, an X2 direction side can be referred to as the right side, and an X1 direction side can be referred to as the left side.

Further, in the case where the process cartridge B and the toner cartridge C are mounted in the apparatus main assembly A, X axes (X1 and X2 directions), Y axes (Y1 and Y2 directions), and Z axis (Z1 and Z2 directions) of the apparatus main assembly A, the process cartridge B, and the toner cartridge C coincide with each other.

### General constitution of image forming apparatus

As shown in parts (a) and (b) of FIG. 1, the image forming apparatus 1 according to this embodiment includes the apparatus main assembly A. On the front side of the image forming apparatus 1, the front door 600 is provided and is constituted so as to be rotatable about a rotational example F. A user grips a gripping portion 602 provided on a side opposite from the rotational axis F of the front door 600, and is capable of opening and closing the front door 600 in an H direction. The direction is a direction along the horizontal direction.

When the front door 600 is opened, a space G for accommodating the process cartridge B and the toner cartridge C is exposed. The process cartridge B and the toner cartridge C are constituted so as to be detachably mountable to the apparatus main assembly A in a J direction. The J direction is a direction along the horizontal direction. The rotational axis F of the front door 600 extends along a gravitational direction (vertical direction) and extends in a direction crossing the J direction which is a mounting/demounting direction of the process cartridge B and the toner cartridge C. In addition, the rotational axis F of the front door 600 extends so as to cross a direction of a rotational axis E of the photosensitive drum 43 includes in the process cartridge B described later.

In other words, in this embodiment, the rotation al axis F extends in the Z axis direction, the rotational axis E of the photosensitive drum 43 extends in the X axis direction, and the J direction which is the mounting/demounting direction of the process cartridge B and the toner cartridge C is parallel to the Y axis direction. That is, the direction of the rotational axis E is the Z axis direction. Details of the mounting/demounting direction and the constitution of the process cartridge B and the toner cartridge C relative to the apparatus main assembly A will be described later.

The apparatus main assembly A includes an operating panel 500. The operating panel 500 is provided in an upper portion of the front door 600. Further the operating panel 500 is disposed close to the rotational axis F of the front door 600. By adopting this arrangement, it becomes easy that the user performs an opening/closing operation of the front door 600.

The operating panel 500 includes a display portion 501 and a power source switch 502 of the apparatus main assembly A. The display portion 501 is capable of performing display for notifying the user of exchange of the process cartridge B and the toner cartridge C and error display such as an occurrence of a paper jam, and is capable of displaying information such as during printing or print completion, which is a state of the apparatus main assembly A.

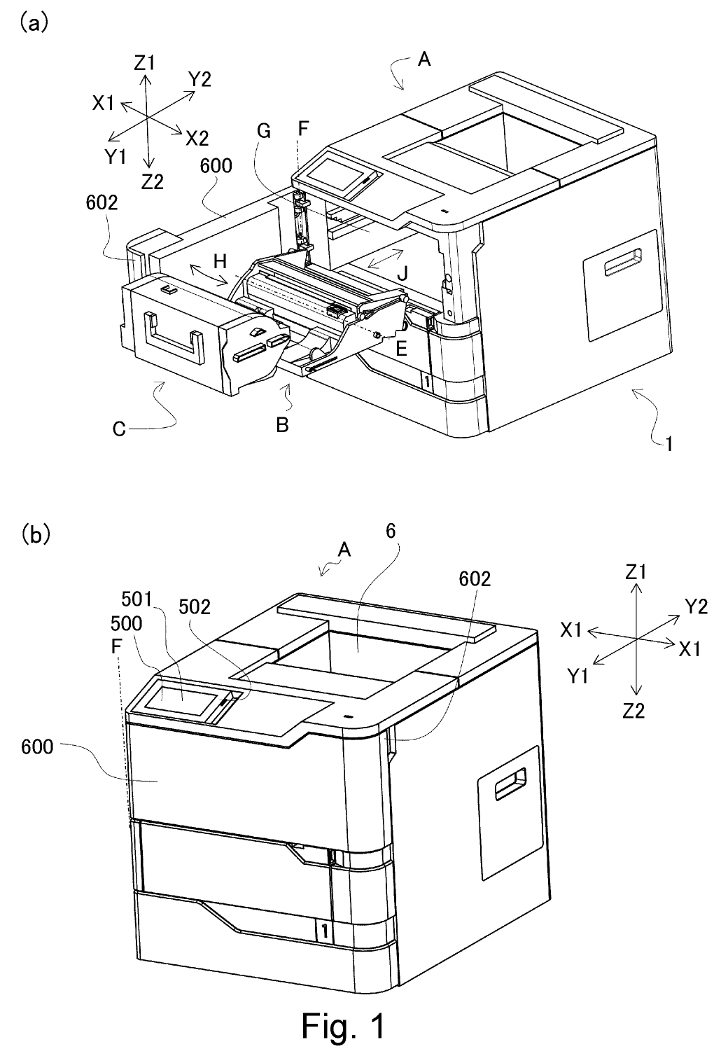

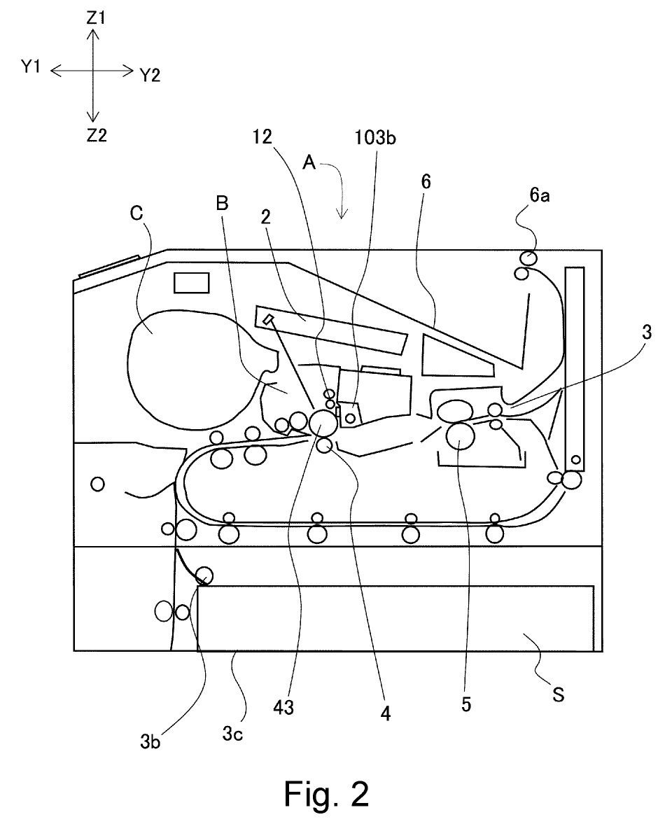

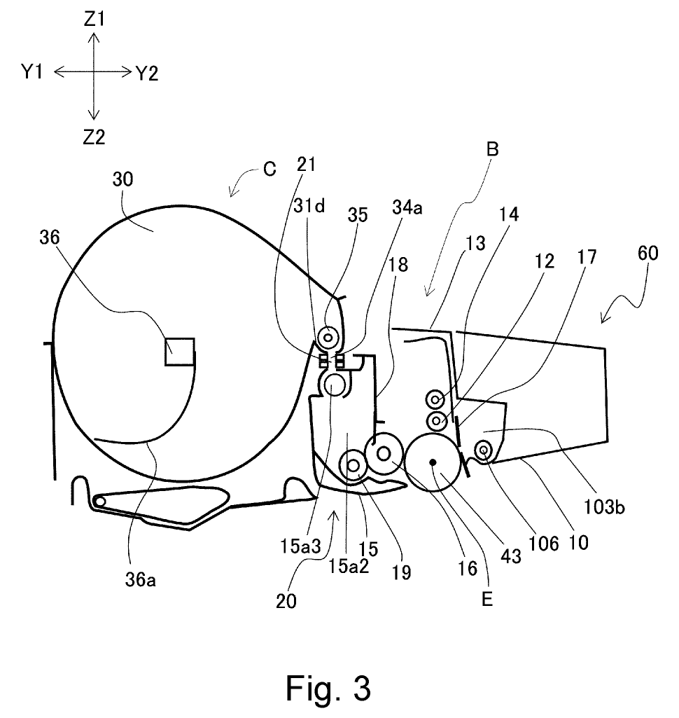

Next, the apparatus main assembly A, the process cartridge B, and the toner cartridge C will be described with reference to FIGS. 2 and 3. FIG. 2 is a sectional view showing the apparatus main assembly A in which the process cartridge B and the toner cartridge C are mounted. FIG. 3 is a sectional view showing the process cartridge B and the toner cartridge C.

As shown in FIG. 2, the apparatus main assembly A is provided with a feeding roller 3b for feeding a sheet to a sheet feeding path 3, a transfer roller 4, a fixing portion 5, and a laser scanner 2. As shown in FIG. 3, the process cartridge C as a cartridge includes a cleaning unit 60 provided the photosensitive drum 43 as an image bearing member and includes a developing unit 20.

The developing unit 20 includes a developer accommodating portion 15a2 for accommodating toner (developer), a developing roller 16 for carrying the toner, a developing blade 18, and a supplying roller 19 for supplying the toner to the developing roller 16. The developing roller 16 supplies the toner to the photosensitive drum 43 and develops an electrostatic latent image formed on the photosensitive drum 43. The developing blade 18 regulates an amount of the toner deposition a surface of the developing roller 16 in contact with the surface of the developing roller 16. In addition, the developing blade imparts triboelectric charge to the toner. That is, the developing blade 18 adjusts the amount of the toner on the developing roller 16.

Incidentally, as regards the toner in the developer accommodating portion 15a2, a remaining amount thereof is detected by an unshown remaining amount detecting portion. When the toner amount in the developer accommodating portion 15a2 becomes a certain value or less, the toner is supplied from the toner cartridge C to the developer accommodating portion 15a2 through a supply opening 21 and a toner receiving chamber 15a3.

The toner cartridge C includes a toner accommodating portion 30 for accommodating the toner to the supplied to the process cartridge B. Further, the toner cartridge C includes a screw member 35 for conveying the toner toward a toner discharge opening 34a of the toner accommodating portion 30 and a stirring and conveying unit 36 for conveying the toner toward the screw member 35. The toner accommodating portion 30 includes a curved shape portion 31d having the substantially same inner diameter as a screw diameter of the screw member 35 in a portion thereof corresponding to a screw portion of the screw member 35. In a part of the curved shape portion 31d, the toner discharge opening 34a is provided.

In a state in which the process cartridge B and the toner cartridge C are mounted in the apparatus main assembly A, the toner discharge opening 34a of the toner cartridge C and the supply opening 21 of the process cartridge B are connected with each other by a toner seal so that the toner is not leaked, and are communicated with each other. By this, the toner discharged through the toner discharge opening 34a is supplied to the developer accommodating portion 15a2 through the supply opening 21 and the toner receiving chamber 15a3 of the process cartridge B. The stirring and conveying unit 36 of the toner cartridge C is rotatably supported by the toner accommodating portion 30 and is driven by a stirring/drive input portion provided to an outside of the toner accommodating portion 30 with respect to the X axis direction. By this, a blade portion 36aof the stirring and conveying unit 36 is rotated.

The cleaning unit 60 of the process cartridge B includes a cleaning blade 17, the charging roller 12, a charging roller cleaner 14, and a residual toner chamber 103b, and rotatably supports the photosensitive drum 43. In this embodiment, a rotational axis of the photosensitive drum 43 is referred to as the rotational axis E (see FIGS. 1 and 3).

The charging roller 12 is disposed so as to contact an outer peripheral surface of the photosensitive drum 43 and electrically charges the photosensitive drum 43 by application of a voltage (charging bias) from the apparatus main assembly A. Further, the charging roller 12 is rotated by rotation of the photosensitive drum 43. The cleaning blade 17 as a cleaning member is an elastic member disposed so as to contact the outer peripheral surface of the photosensitive drum 43. The cleaning blade 17 elastically contacts the photosensitive drum 43 at a free end thereof, and thus is a capable of removing (cleaning) the toner, remaining after a sheet S passes through between the photosensitive drum 43 and the transfer roller 4, from the photosensitive drum 43. The toner removed by the cleaning blade 17 (hereinafter, this toner is referred to as a residual toner) is stored in the residual toner chamber 103b. The charging roller cleaner 14 is a roller disposed so as to contact a surface (outer peripheral surface) of the charging roller 12, and cleans the charging roller 12 by being rotated by rotation of the charging roller 12.

Next, an operation of the image forming apparatus 1 will be described with reference to FIG. 2. The photosensitive drum 43 is rotationally driven by an unshown driving source, and is charged uniformly to a predetermined potential by the charging roller 12. The photosensitive drum 43 after the charging is exposed at a surface thereof to light based on image information by the laser scanner, so that an electric charge of an exposed portion of the surface of the photosensitive drum 43 is removed, so that the electrically latent image is formed on the photosensitive drum surface. To the thus formed electrostatic latent image on the photosensitive drum 43, the toner is supplied from the developing roller 16, so that a toner image is formed on the photosensitive drum 43.

At this time, in parallel to the above-described image forming process, the sheet S is conveyed along the sheet feeding (conveying) path 3. Specifically, the sheet S accommodated in a cassette 3c is fed by rotation of the feeding roller 3b. Thereafter, the sheet S is conveyed to between the photosensitive drum 43 and the transfer roller 4 in synchronism with a timing when the toner image is formed on the photosensitive drum 43. When the sheet S passes through between the photosensitive drum 43 and the transfer roller 4, by a transfer voltage applied to the transfer roller 4, the toner image is transferred as an unfixed image onto the sheet S. Thereafter, the sheet S on which the toner image is transferred is conveyed toward the fixing portion 5. The toner image on the sheet S conveyed to the fixing portion 5 is fixed on the surface of the sheet S by being heated and pressed when the sheet S passes through the fixing portion 5. Then, the sheet S is discharged to a discharge tray 6 by a discharging roller pair 6a.

### Mounting and demounting of process cartridge and toner cartridge relative to apparatus main assembly

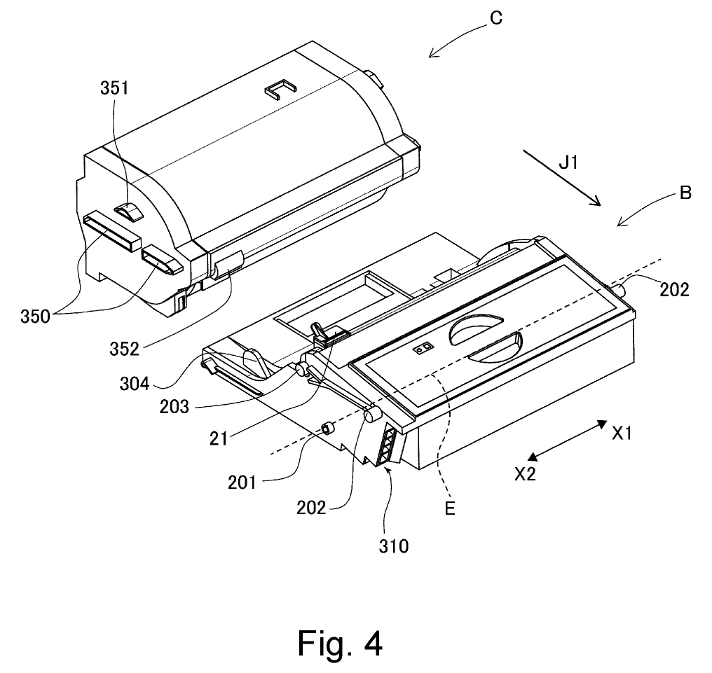

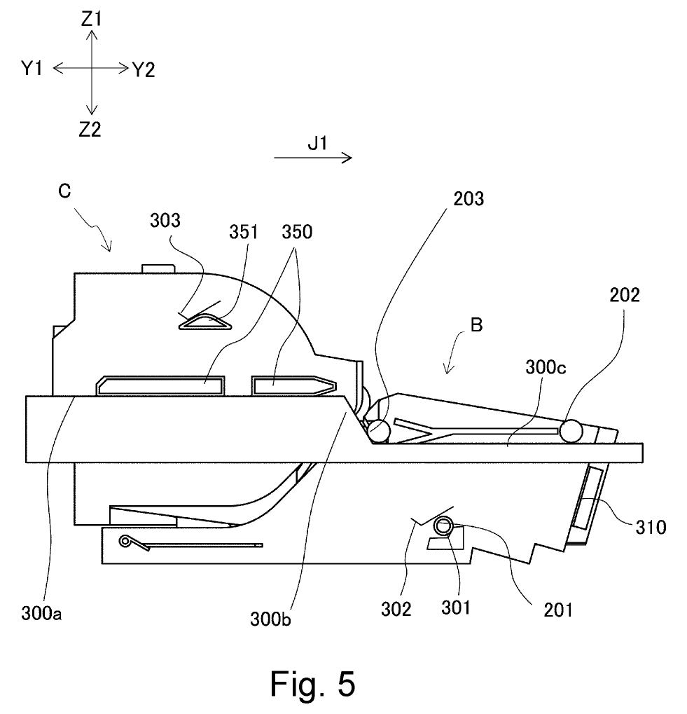

Next, a procedure of mounting the process cartridge B and the toner cartridge C to the apparatus main assembly A will be described using FIGS. 4 and 5. FIG. 4 is a perspective view showing the process cartridge B and the toner cartridge C. FIG. 5 is a side view showing a state in which the process cartridge B and the toner cartridge C are mounted in the apparatus main assembly A.

With respect to the X axis direction which is a direction of the rotational axis E of the photosensitive drum 43, one side wall of the process cartridge B is provided with a first portion-to-be-guided 202 and a second portion-to-be-guided 203 which have a cylindrical shape. In a J1 direction in which the process cartridge B is mounted into the apparatus main assembly A. The first portion-to-be-guided 202 is disposed downstream of the second portion-to-be-guided 203. Further, the side wall of the process cartridge B is provided with a cylindrical drum shaft 201 disposed coaxially with the rotational axis E of the photosensitive drum 43.

As shown in FIG. 5, in a state when the process cartridge B is started to be mounted in the space G (see FIG. 1) of the apparatus main assembly A, the first portion-to-be-guided 202 is guided by a guiding portion 300a of the apparatus main assembly A. When the process cartridge B is further inserted to the J1 direction, the second portion-to-be-guided 203 is guided by the guiding portion 300a.

In a mounting completion portion of the process cartridge B, when drive is inputted to the photosensitive drum 43 by an unshown driving means, the second portion-to-be-guided 203 contacts a guiding portion 300b of the apparatus main assembly A. By this, rotation of the process cartridge B around the X axis is stopped. At that time, the first portion-to-be-guided 202 ensures a gap between itself and a guiding portion 303c of the apparatus main assembly A.

Further, the drum shaft 201 of the process cartridge B is guided by a positioning portion 301 of the apparatus main assembly A and is urged against the positioning portion 301 by an urging portion 302 of the apparatus main assembly A. By this, the process cartridge B is positioned with respect to the J1 direction and the Z2 direction. Incidentally, with respect to the X axis direction, a side wall on the other side of the process cartridge B also has a constitution similar to the above-described constitution, and therefore will be omitted from description.

Next, after the mounting of the process cartridge B to the apparatus main assembly B is completed, the toner cartridge C is mounted to the apparatus main assembly A. On a side wall on one side of the toner cartridge C in the X axis direction, two third portions-to-be-guided 350 and a projected portion 351 are provided. When the toner cartridge C is started to be mounted into the space G (see FIG. 1) of the apparatus main assembly, the third portion-to-be-guided 350 are guided by the guiding portion 300a of the apparatus main assembly A. When the mounting of the toner cartridge C to the apparatus main assembly A is completed, the projected portion 351 is urged by an urging portion 303 provided to the apparatus main assembly A. By this, the third portions-to-be-guided 350 are urged against the guiding portion 300a, so that the toner cartridge C is positioned in the J1 direction, and in addition, rotation of the toner cartridge C around the X axis is stopped. Further, a rib 304 of the process cartridge B shown in FIG. 4 is engaged with a groove portion 352 of the toner cartridge C, so that the positioning of the toner cartridge C to the process cartridge B with respect to a longitudinal direction (direction of the rotational axis E, the X axis direction) of the toner cartridge C is completed. In the longitudinal direction of the toner cartridge C, the rib 304 is disposed on a supply opening 21 side, so that a relative position accuracy between the supply opening 21 of the process cartridge B and the toner discharge opening 34a of the toner cartridge C is enhanced, and thus it is possible to suppress toner leakage.

### Description of contact (point) constitution and arrangement constitution of contact (point) connection constitution

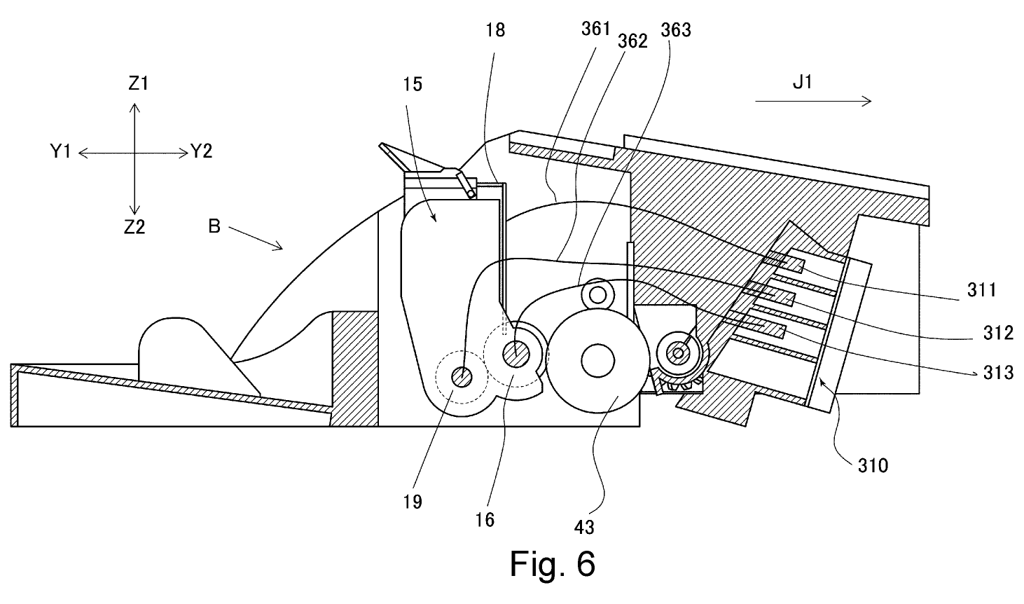

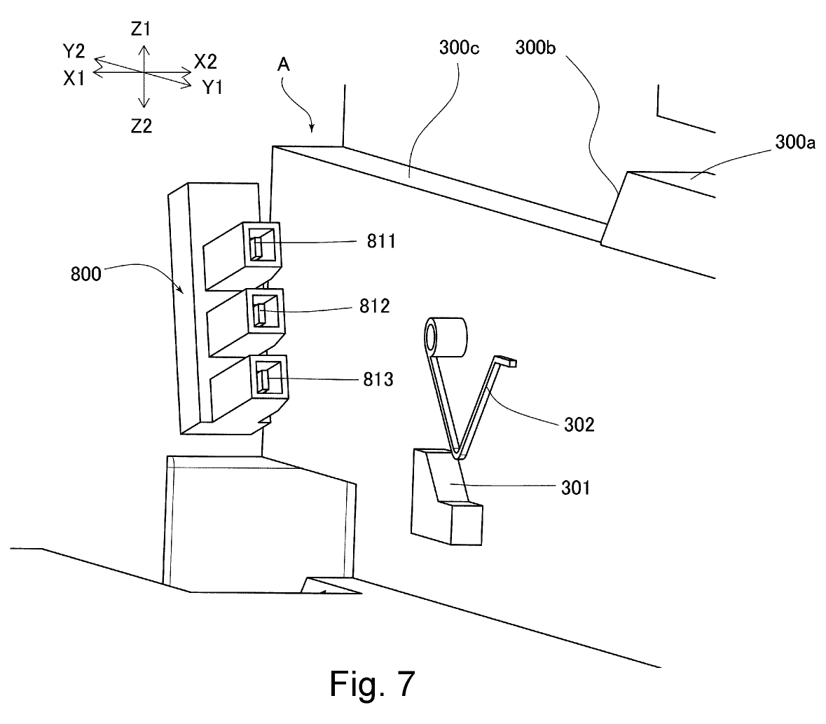

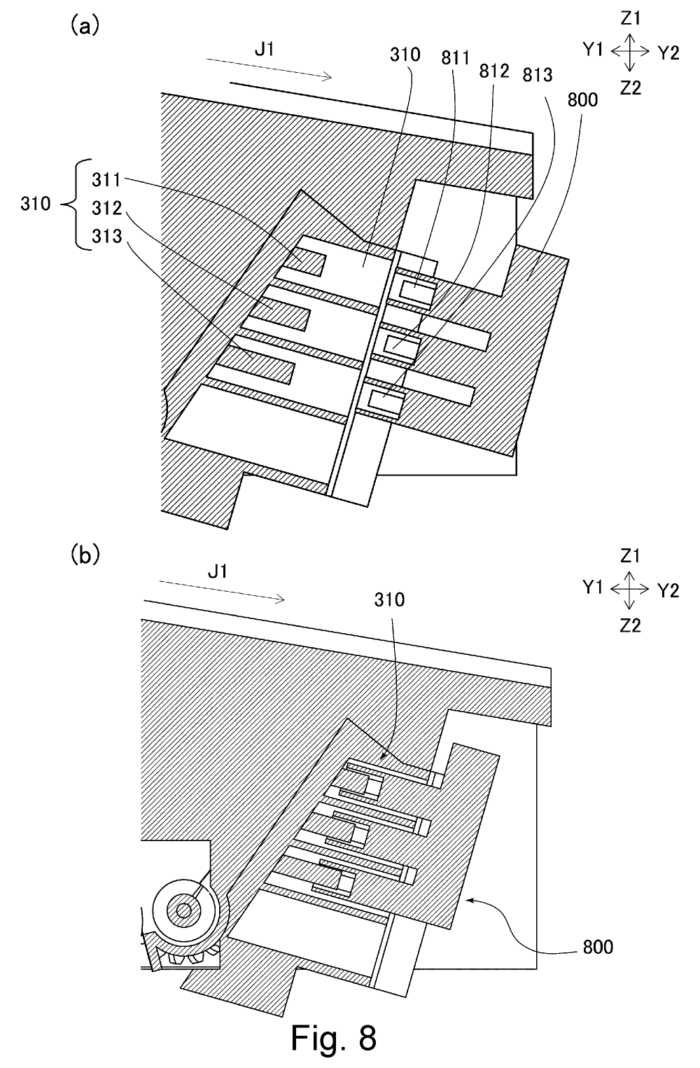

Next, a contact (point) constitution of the process cartridge B will be described using FIGS. 6 to part (b) of 8. FIG. 6 is a partial sectional view showing a contact (point) unit 310 of the process cartridge B. FIG. 7 is a perspective view showing a main assembly contact unit 800 of the apparatus main assembly A. Part (a) of FIG. 8 is partial sectional view showing a state during mounting of the contact unit 310 to the main assembly contact unit 800, and part (b) of FIG. 8 is a partial sectional view showing a state in which the mounting of the contact unit 310 to the main assembly contact unit 800 is completed.

As shown in FIG. 6, the developing unit 15 of the process cartridge B includes the developing roller 16, the supplying roller 19, and the developing blade 18, and to each of the developing roller 16, the supplying roller 19, and the developing blade 18, a bias is applied from the apparatus main assembly A. The process cartridge B includes the contact unit 310 onto a downstream side of the J1 direction which is a mounting direction of the apparatus main assembly A. In other words, the process cartridge B includes the contact unit 310 on a leading end side of a direction in which the process cartridge B is mounted to the apparatus main assembly A.

Further, the contact unit 310 is disposed on a side opposite from an unshown driving means of the apparatus main assembly A with respect to a direction (X axis direction) of the rotational axis E of the photosensitive drum 43. The contact unit 310 includes a developing blade contact 311, a supplying roller contact 312, and a developing roller contact 313 arranged in an order from an upper side toward a lower side of the contact unit 310. In other words, the developing blade contact 311, the supplying roller contact 312, and the developing roller contact 313 are disposed in this order from a side closer to the first portion-to-be-guided 202 (see FIG. 4). In this embodiment, the respective contacts of the contact unit 310 are disposed as described above, but the present disclosure is not limited thereto, and the respective contacts may also be disposed in orders different from the above-described order.

The developing blade contact 311 and the developing blade 18 are electrically connected by wiring 361. Similarly, the supplying roller contact 312 and the supplying roller 19 are electrically connected by wiring 362. The developing roller contact 313 and the developing roller 16 are also electrically connected by wiring 363. Each of the developing blade contact 311, the supplying roller contact 312, and the developing roller contact 313 of the contact unit 310 is constituted so as to be enclosed by a rib. By this, a creepage distance for insulation of each contact can be ensured, and in addition, it is possible to prevent the user from touching a contact (point) metal plate.

Further, as shown in FIG. 7, the apparatus main assembly A includes the main assembly contact unit 800, and the main assembly contact unit 800 is disposed so as to be connectable to the above-described contact unit 310 of the process cartridge B. The main assembly contact unit 800 includes a main assembly developing blade contact 811, a main assembly supplying roller contact 812, and a main assembly developing roller contact 813 so as to correspond to the developing blade contact 311, the supplying roller contact 312, and the developing roller contact 313, respectively, of the contact unit 310.

Each of the main assembly developing blade contact 811, the main assembly supplying roller contact 812, and the main assembly developing roller contact 813 are connected to an unshown electric board of the apparatus main assembly A, and is constituted so as to be capable of supplying an appropriate bias.

Next, connection between the contact unit 310 and the main assembly contact unit 800 will be described while making reference to parts (a) and (b) of FIG. 8. When the process cartridge B is moved toward in the J1 direction, as shown in part (a) of FIG. 8, the contact unit 310 approaches the main assembly contact unit 800. Then, as shown in part (b) of FIG. 8, when the mounting the process cartridge B to the apparatus main assembly A is completed, the contact unit 310 is connected to the main assembly contact unit 800. At this time, the developing blade contact 311, the supplying roller contact 312, and the developing roller contact 313 of the contact unit 310 are engaged with the main assembly developing blade contact 811, the main assembly supplying roller contact 812, and the main assembly developing roller contact 813, respectively, of the main assembly contact unit 800. By this, each contact is electrically connected to an associated contact.

### Detailed constitution of cleaning frame

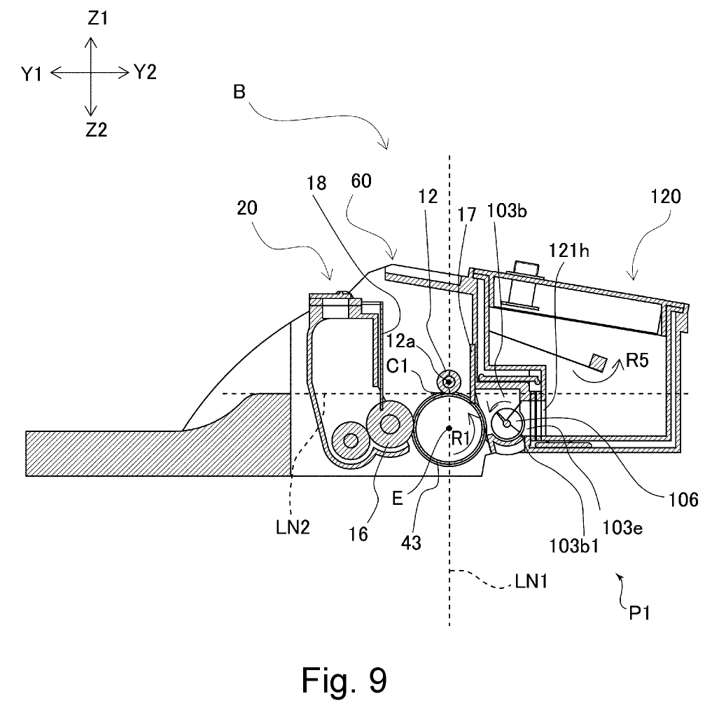

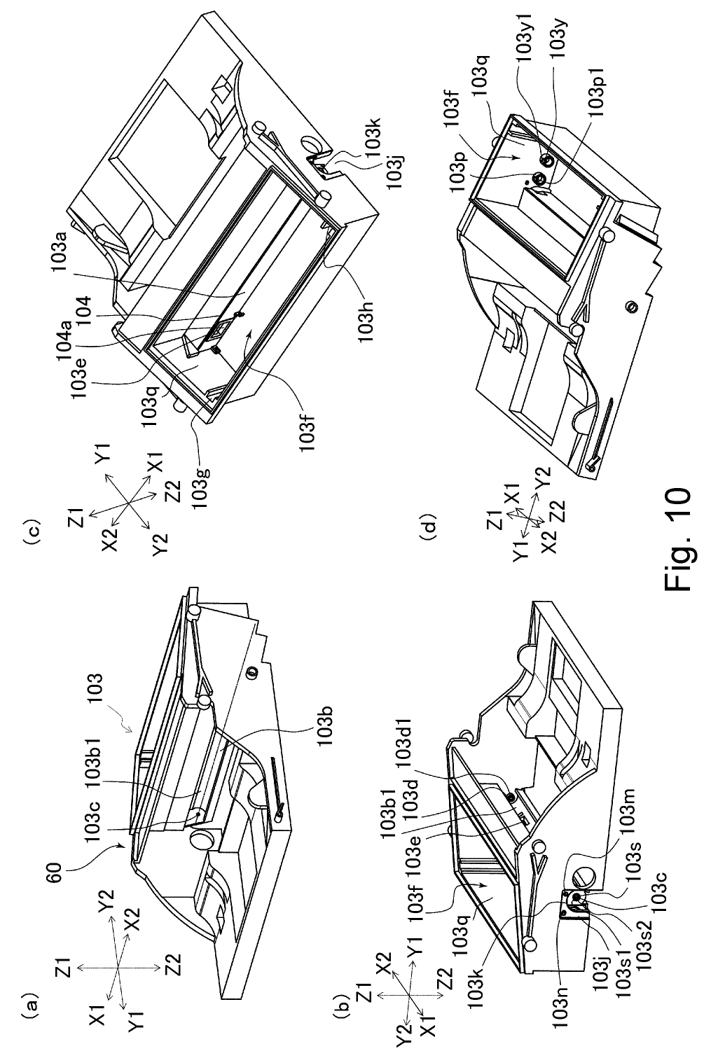

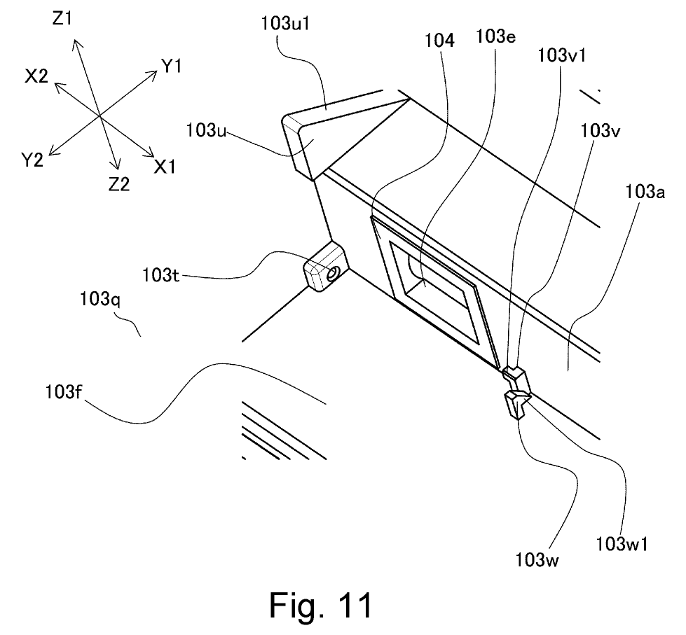

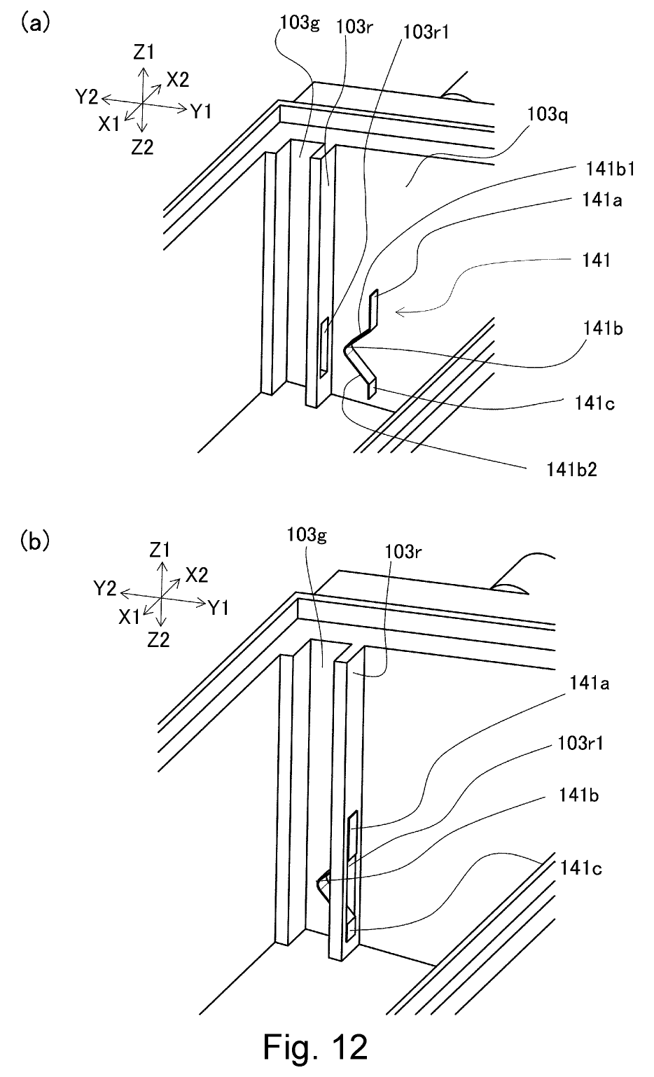

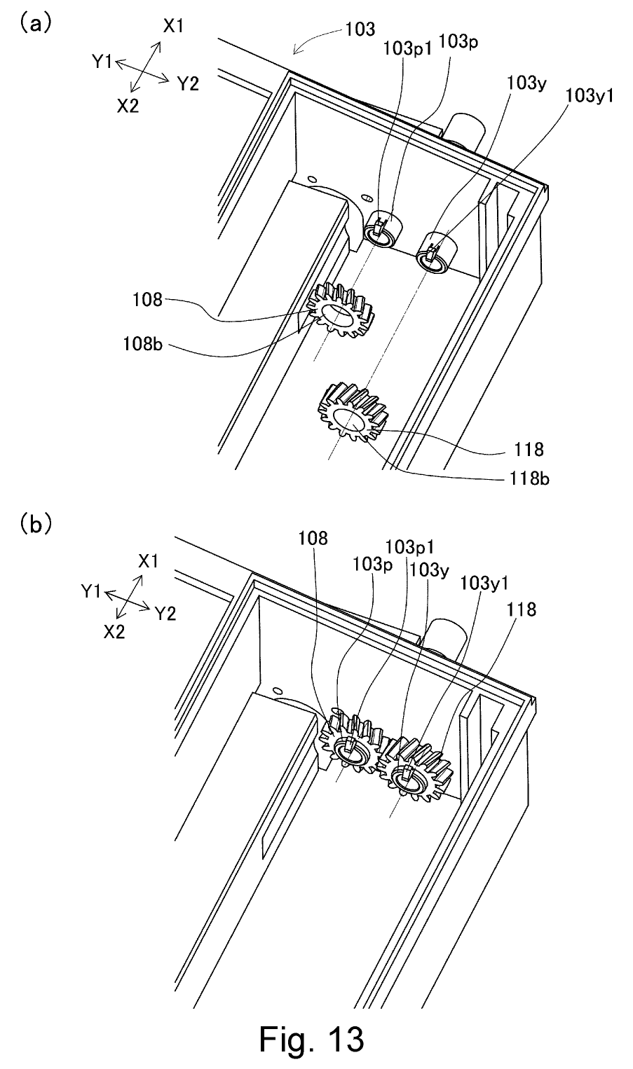

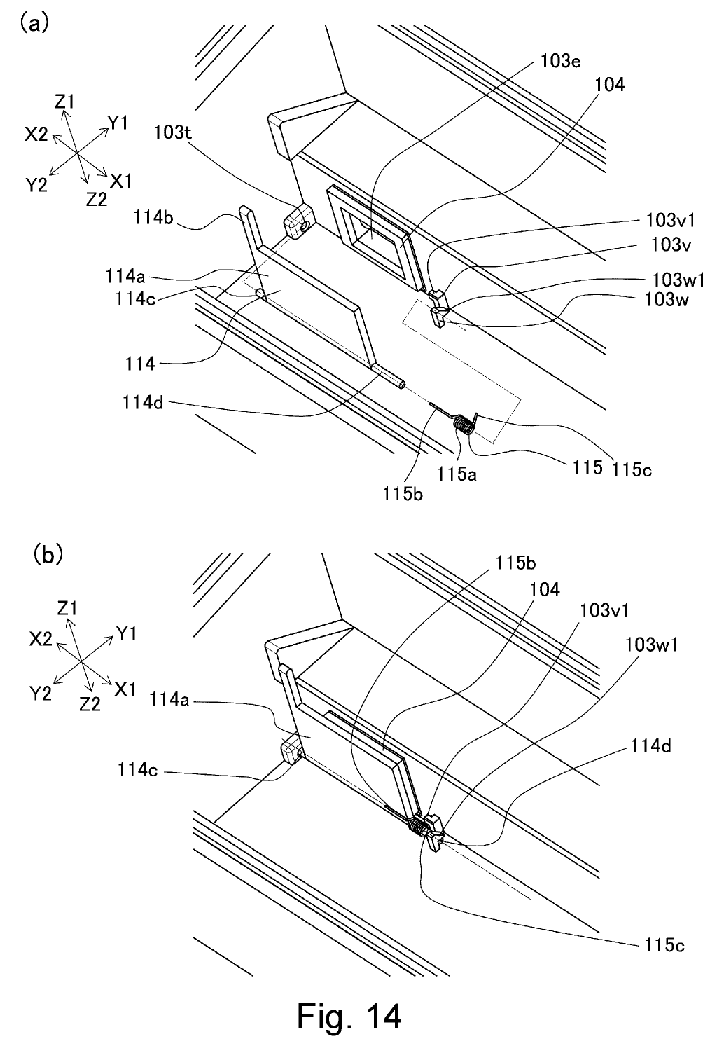

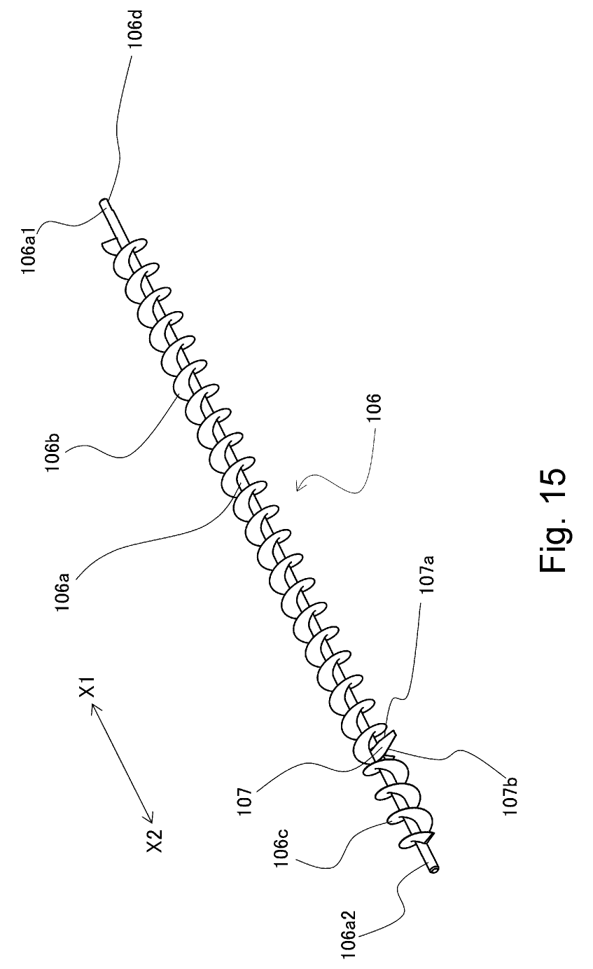

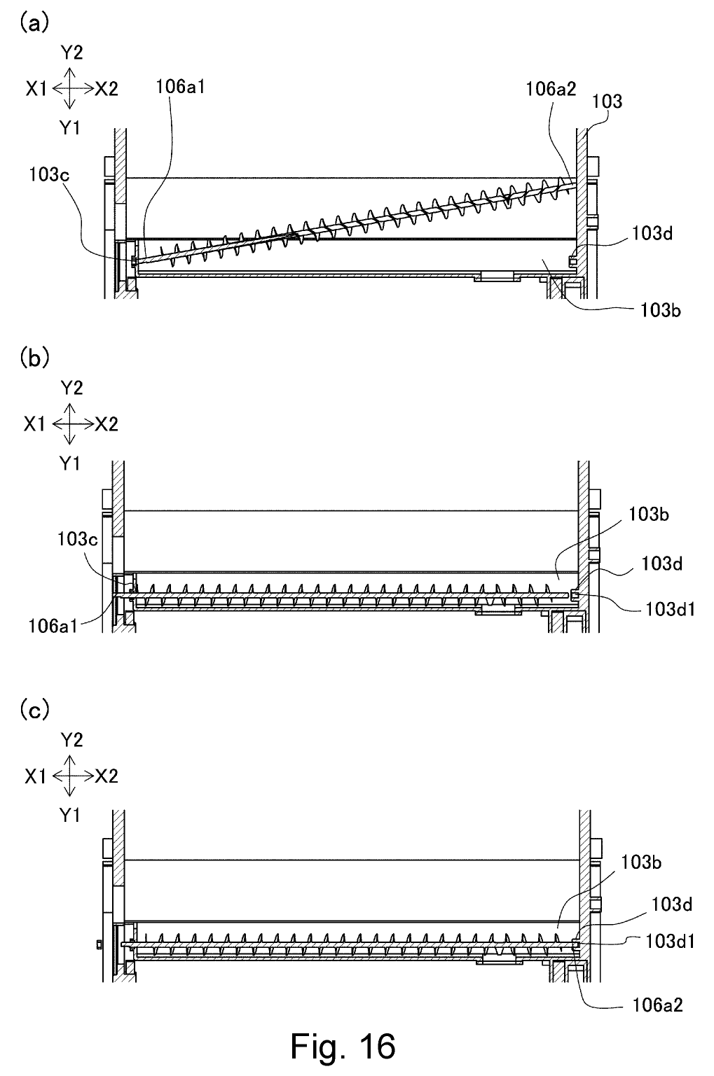

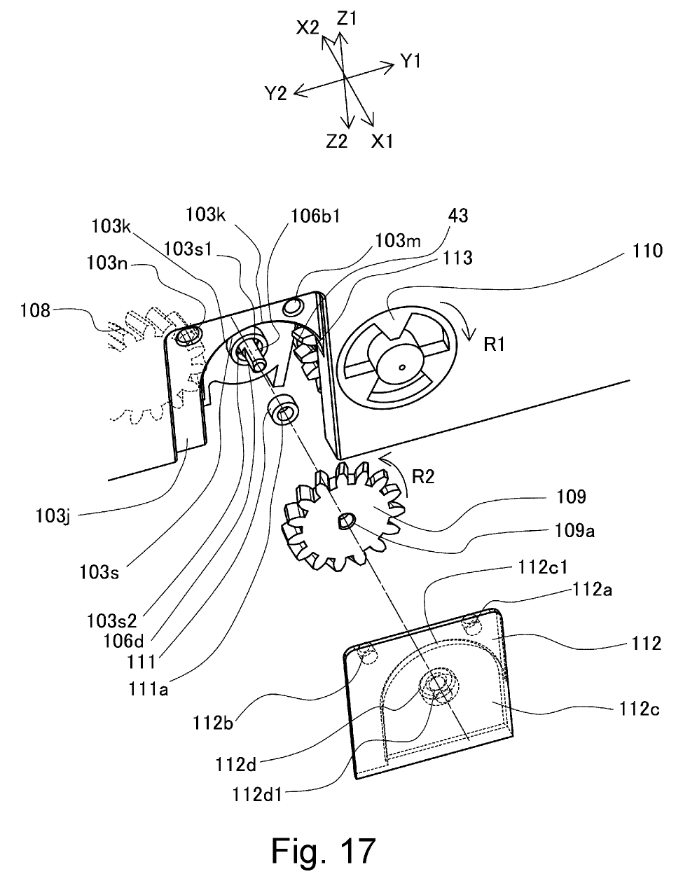

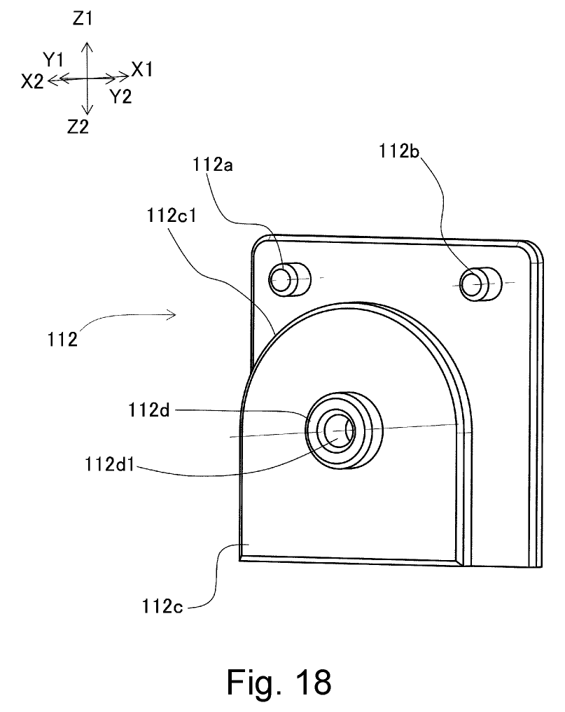

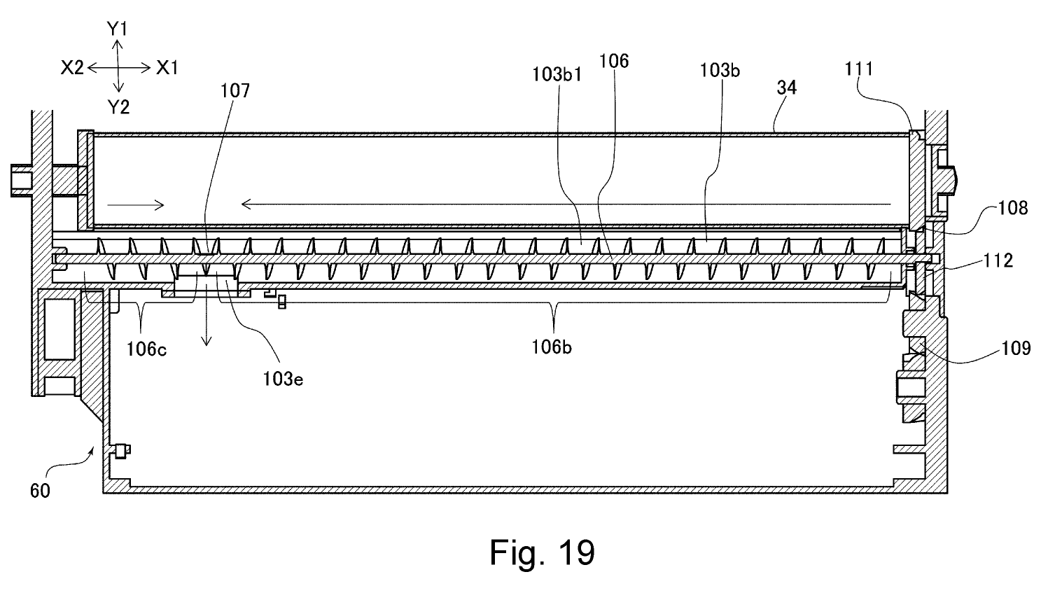

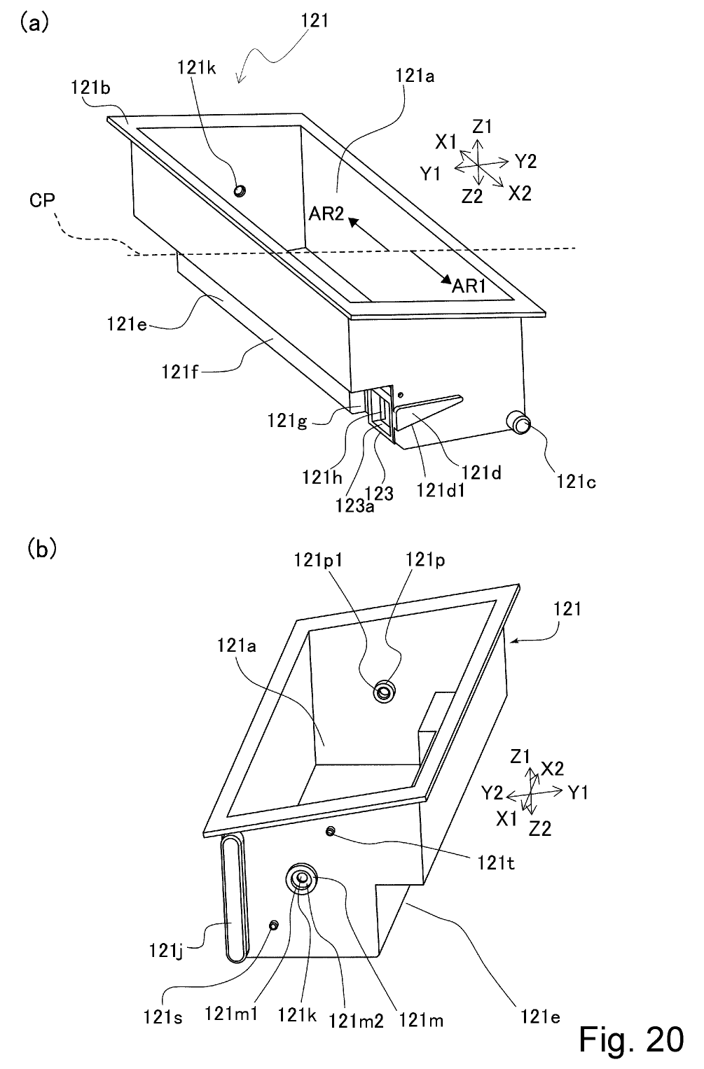

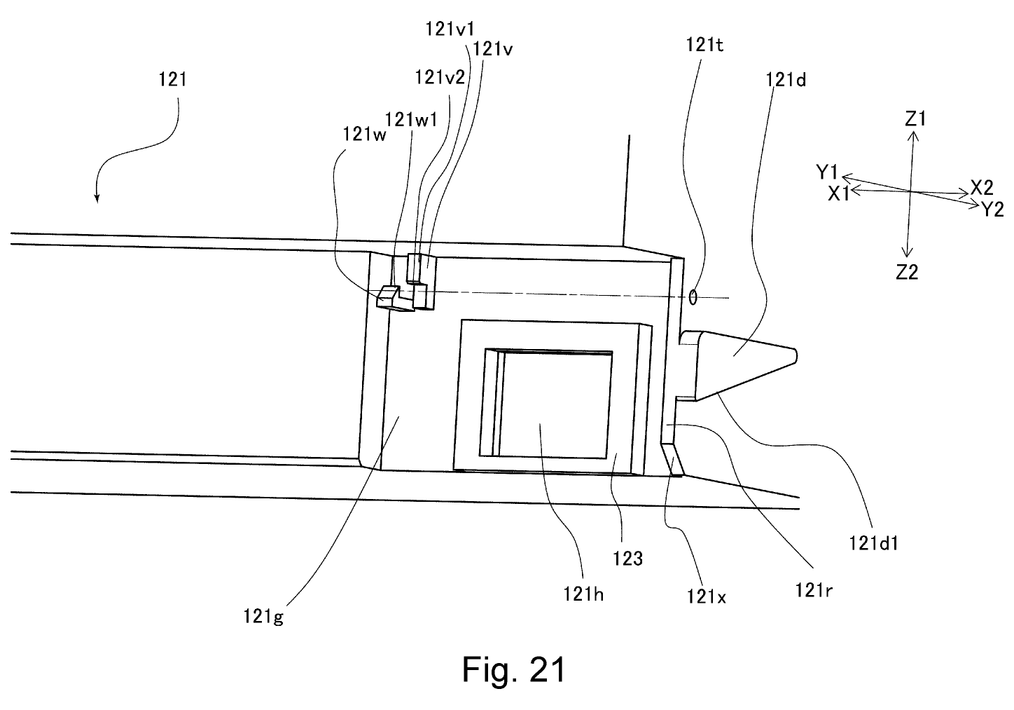

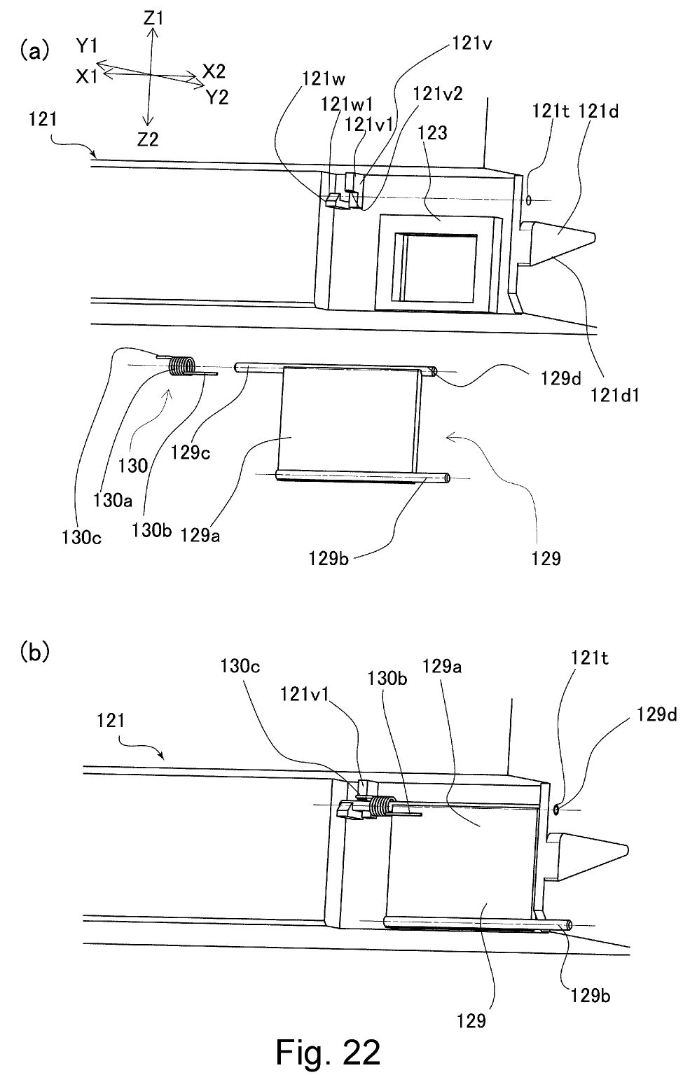

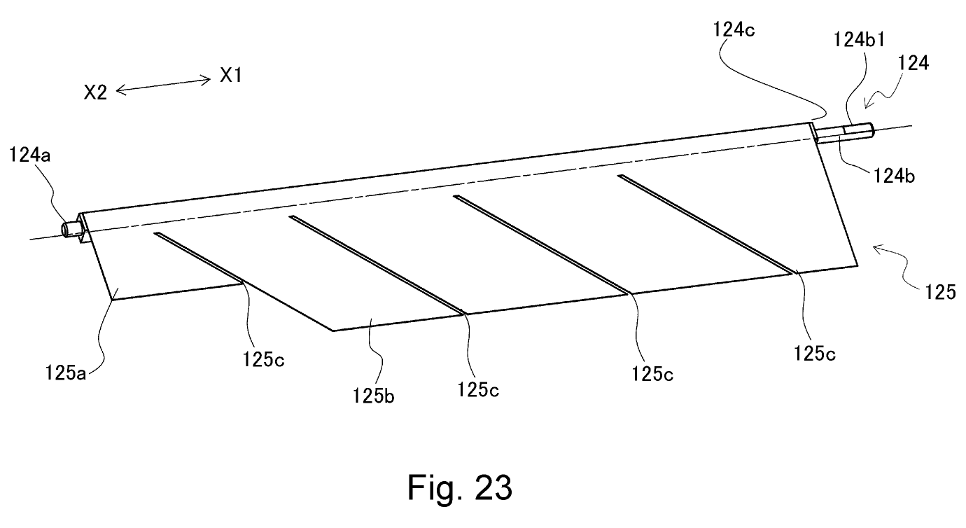

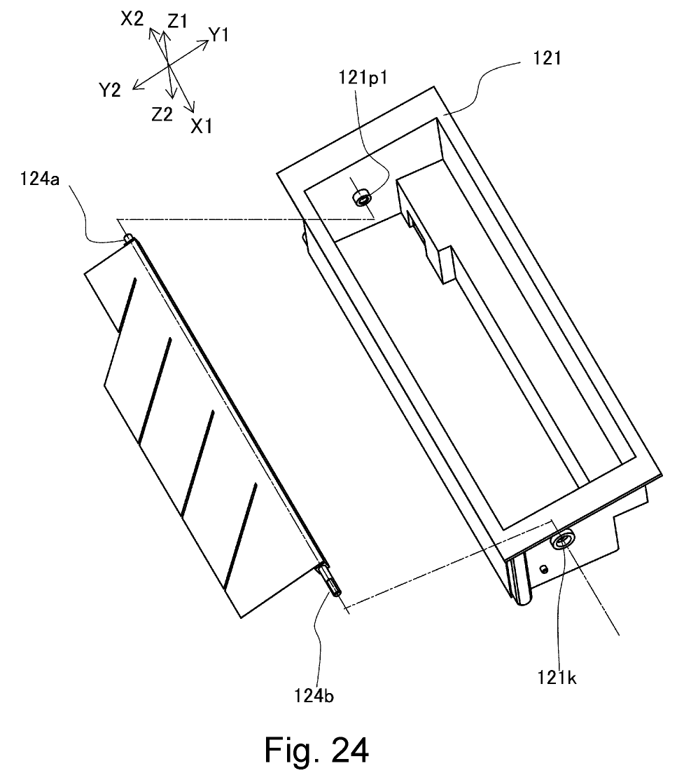

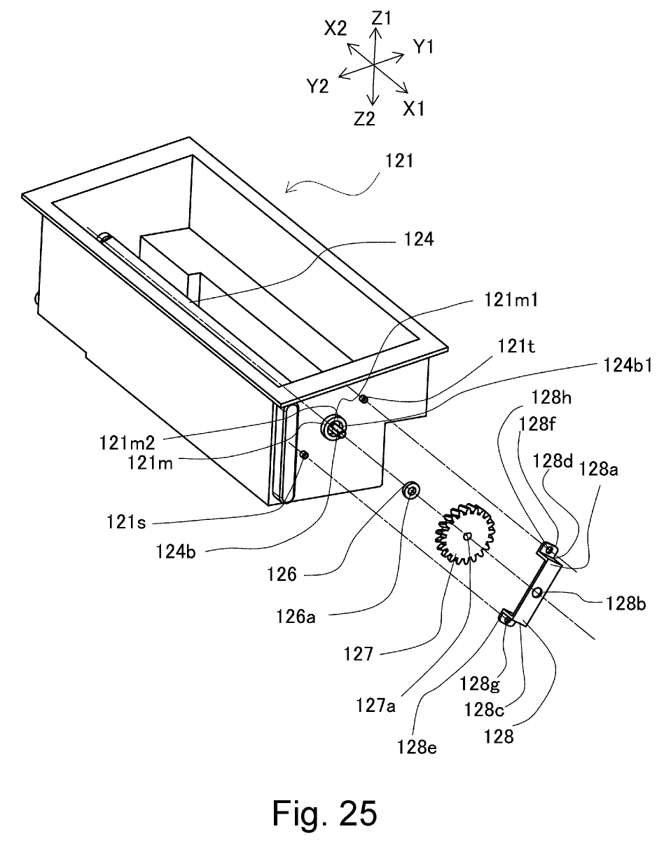

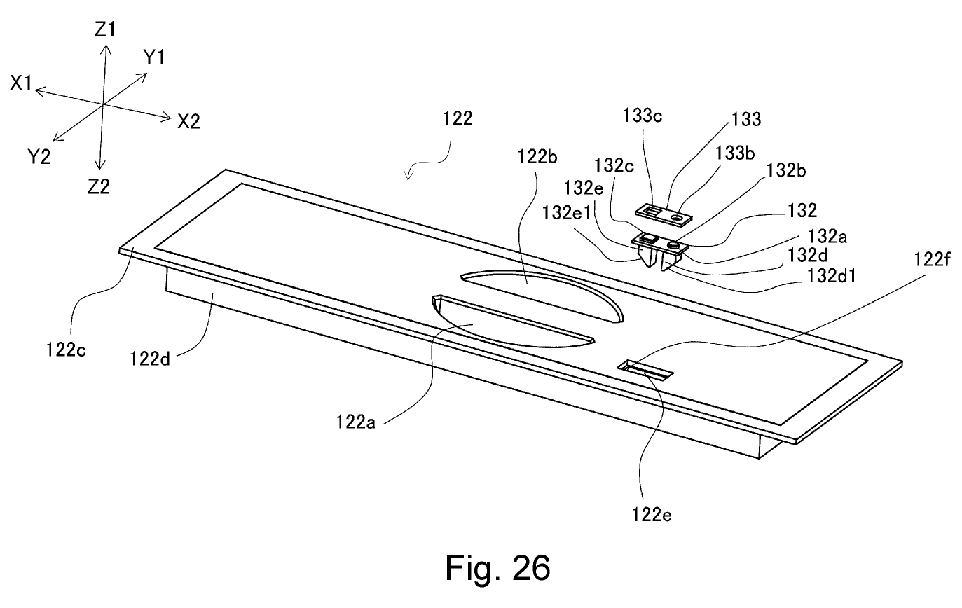

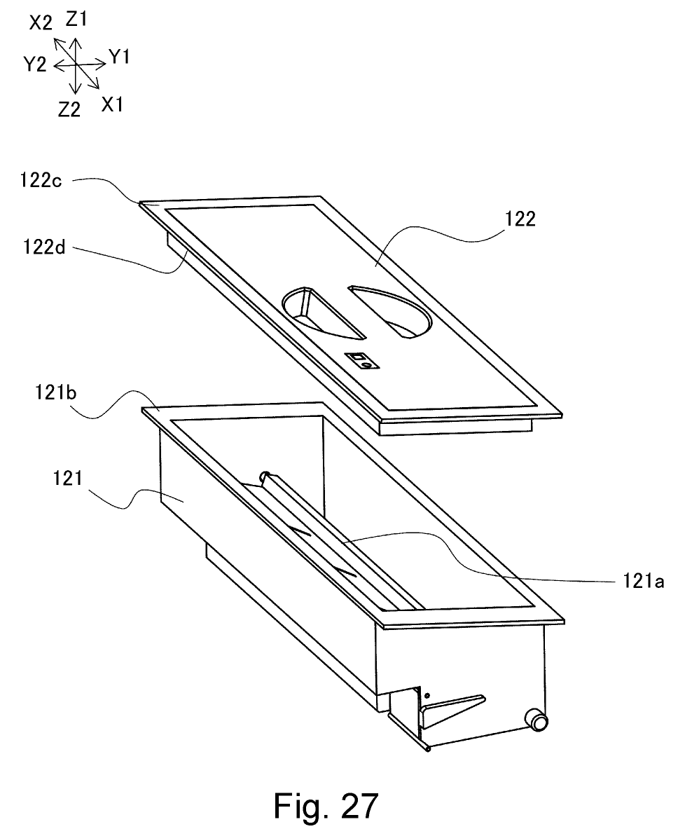

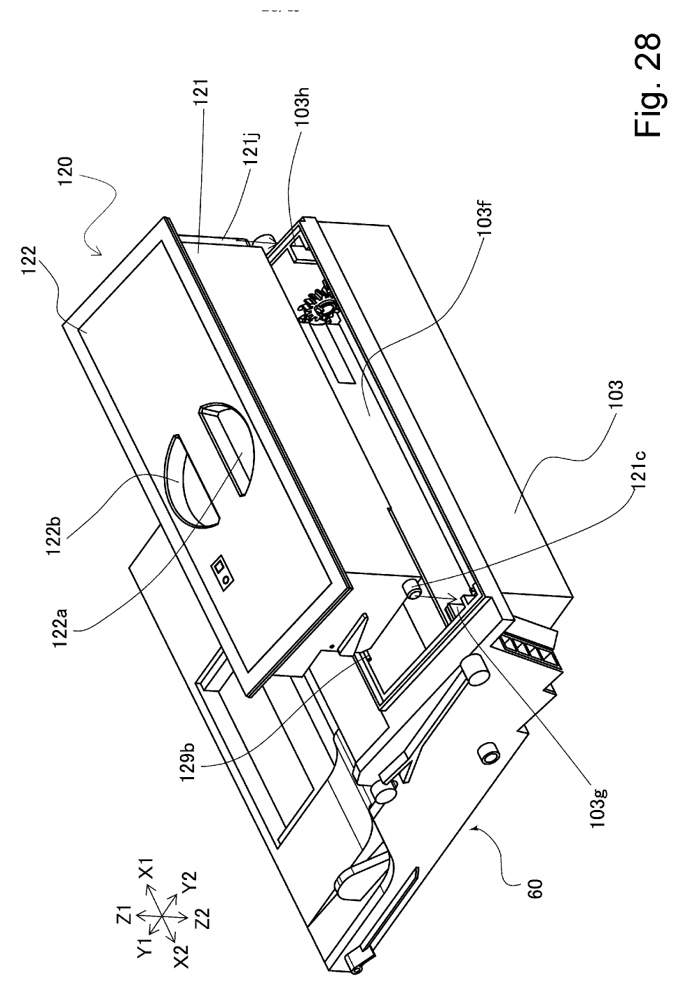

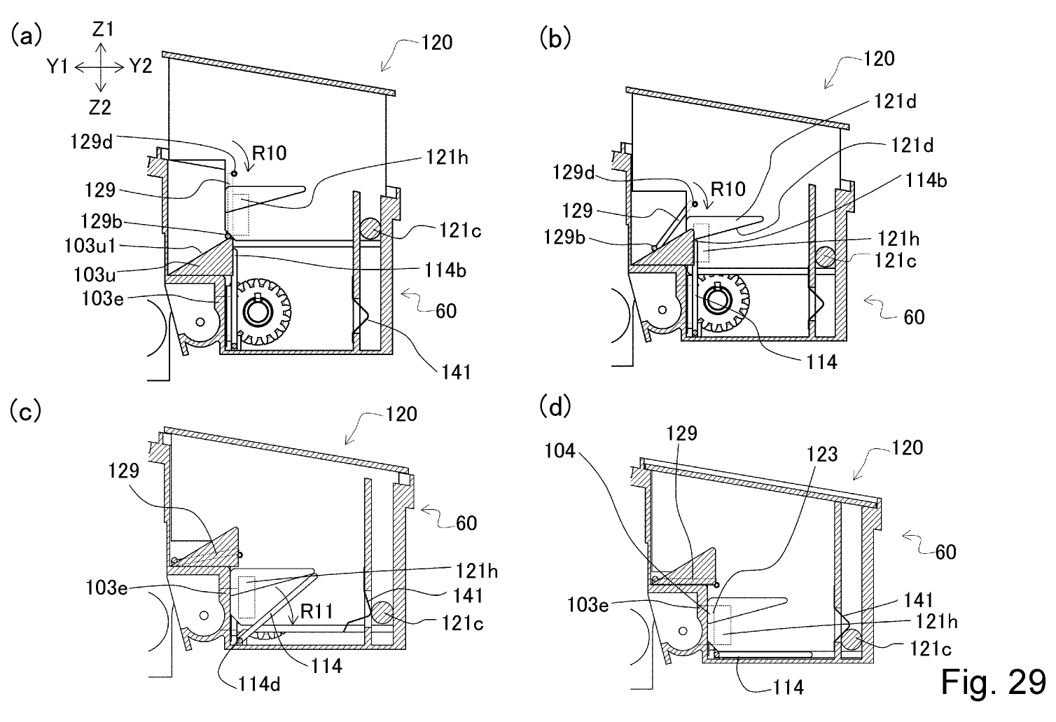

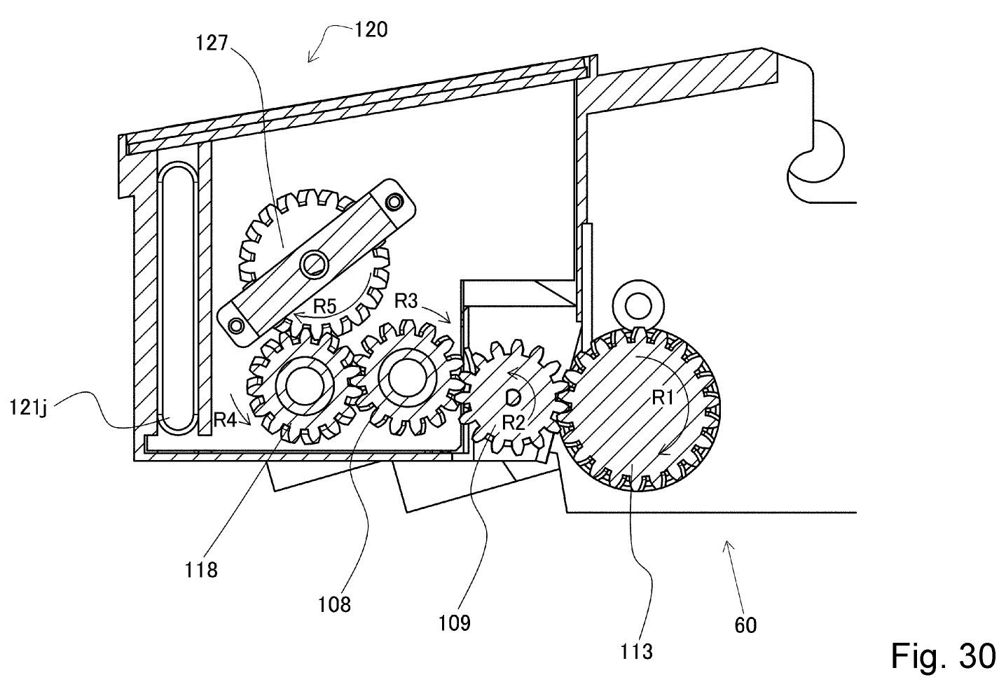

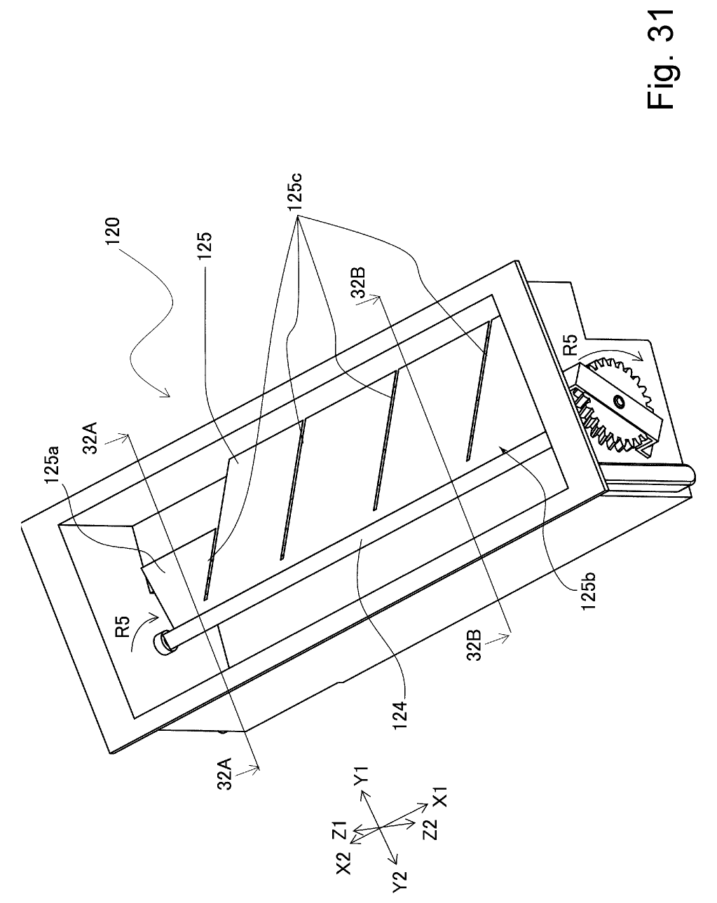

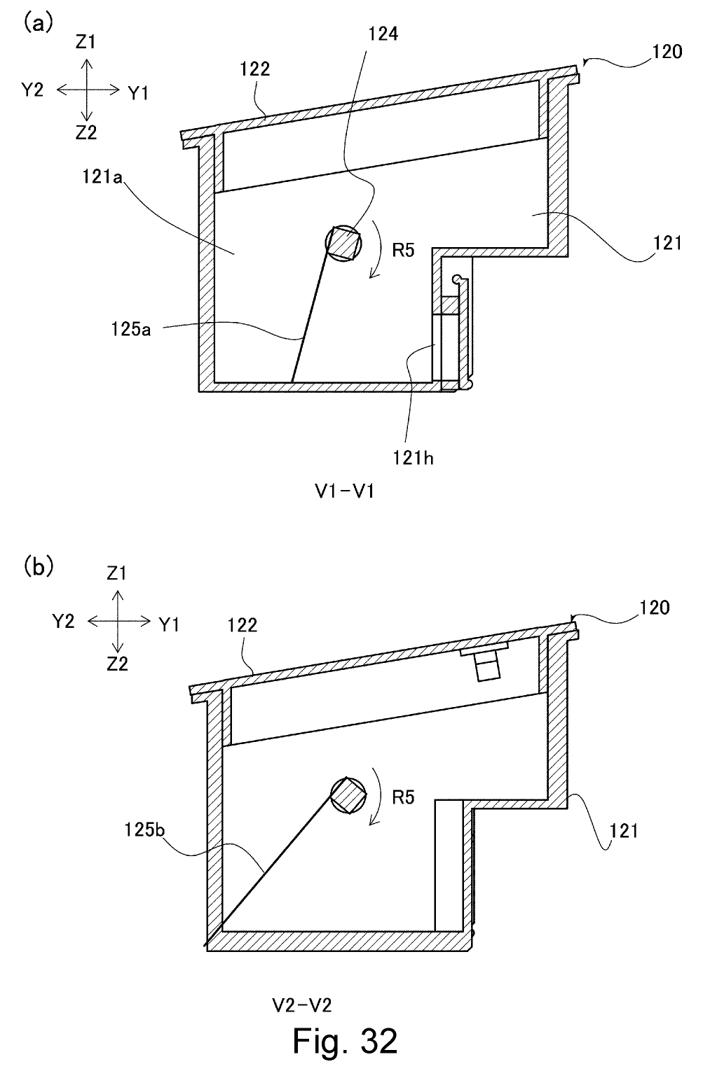

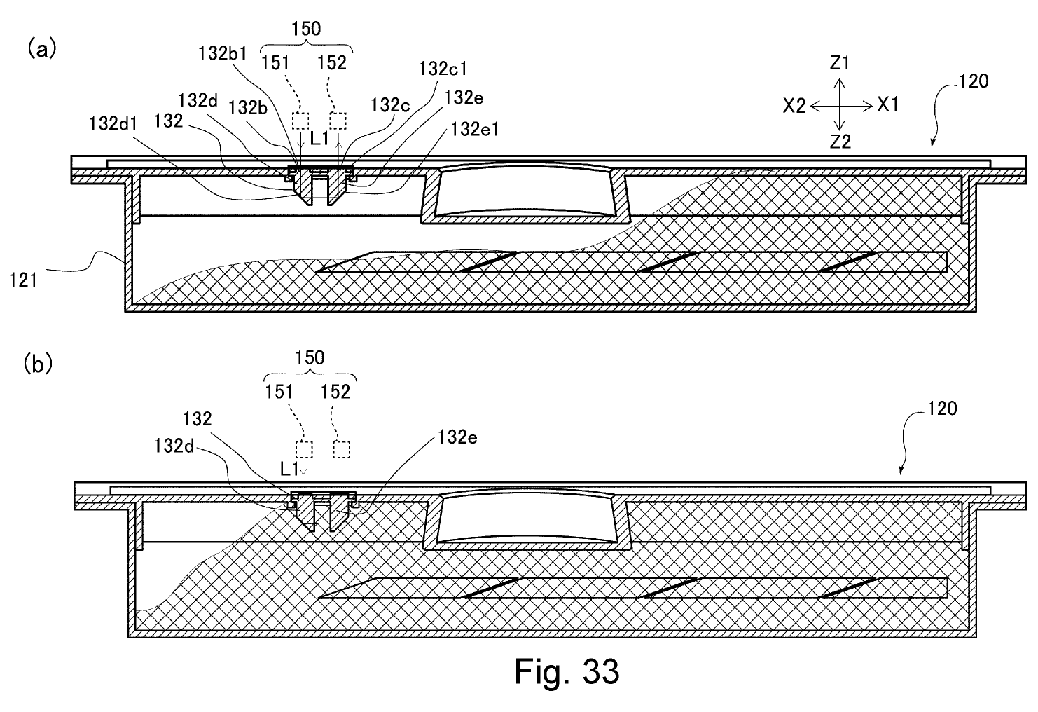

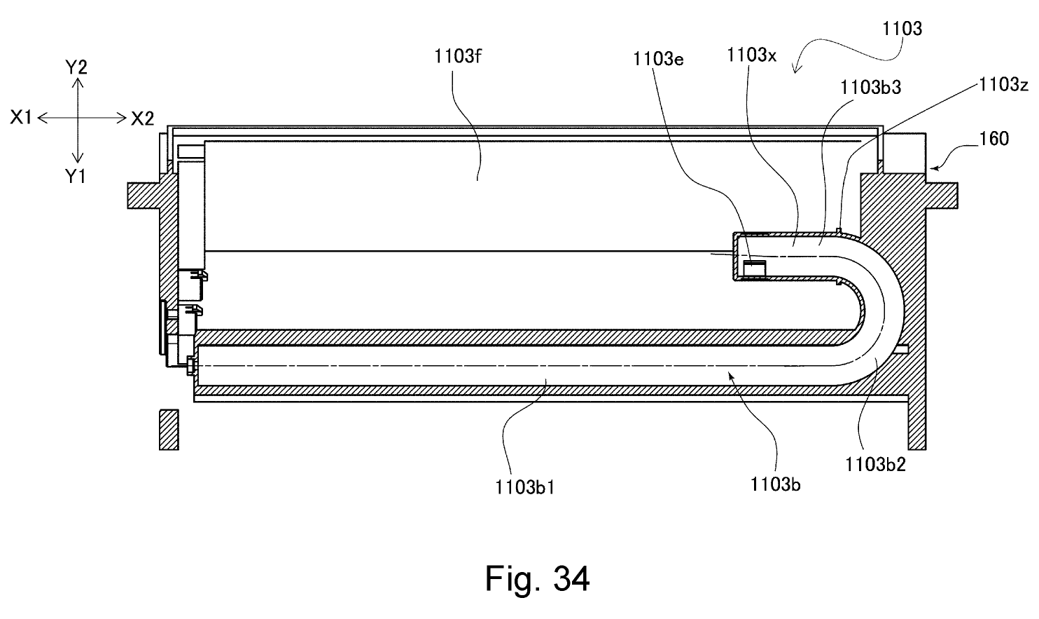

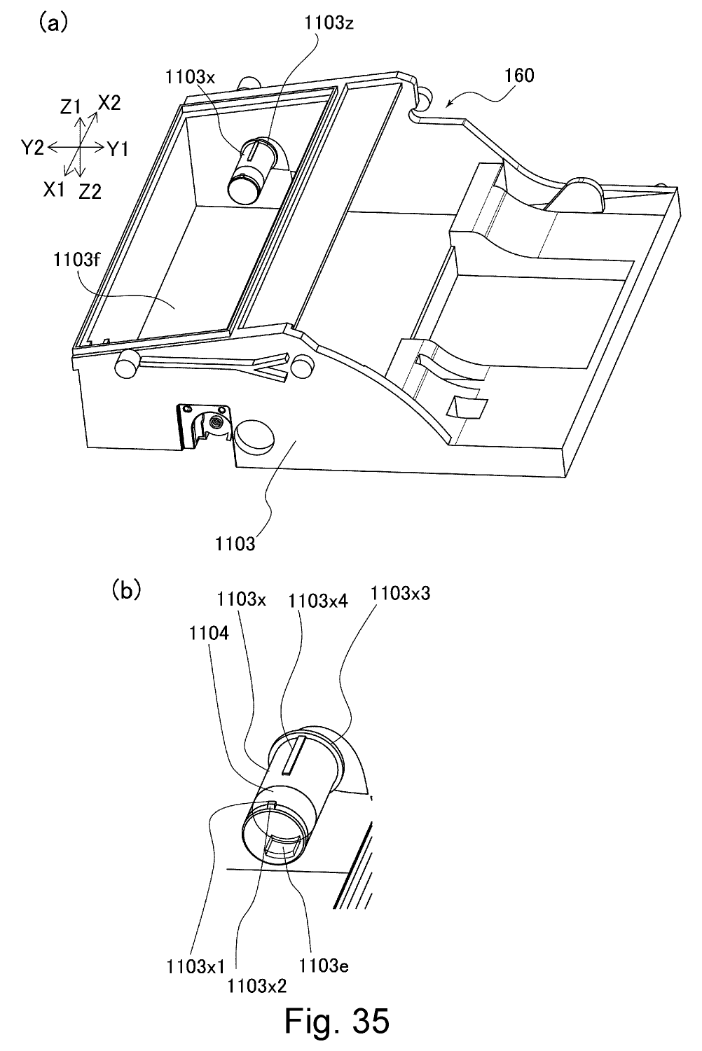

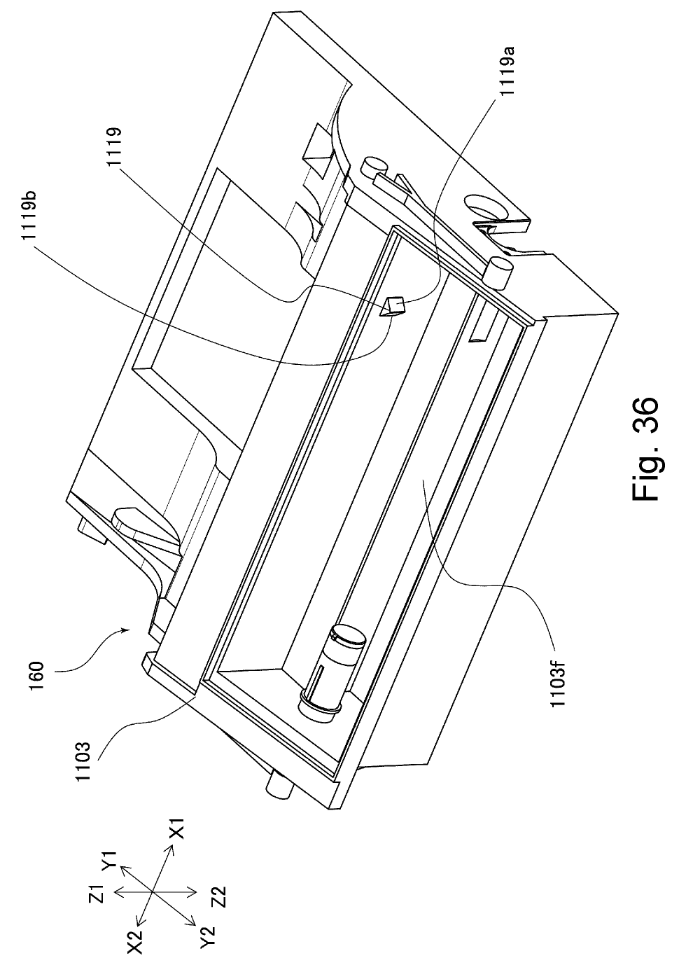

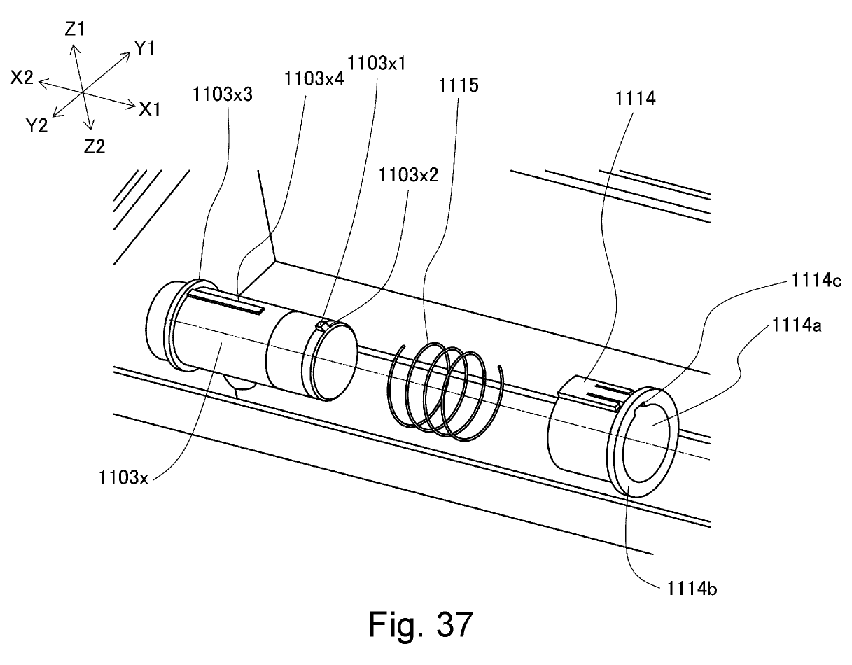

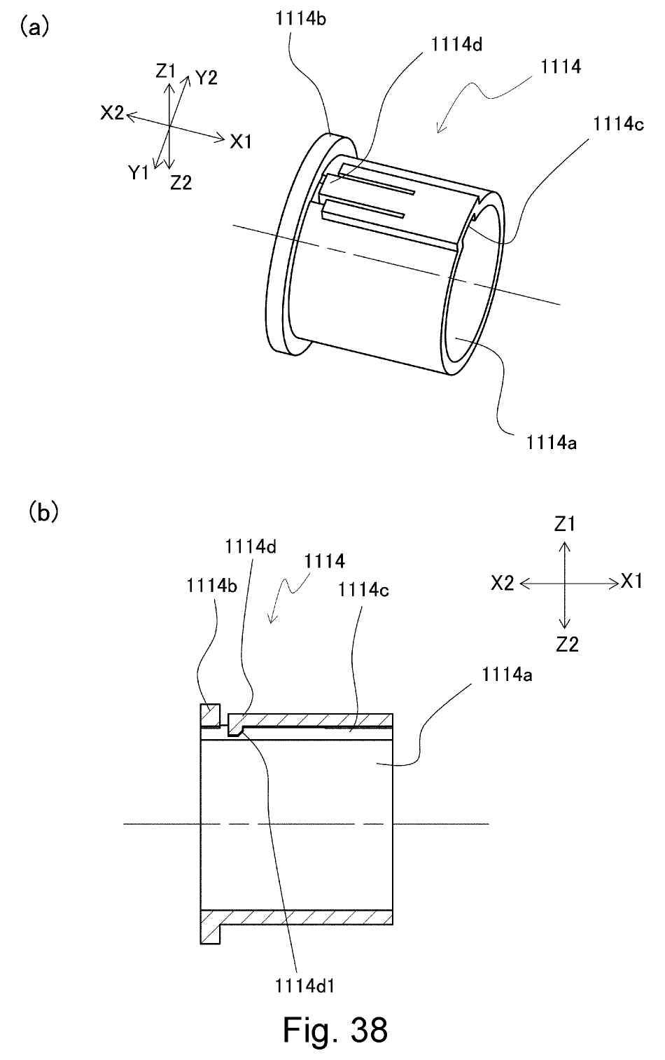

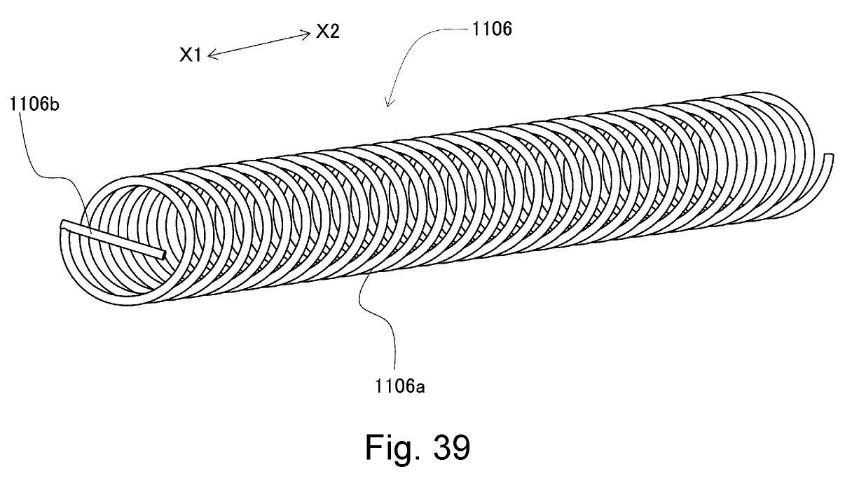

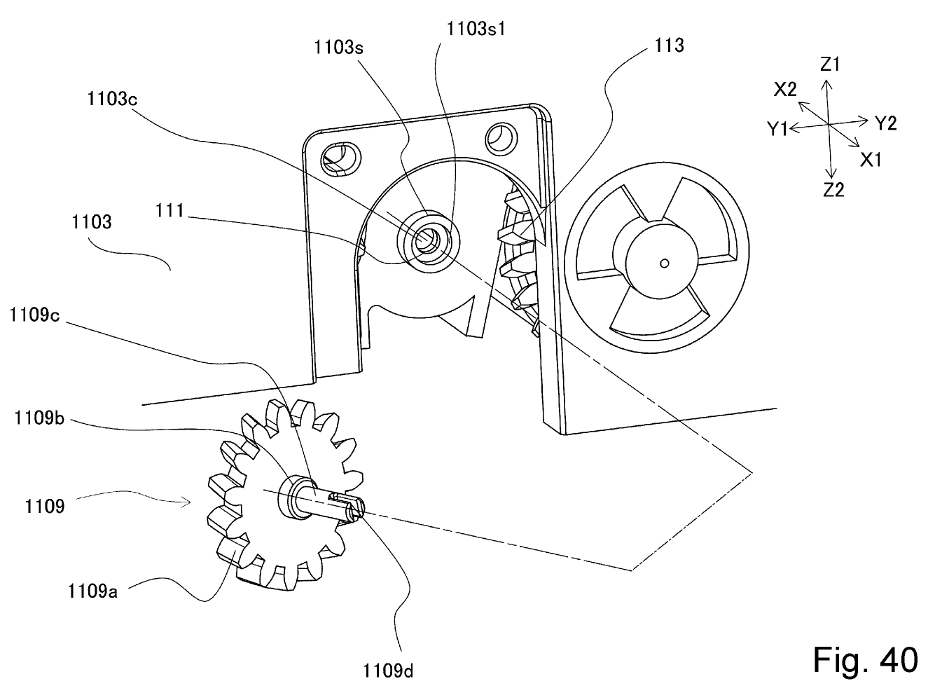

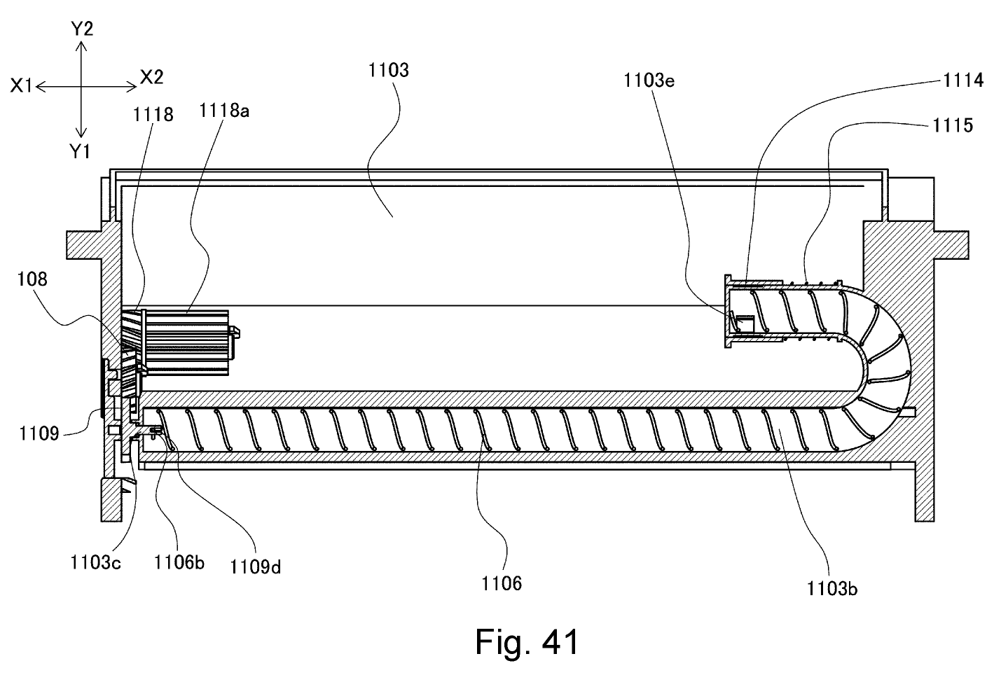

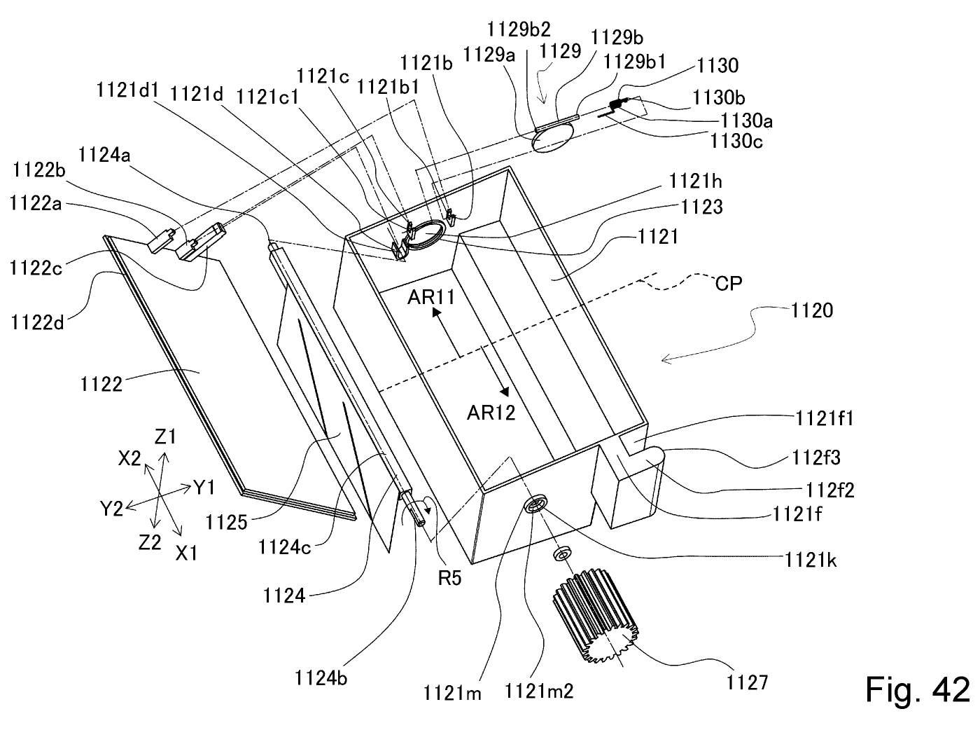

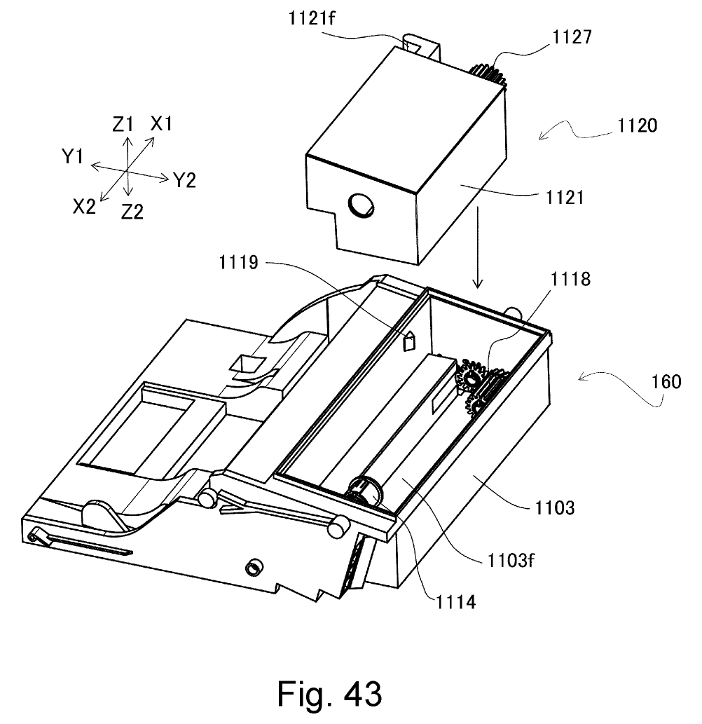

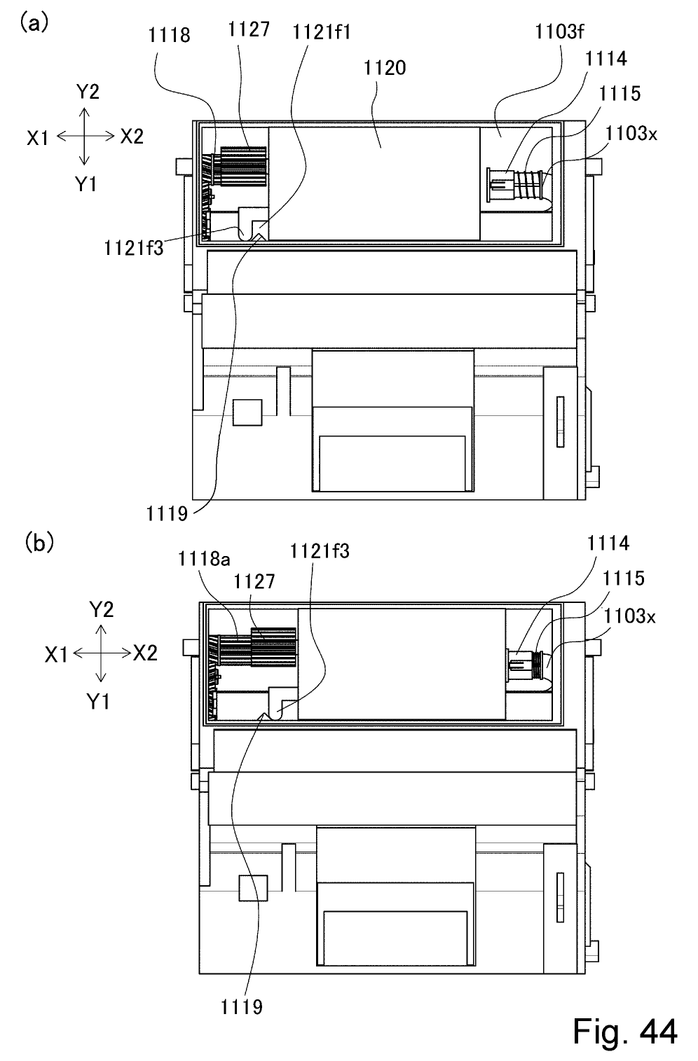

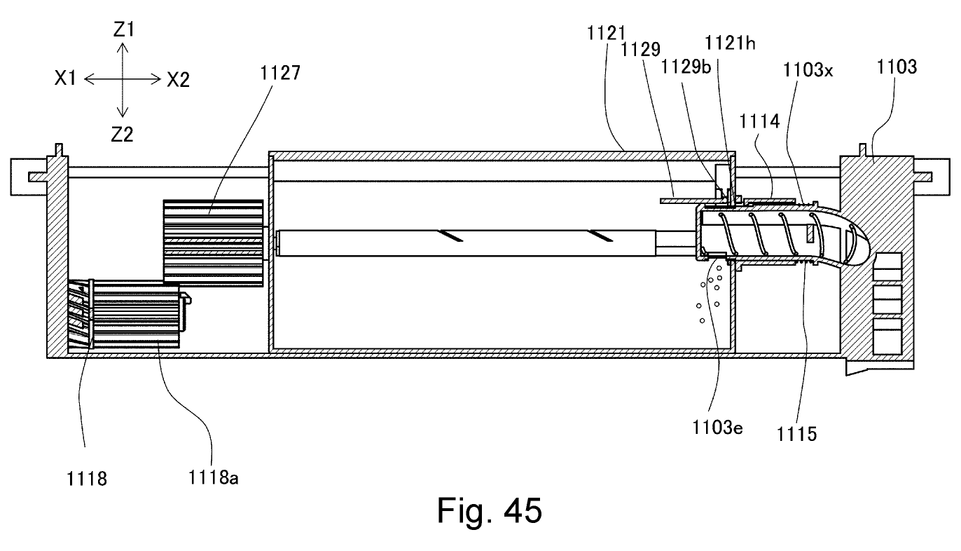

Next, a detailed constitution of a cleaning frame 103 of the cleaning unit 60 will be described using FIGS. 9 to 11. FIG. 9 is a sectional view showing the process cartridge B. Incidentally, in this embodiment, screws when the respective parts are connected will be omitted from description. Part (a) of FIG. 10 is a perspective view showing the cleaning frame 103. Parts (b), (c), and (d) of FIG. 10 are other perspective views showing the cleaning frame 103. FIG. 11 is an enlarged perspective view in which the neighborhood of the discharge opening 103e of the cleaning frame 103 shown in part (c) of FIG. 10 is enlarged.

As shown in FIG. 9, the process cartridge B is constituted by integrally including the cleaning unit (photosensitive member holding unit, drum holding unit, image bearing member holding unit, first unit) 60 and the developing unit (developer carrying member holding unit, second unit) 20.

The residual toner chamber 103b of the cleaning unit 60 is provided with a residual toner conveying member 106.

The residual toner conveying member 106 has a screw shape, and conveys the residual toner in the direction of the rotational axis E, i.e., in the X axis direction. The residual toner conveyed by the residual toner conveying member 106 is conveyed toward a residual toner unit 120 as a residual toner accommodating portion through the discharge opening 103e.

As shown in FIG. 9 and part (a) of FIG. 10, the cleaning unit 60 includes the cleaning frame 103 as a frame for rotatably supporting the photosensitive drum 43, and the cleaning frame 103 is provided with the residual toner chamber 103b. The residual toner chamber 103b is provided with an arcuate shape portion 103b1 extending in the X axis direction. Further, in an end portion of the residual toner chamber 103b in the X1 direction, a through hole 103c coaxial with the arcuate shape portion 103b1 is provided.

As shown in part (b) of FIG. 10, in an end portion of the residual toner chamber 103b in the X2 direction, a cylindrical portion 103d projected in the X1 direction is provided coaxially with the through hole 103c. In a central portion of the cylindrical portion 103d, a recessed portion 103d1 recessed in the X2 direction is provided.

Further, in an end portion of the cleaning frame in the X direction, a rectangular recessed portion 103j recessed in the X2 direction is provided. The recessed portion 103j is provided with an arcuate shape portion 103k larger in diameter than the through hole 103c is provided. Further, the recessed portion 103j is provided with a cylindrical portion 103s which is coaxial with the through hole 103c, which has a diameter larger than the through hole 103c, and which is recessed in the X direction. The cylindrical portion 103s is provided with a hole portion 103s1 recessed in the X2 direction. In an end portion of the cylindrical portion 103s in the X2 direction, an end surface 103s2 having a through hole 103c is provided.

The recessed portion 103j is provided with a round recessed portion 103m disposed on the Z1 direction side (upper side) of the arcuate shape portion 103k and is provided with a long round recessed portion 103n. The round recessed portion 103m has a circular shape, and the long round recessed portion 103n has a long circular shape. The round recessed portion 103m and the long round recessed portion 103n are provided and arranged in the Y axis direction.

Further, as shown in parts (b) and (c) of FIG. 10, on the X2 direction side of the arcuate shape portion 103b1, the discharge opening 103e which is a rectangular through hole communicating with the residual toner chamber 103b in the Y2 direction is provided. As shown in part (c) of FIG. 10, the discharge opening 103e communicates with a space 103f recessed in the Z2 direction. An opening of the discharge opening 103e on the Y2 direction side is formed on a surface 103a which is a flat surface shape perpendicular to the Y axis direction. To the surface 103a, an elastic seal 104 is mounted so as to enclose the discharge opening 103e. The elastic seal 104 has a plate shape formed with, for example, a foam member such as a sponge and is provided with a through hole 104a larger than the discharge opening 103e. Further, the elastic seal 104 is mounted to the surface 103a with an adhesive or the like so that he through hole 104a encloses the discharge opening 103e.

An inside surface 103q of the cleaning frame 103 forming the space 103f is provided with recessed portions 103g and 103h. The recessed portion 103g is disposed on an end portion side of the space 103f in the X2 direction and extends in the Z axis direction. The recessed portion 103h is disposed on an end portion side of the space 103f in the X1 direction and extends in the Z axis direction.

Further, as shown in part (d) of FIG. 10, in an end portion of the inside surface 103q in the X1 direction, projected portions 103p and 103y which project in the X2 direction and which have a substantially cylindrical shape are provided. At an end of the projected portion 103p, a claw portion 103p1 projecting from an outer peripheral surface of the projected portion 103p to an outside in a radial direction is provided. Further, at an end of the projected portion 103y, a claw portion 103y1 projecting from an outer peripheral surface of the projected portion 103y to an outside in a radial direction is provided.

Next, a shape of the cleaning frame 103 in the neighborhood of the discharge opening 103e will be described. As shown in FIG. 11, in an end portion of the inside surface 103q, on the X2 direction side, forming the space 103f of the cleaning frame 103, a circular recessed portion 103t recessed toward the X2 direction side is provided. Further, on the Z1 direction side of the recessed portion 103t, a projected portion 103u projected in the X1 direction is provided. In an end portion of the projected portion 103u in the Z1 direction, an inclined surface portion 103u1 extending in the Z2 direction toward the Y1 direction is provided.

Further, on a side opposite from the recessed portion 103t in the X axis direction, a projected portion 103v projected from the surface 103a in the Y2 direction is provided while sandwiching the discharge opening 103e between itself and the recessed portion 103t in the X axis direction. In an end portion of the projected portion 103v in the X2 direction, a projected portion 103v1 projected in the X2 direction is provided. Further, on the X1 direction side of the projected portion 103v of the cleaning frame 103, a projected portion 103w projected in the Z1 direction is provided. In an end portion of the projected portion 103w in the Z1 direction, a claw portion 103w1 projected in the Y1 direction is provided.

### Assembling of leaf spring to cleaning frame

Next, assembling of a leaf spring 141 to the cleaning frame 103 will be described using parts (a) and (b) of FIG. 12. Part (a) of FIG. 12 is an exploded perspective view showing the cleaning frame 103 and the leaf spring 141, and part (b) of FIG. 12 is a perspective view showing a state in which the leaf spring 141 is assembled to the cleaning frame 103.

As shown in part (a) of FIG. 12, the recessed portion 103g provided on the inside surface 103q of the cleaning frame 103 is constituted by a wall portion 103r extending in the Z axis direction. On the Z2 direction side of the wall portion 103r, a through hole 103r1 having a rectangular hole shape penetrating through the wall portion 103r in the Y axis direction is provided. As shown in parts (a) and (b) of FIG. 12, the leaf spring 141 is assembled into the through hole 103r1. The leaf spring 141 is formed by a metal plate which is a thin plate, and includes flat plate portions 141a and 141c and a projected portion 141b. The projected portion 141b is disposed between the flat plate portions 141a and 141c so as to connect the flat plate portions 141a and 141c. The flat plate portions 141a and 141c are disposed on the substantially same flat surface so that each of the flat plate portions 141a and 141c extends in the Z axis direction.

The projected portion 141b is constituted by two inclined surface portions 141b1 and 141b2, and has a mountain shape, which is constituted so that an angle formed between the inclined surface portion and an extended line of the flat plate portion 141a becomes about 45 degrees. As shown in part (b) of FIG. 12, the projected portion 141b of the leaf spring 141 is engaged into the through hole 103r1 of the cleaning frame 103. The flat plate portion 141a of the leaf spring 141 is fixed to the wall portion 103r of the cleaning frame 103 by an adhesive or the like. The flat plate portion 141c of the leaf spring 141 is disposed in contact with the wall portion 103r or with a slight gap between itself and the wall portion 103r.

### Assembling of idler gears to cleaning frame

Next, mounting of a first idler gear 108 and a second idler gear 118 to the cleaning frame 103 will be described. Part (a) of FIG. 13 is an exploded perspective view showing a state immediately before the first idler gear 108 and the second idler gear 118 are mounted to the cleaning frame 103. Part (b) of FIG. 13 is a perspective view showing a state in which the first idler gear 108 and the second idler gear 118 are mounted to the cleaning frame 103.

As shown in part (a) of FIG. 13, the first idler gear 108 and the second idler gear 118 are helical gears and includes round through holes 108b and 118b, respectively, in a central portion. The through hole 108b of the first idler gear 108 is engaged with the projected portion 103p of the cleaning frame 103. At this time, the claw portion 103p1 provided to the projected portion 103p is elastically deformed toward an inside of the projected portion 103p in a radial direction by the through hole 108b of the first idler gear 108. The claw portion 103p1 passes through the through hole 108b, so that the elastic deformation is released, and the claw portion 103p1 is projected toward the X2 side of the first idler gear 108 as shown in part (b) of FIG. 13. The claw portion 103p1 is disposed so as to overlap with the first idler gear 108 as viewed in the X axis direction. That is, at least a part of the claw portion 103p1 is positioned outside the through hole of the first idler gear 108 in the radial direction. By this, the first idler gear 108 is prevented frame coming off the cleaning frame 103 in the X axis direction, and is rotatably supported by the cleaning frame 103.

Next, the second idler gear 118 is assembled to the cleaning frame 103 in a method similar to the method for the first idler gear 108. Specifically, the second idler gear 118 is engaged with the projected portion 103y of the cleaning frame 103. At this time, the claw portion 103y1 provided to the projected portion 103y is elastically deformed toward an inside of the projected portion 103y in a radial direction by the through hole 118b of the second idler gear 118. The claw portion 103y1 passes through the through hole 118b, so that the elastic deformation is released, and the claw portion 103y1 is projected toward the X2 side of the second idler gear 118 as shown in part (b) of FIG. 13. The claw portion 103y1 is disposed so as to overlap with the second idler gear 118 as viewed in the X axis direction. That is, at least a part of the claw portion 103y1 is positioned outside the through hole of the second idler gear 118 in the radial direction. By this, the second idler gear 118 is prevented frame coming off the cleaning frame 103 in the X axis direction, and is rotatably supported by the cleaning frame 103.

The first idler gear 108 and the second idler gear 118 are in a state in which gear portions thereof are engaged with each other in a mounted state to the cleaning frame 103 and are capable of transmitting drive to each other.

### Assembling of discharge shutter to cleaning frame

Next, assembling of the discharge shutter 114 to the cleaning frame 103 will be described using parts (a) and (b) of FIG. 14. Part (a) of FIG. 14 is an exploded perspective view showing a state immediately before the discharge shutter 114 is assembled to the cleaning frame 103. Part (b) of FIG. 14 is a perspective view showing a state in which the discharge shutter 114 is assembled to the cleaning frame 103.

As shown in part (a) of FIG. 14, the discharge shutter 114 has a flat plate shape, and includes a flat plate portion 114a extending along an XZ plane perpendicular to the Y axis direction. In an end portion of the flat plate portion 114a in the Z1 direction and in an end portion of the flat plate portion 114a in the X2 direction, a projected portion 114b projected in the Z1 direction is provided.

In an end portion of the discharge shutter 114 in the Z2 direction, a cylindrical portion 114c projected in the X2 direction and a cylindrical portion 114d projected in the X1 direction are coaxially provided. To the cylindrical portion 114d, a torsion coil spring 115 is mounted. The torsion coil spring 115 includes a coil portion 115a wound around an axis extending in the X axis direction, an end portion wire 115b provided in an end portion of the coil portion 115a in the X2 direction, and an end portion wire 115c provided in an end portion of the coil portion 115a. The end portion wire 115b extends in the X2 direction, and the end portion wire 115c extends to the outside of the coil portion 115a in the radial direction.

As shown in parts (a) and (b) of FIG. 14, the coil portion 115a of the torsion coil spring 115 is engaged into the cylindrical portion 114d of the discharge shutter 114. Further, the cylindrical portion 114c of the discharge shutter 114 is inserted into the recessed portion 103t of the cleaning frame 103. At this time, the cylindrical portion 114d of the discharge shutter 114 is abutted against the claw portion 103w1 of the projected portion 103w in the Z2 direction from above the projected portion 103w while abutting against the projected portion 103v in the Y1 direction. The projected portion 103w is elastically deformed toward the Y2 direction by that the claw portion 103w1 is pressed in the Z2 direction by the cylindrical portion 114d. When the elastic deformation of the projected portion 103w is released by that the cylindrical portion 114d of the discharge shutter 114 gets over the claw portion 103w1 in the Z2 direction, the claw portion 103w1 and the cylindrical portion 114d overlap with each other as viewed in the Z axis direction.

That is, the cylindrical portion 114d of the discharge shutter 114 is engaged with the claw portion 103w1 in the Z axis direction, and in addition, is sandwiched between the projected portions 103v and 103w in the Y axis direction. By this, the discharge shutter 114 is prevented from coming off the cleaning frame 103 in the Z axis direction, and in addition, is positioned in the Y axis direction.

Further, as shown in part (b) of FIG. 14, the end portion wire 115b of the torsion coil spring 115 is abutted against a side surface of the flat plate portion 114a of the discharge shutter 114. Further, the end portion wire 115c of the torsion coil spring 115 is abutted against the projected portion 103v1 of the projected portion 103v in the rotational direction of the coil portion 115a. Further, the torsion coil spring 115 restricts movement of the discharge shutter 114 in the X1 direction. Thus, to the cleaning frame 103, the discharge shutter 114 is positioned in a state in which the discharge shutter 114 is rotatable about the cylindrical portions 114c and 114d.

At this time, the torsion coil spring 115 is in a charge state, so that on the discharge shutter 114, a rotational force about the cylindrical portions 114c and 114d relative to the cleaning frame 103 acts. For this reason, the flat plate portion 114a of the discharge shutter 114 is abutted against the elastic seal 104 provided to the cleaning frame 103, and the elastic seal 104 is crushed, so that residual toner in the residual toner chamber 103b is sealed.

### Residual toner conveying member

Next, the residual toner conveying member 106 will be described using FIG. 15. FIG. 15 is a perspective view showing the residual toner conveying member 106. As shown in FIG. 15, the residual toner conveying member 106 includes a cylindrical shaft portion 106a extending in the X axis direction, a screw portion 106b, and a reverse screw portion 106c. The screw portion 106b and the reverse screw portion 106c are integrally provided to the shaft portion 106a and each extends helically.

The reverse screw portion 106c is disposed downstream of the screw portion 106b with respect to the X2 direction and has a helical shape such that the reverse screw portion 106c is rotated in a direction opposite to a rotational direction of the screw portion 106b. The shaft portion 106a includes a shaft end portion 106a1 which is an end portion thereof in the X1 direction and a shaft end portion 106a2 which is an end portion thereof in the X2 direction. In an extreme end portion of the shaft end portion 106a1, a D-cut portion 106d is provided.

Further, between the screw portion 106b and the reverse screw portion 106c, a seat member 107 which is an elastic sheet is mounted to the shaft portion 106a by bonding or the like. The sheet member 107 is constituted by a plate-like elastic member, and one end thereof is fixed to the shaft portion 106a and the other end thereof becomes a free end. In opposite ends of the sheet member 107 in the X axis direction on the free end side, inclined surfaces 107a and 107b each extending obliquely with respect to the X axis direction are provided.

### Assembling of residual toner conveying member to cleaning frame

Next, assembling of the residual toner conveying member 106 to the cleaning frame 103 will be described using part (a) of FIGS. 16 to 18. Parts (a), (b), and (c) of FIG. 16 are sectional views showing a process in which the residual toner conveying member 106 is assembled to the cleaning frame 103. FIG. 17 is an exploded perspective view showing a state in which a residual toner gear 109 is assembled to the residual toner conveying member 106. FIG. 18 is a perspective view showing a side cover 112.

First, as shown in part (a) of FIG. 16, the shaft end portion 106a1 of the residual toner conveying member 106 is inserted into the through hole 103c of the cleaning frame 103. The residual toner conveying member 106 is inserted into the through hole 103c, and enters an inside of the residual toner chamber 103b as shown in part (b) of FIG. 16, so that a deformed state is released. Further, as shown in part (c) of FIG. 16, the shaft end portion 106a2 of the residual toner conveying member 106 is inserted into the recessed portion 103d1 of the cylindrical portion 103d. Thus, assembling of the residual toner conveying member 106 to the cleaning frame 103 is performed. Thereafter, to the cleaning frame 103, respective parts including the photosensitive drum 43 are mounted, but detailed description thereof will be omitted. Finally, to the residual toner conveying member 106, the residual toner gear 109 (see FIG. 17) is mounted.

As shown in FIG. 17, to an end surface of the cleaning frame 103 in the X1 direction, a drive input coupling 110 is mounted coaxially with the photosensitive drum 43. To the drive input coupling 110, a driving force from the apparatus main assembly A is inputted. Further, to an end portion of the photosensitive drum 43 in the X1 direction, a drum gear 113 having a helical gear shape is mounted coaxially with and integrally rotatable with the photosensitive drum 43.

Further, relative to the drum gear 113, on the Y2 direction side, the above-described first idler gear 108 is disposed while sandwiching the recessed portion 103j of the cleaning frame 103 between itself and the drum gear 113. A state in which the shaft end portion 106b1 of the residual toner conveying member 106 passing through the through hole 103c is projected from the cylindrical portion 103s of the cleaning frame 103 in the X1 direction is formed.

First, the seal member 111 is engaged into the X2 direction toward the shaft end portion 106b1, and thus is inserted into a hole portion 103s1 of the cylindrical portion 103s. Then, the seal member 111 is inserted until abuts against an end surface 103s2 of the hole portion 103s1. The seal member 111 is a cylindrical elastic member and is constituted by, for example, a foam material or the like, such as a sponge.

Further, a through hole 111a provided at a center of the seal member 111 has a smaller diameter than an outer diameter of the shaft end portion 106b1 of the residual toner conveying member 106, and therefore, the seal member 111 is engaged into the shaft end portion 106b1 while being expanded toward an outside in the radial direction. Further, an outer diameter of the seal member 111 is larger than an inner diameter of the cylindrical portion 103s, and therefore, the seal member 111 is assembled to the hole portion 103s1 of the cylindrical portion 103s while being crushed toward the inside in the radial direction.

Next, to the shaft end portion 106b1 of the residual toner conveying member 106. The residual toner gear 109 has a helical gear shape and is provided with a D-cut hole 109a which is a through hole in a central portion thereof. The D-cut hole 109a is engaged with the D-cut portion 106d provided to the shaft end portion 106b1 of the residual toner conveying member 106, so that the residual toner gear 109 becomes integrally rotatable with the residual toner conveying member 106. Further, a helical gear portion of the residual toner gear 109 is engaged with the drum gear 113 and the first idler gear 108, so that these three gears are in a state in which the three gears are capable of transmitting drive (driving force) to each other.

Further, to the cleaning frame 103, the side cover 112 is mounted in the X2 direction. As shown in FIGS. 17 and 18, the side cover 112 has a flat plate shape extending along the YZ plane perpendicular to X axis direction. On the Z1 direction side of the side cover 112, two cylindrical bosses 112a and 112b re projected in the X1 direction, and are disposed and arranged in the Y axis direction.

Further, the side cover 112 is provided with a projected portion 112c which is disposed on the Z2 direction side of the cylindrical bosses 112a and 112b and which is projected in the X2 direction. The projected portion 112c includes an arcuate shape portion 112c1 in an end portion thereof with respect to the Z1 direction. The projected portion 112c is provided with a cylindrical portion 112d coaxially with the arcuate shape portion 112c1. The cylindrical portion 112d is provided with a recessed portion 112d1 recessed in the X2 direction.

As shown in FIG. 17, the side cover 112 is mounted to the recessed portion 103j of the cleaning frame 103 in the X2 direction. At this time, the arcuate shape portion 112c1 of the side cover 112 is engaged into the arcuate shape portion 103k of the cleaning frame 103. Then, into the recessed portion 112d1 of the cylindrical portion 112d, the shaft end portion 106b1 of the residual toner conveying member 106 is inserted.

Further, the cylindrical bosses 112a and 112b of the side cover 112 are inserted onto the round recessed portion 103m and the long round recessed portion 103n, respectively, of the cleaning frame 103. The side cover 112 is abutted against the cleaning frame 103 in the X2 direction, and is fixed to the cleaning frame 103 by bonding or the like.

When the side cover 112 is abutted against the cleaning frame 103 in the X2 direction, the residual toner gear 109 is pressed in the X2 direction by the cylindrical portion 112d of the side cover 112. By this, in a state in which the side cover 112 is crushed, the residual toner gear 109 and the side cover 112 are assembled to the residual toner conveying member 106 and the cleaning frame 103, respectively. Thus, the seal member 111 is crushed by each of the cleaning frame 103, the residual toner conveying member 106, and the residual toner gear 109, and gaps therebetween are closed, so that the toner accommodated in the residual toner chamber 103b is sealed.

### Description of residual toner conveyance

Next, a residual toner conveyance constitution in the cleaning unit 60 will be described using FIGS. 9, 17, and 19. FIG. 19 is a sectional view showing the cleaning unit 60 including the residual toner conveying member 106. In FIG. 19, a cross section passing through the rotational axis of the residual toner conveying member 106.

As shown in FIGS. 9 and 19, the residual toner scraped off from the photosensitive drum 43 by the cleaning blade 17 is sent to the residual toner chamber 103b of the cleaning frame 103 by its own weight. The residual toner chamber 103b opposes a contact portion between the photosensitive drum 43 and the cleaning blade 17. In the residual toner chamber 103b, the residual toner conveying member 106 is disposed. When the photosensitive drum 43 is rotated in the R1 direction, the drum gear 113 rotates integrally with the photosensitive drum 43 is also rotated in the R1 direction. The drum gear 113 is engaged with the residual toner gear 109 and the first idler gear 108 so as to be capable of transmitting the driving force (drive transmission), and the photosensitive drum 43 is rotated, so that the residual toner gear 109 is rotated in the R2 direction which is an opposite direction to the R1 direction. Thus, the residual toner conveying member 106 rotatably supported integrally with the residual toner gear 109 is rotated in the R2 direction.

As shown in FIG. 19, the screw portion 106b is provided to the residual toner conveying member 106, and the screw portion 106b conveys the residual toner in the residual toner chamber 103b in the X2 direction by rotating the residual toner conveying member 106.

Further, on the X2 direction side of the residual toner conveying member 106, the reverse screw portion 106c is provided, and the reverse screw portion 106c conveys the residual toner in the residual toner chamber 103b in the X1 direction. The residual toner conveyed by the screw portion 106b and the residual toner conveyed by the reverse screw portion 106c collide with each other between the screw portion 106b and the reverse screw portion 106c, and are discharged through the discharge opening 103e.

Further, in a position opposing the discharge opening 103e, the above-described sheet member 107 is disposed. When the residual toner conveying member 106 is rotated, the sheet member 107 is bent in contact with the arcuate shape portion 103b1. Then, bending of the sheet member 107 in a free end portion thereof is released when the sheet member 107 moves toward the discharge opening 103e, so that the sheet member 107 discharges the residual toner vigorously. Thus, the residual toner is discharged from the cleaning frame 103 toward the outside of the cleaning frame 103 through the discharge openings 103e.

### Outline constitution of residual toner unit

Next, an outline constitution of the residual toner unit 120 will be described. Part (a) of FIG. 20 is a perspective view showing a residual toner frame 121, and part (b) of FIG. 20 is another perspective view showing the residual toner frame 121. FIG. 21 is a perspective view in which a neighborhood of a receiving opening 121h of the residual toner frame 121 is viewed in the Y2 direction.

As shown in FIG. 27 described later, the residual toner unit 120 includes the residual toner frame 121 and a residual toner lid 122, and the residual toner lid 122 is connected to the residual toner frame 121. First, the residual toner frame 121 will be described using parts (a) and (b) of FIG. 20. As shown in parts (a) and (b) of FIG. 20, the residual toner frame 121 has a trough-like shape extending in the X axis direction and is recessed in the Z2 direction. Further, inside the residual toner frame 121, a space 121a is formed.

In an end portion of the residual toner frame 121 with respect to the Z1 direction, an end surface 121b extending along the XY plane perpendicular to the Z axis direction so as to enclose the space 121a is provided. Further, in a downstream end portion with respect to each of the Z2 direction and the Y1 direction of the residual toner frame 121, a recessed portion 121e recessed in the Y2 direction is provided. An end surface 121f of the recessed portion 121e forms a surface perpendicular to the Y axis direction. In an end portion of the end surface 121f with respect to the X2 direction, a recessed portion 121g recessed in the Y2 direction is provided, and the recessed portion 121g is provided with a rectangular receiving opening 121h penetrating through the residual toner frame 121 in the Y axis direction.

In an edge portion of the receiving opening 121h, an elastic seal 123 is mounted so as to enclose the receiving opening 121h. The elastic seal 123 has a plate-like shape formed with a foam member such as a sponge, for example, and includes a through hole 123a larger than the receiving opening 121h. The elastic seal 123 is mounted to the residual toner frame 121 by bonding or the like so that the through hole 123a encloses the receiving opening 121h.

Further, on a side end surface of the residual toner frame 121 with respect to the X2 direction, a cylindrical boss 121c projected in the X2 direction and a projected portion 121d projected in the X2 direction are provided. The cylindrical boss 121c is provided in an end portion of the side end surface with respect to the Y2 direction and the Z2 direction. Further, the projected portion 121d is disposed downstream of the cylindrical boss 121c with respect to the Y1 direction. The projected portion 121d is provided with an inclined surface portion 121d1 inclined so as to oppose the cylindrical boss 121c.

As shown in part (b) of FIG. 20, on a side end surface of the residual toner frame 121 with respect to the X1 direction, a long round boss 121j, a cylindrical projection 121m, and two cylindrical bosses 121s and 121t, which are each projected in the X1 direction are provided. The boss 121j is provided in an end portion of the side end surface with respect to the Y2 direction and extends in the Z axis direction. Further, in a center of the cylindrical projection 121m, a through hole 121k penetrating through the residual toner frame 121 in the X axis direction is provided.

An inner diameter portion 121m1 of the cylindrical projection 121m has a diameter larger than a diameter of the through hole 121k, and in an end portion of the cylindrical projection 121m with respect to the X2 direction, an end surface 121m2 enclosing the through hole 121k is formed. The cylindrical bosses 121s and 121t are provided in opposite positions while sandwiching the cylindrical projection 121m therebetween. On an inner side surface of the residual toner frame 121 with respect to the X2 direction, a cylindrical portion 121p projected in the X1 direction is provided, and in a center of the cylindrical portion 121p, a recessed portion 121p1 recessed in the X2 direction.

As shown in FIG. 21, the recessed portion 121g of the residual toner frame 121 is provided with the receiving opening 121h. On the X2 direction side of the receiving opening 121h, a wall portion 121r extending in the Z axis direction and projecting in the Y1 direction is provided. In an end portion of the wall portion 121r with respect to the Z2 direction, a chamfered portion 121x is provided.

Further, on the Z1 direction side of the wall portion 121r, a circular through hole 121t penetrating through the wall portion 121r in the X axis direction is provided. On the X1 direction side of the recessed portion 121g, projected portions 121v and 121w projected in the Y1 direction are provided. The projected portion 121v includes a projected portion 121v1 projected in the Y1 direction and an end surface 121v2 constituting a lower surface of the projected portion 121v1. In an end portion of the projected portion 121w with respect to the Y1 direction, a claw portion 121w1 projected in the Z1 direction is provided.

### Residual toner shutter

Next, a residual toner shutter 129 for sealing the receiving opening 121h will be described using parts (a) and (b) of FIG. 22. Part (a) of FIG. 22 is an exploded perspective view showing the residual toner frame 121, the residual toner shutter 129, and a torsion coil spring 130. Part (b) of FIG. 22 is a perspective view showing a state in which the residual toner shutter 129 and the torsion coil spring 130 are assembled to the residual toner frame 121.

As shown in part (a) of FIG. 22, the residual toner shutter 129 has a flat plate shape and includes a flat plate portion 129a extending along the XZ plane residual toner the Y axis direction. In an end portion of the flat plate portion 129a with respect to the Z2 direction and the X2 direction, a cylindrical projected portion 129b projected in the X2 direction is provided.

In an end portion of the residual toner shutter 129 with respect to the Z1 direction, a cylindrical portion 129c projected in the X1 direction and a cylindrical portion 129d projected in the X2 direction are coaxially provided. To the cylindrical portion 129c, the torsion coil spring 130 is mounted. The torsion coil spring 130 includes a coil portion 130a wound around an axis thereof extending in the X axis direction, an end portion wire 130b provided at an end portion thereof with respect to the X2 direction, and an end portion wire 130c provided at an end portion thereof with respect to the X1 direction. The end portion wire 130b extends in the X2 direction, and the end portion wire extends in the X1 direction.

As shown in part (a) and (b) of FIG. 22, the coil portion 130a of the torsion coil spring 130 is engaged with the cylindrical portion 129c of the residual toner shutter 129. Then, the cylindrical portion 129d of the residual toner shutter 129 is inserted into the through hole 121t of the residual toner frame 121. At this time, the cylindrical portion 129c of the residual toner shutter 129 is abutted against the claw portion 121w1 of the projected portion 121w of the residual toner frame 121 in the Y2 direction while being abutted against the projected portion 121v in the Z1 direction. The projected portion 121w is elastically deformed in the Z2 direction by that the claw portion 121w1 is pressed in the Y2 direction by the cylindrical portion 129c. The cylindrical portion 129c gets over the claw portion 121w1 in the Y2 direction, and when the elastic deformation of the projected portion 121w is released, the claw portion 121w1 and the cylindrical portion 129c overlap with each other as viewed in the Y axis direction.

That is, the cylindrical portion 129d of the residual toner shutter 129 is engaged with the claw portion 121w1 in the Y axis direction, and in addition, is sandwiched between the projected portions 121v and 121w with respect to the Z axis direction. By this the residual toner shutter 129 is prevented from coming off of the residual toner frame 121 in the Y axis direction, and in addition, is positioned relative to the residual toner frame 121 with respect to the Z axis direction.

Further, the end portion wire 130b of the torsion coil spring 130 is abutted against a side surface of the flat plate portion 129a of the residual toner shutter 129. Further, the end portion wire 130c of the torsion coil spring 130 is abutted against the projected portion 121v1 of the projected portion 121v in the rotational direction of the coil portion 130a. Further, the torsion coil spring 130 restricts movement of the X axis direction of the residual toner shutter 129. Thus, the residual toner shutter 129 is supported in a state in which the residual toner shutter 129 is rotatable about the cylindrical portions 129c and 129d relative to the residual toner frame 121. At this time, the projected portion 129b of the residual toner shutter 129 is projected from the residual toner frame 121 in the X2 direction.

At this time, the torsion coil spring 130 is in a charge state, and a rotational force about the cylindrical portions 129c and 129d relative to the residual toner frame 121 acts on the residual toner shutter 129. For this reason, the flat plate portion 129a of the residual toner shutter 129 is abutted against the elastic seal 123 provided to the residual toner frame 121 and the elastic seal 123 is curved, so that the residual toner in the residual toner frame 121 is sealed.

### Description of stirring member

FIG. 23 is a perspective view showing a stirring member 124 mounted to the residual toner frame 121.

The stirring member 124 includes a pillar portion 124c formed in a rectangular shape in cross section and extending in the X axis direction. Further, the stirring member 124 includes a boss portion 124a provided on an end surface of the pillar portion 124c with respect to the X2 direction and a boss portion 124b provided on an end surface of the pillar portion 124c with respect to the X1 direction. These boss portions 124a and 124b are each formed in a cylindrical shape, and in addition, are disposed coaxially with each other. In an end portion of the boss portion 124b with respect to the X1 direction, a D-cut portion 124b1 is provided.

On one surface of the pillar portion 124c, a stirring sheet 125 is mounted by bonding or the like. The stirring sheet 125 is a substantially rectangular sheet extending in the X axis direction and is a flexible sheet. The stirring sheet 125 is formed partially short in an end portion thereof with respect to the X2 direction, and in the following, a shortly formed portion of the stirring sheet 125 is referred to as a short sheet portion 125a and a portion other than the short sheet portion 125a is referred to as a long sheet portion 125b. The stirring sheet 125 includes a plurality of inclined slits 125c each extending from a free end to a fixed end of the stirring sheet 125 in the X2 direction.

### Mounting of stirring member

Next, assembling (mounting) of the stirring member 124 to the residual toner frame 121 will be described using FIGS. 24 and 25. FIG. 24 is an exploded perspective view showing a state in which the stirring member 124 is assembled to the residual toner frame 121. FIG. 25 is an exploded perspective view showing the residual toner frame 121, a cylindrical seal 126, a stirring gear 127, and a side cover 128.

First, as shown in FIG. 24, the boss portion 124b of the stirring member 124 is inserted into the through hole 121k of the residual toner frame 121. Then, the boss portion 124a of the stirring member 124 is inserted into the recessed portion 121p1 of the residual toner frame 121. By this, the stirring member 124 is rotatably supported by the residual toner frame 121. The boss portion 124b of the stirring member 124 generates through the through hole 121k to an outside of the residual toner frame 121 in the X1 direction.

Next, as shown in FIG. 25, the cylindrical seal 126, the stirring gear 127, and the side cover 128 are mounted to the residual toner frame 121 in the X2 direction. The cylindrical seal 126 is a cylindrical elastic member, and is constituted by a foam material or the like, such as a sponge, for example. The cylindrical seal 126 includes an inner diameter portion 126a forming a through hole.

The stirring gear 127 is a gear having a helical gear portion and is provided with a through hole 127a having a D-cut shape in a central portion thereof. The side cover 128 includes flat plate portions 128a, 128e, and 128f each having a rectangular plate shape, pillars 128c and 128d extending in the X2 direction from opposite end portions of the flat plate portion 128a. The flat plate portion 128a is provided with a through hole 128b which is a round hole. The flat plate portions 128e and 128f in mutually spaced directions from end portions of the pillars 128c and 128d, respectively, with respect to the X2 direction. The flat plate portions 128e and 128f are provided with through holes 128g and 128h, respectively, penetrating in the X axis direction. The through hole 128g has a round hole shape, and the through hole 128h has a long round shape.

As shown in FIG. 25, an inner diameter portion 126a of the cylindrical seal 126 is inserted and engaged into the boss portion 124b of the stirring member 124 in the X2 direction, and the cylindrical seal 126 is inserted until the cylindrical seal 126 passes through the inner diameter portion 121m1 of the cylindrical projection 121m and is abutted against the end surface 121m2. The inner diameter portion 126a of the cylindrical seal 126 is a smaller diameter than an outer diameter of the boss portion 124b of the stirring member 124, and therefore, the cylindrical seal 126 is inserted and engaged into the boss portion 124b while being projected and expanded toward an outside in a radial direction. Further, an outer diameter of the cylindrical seal 126 is a large diameter than an inner diameter of the cylindrical projection 121m, and therefore, the cylindrical seal 126 is assembled in the cylindrical projection 121m of the residual toner frame 121 while being crushed toward an inside with respect to the radial direction.

Next, the stirring gear 127 is mounted to the boss portion 124b so that the D-cut portion 124b1 of the boss portion 124b of the stirring member 124 is inserted and engaged into the through hole 127a. By this, the stirring gear 127 becomes rotatable integrally with the stirring member 124.

Then, the side cover 128 is mounted to the residual toner frame 121 in the X2 direction. The cylindrical bosses 121s and 121t of the residual toner frame 121 are inserted into the through holes 128g and 128h, respectively, provided in the side cover 128, and the flat plate portions 128e and 128f of the side cover 218 are fixed to the residual toner frame 121 by bonding or the like. Further, the boss portion 124b generates through the through hole 128b of the side cover 128.

When the side cover 128 is abutted against the residual toner frame 121 in the X axis direction, the stirring gear 127 is projected in the X2 direction by the flat plate portion 128a.

By this, in a state in which the cylindrical seal 126 is crushed, the stirring gear 127 and the side cover 128 are assembled with the stirring member 124 and the residual toner frame 121, respectively. Thus, the cylindrical seal 126 is crushed by each of the residual toner frame 121, the stirring member 124, and the stirring gear 127, and gaps therebetween are closed, so that the toner in the residual toner unit 120 is sealed.

### Description of residual toner lid

Next, a constitution of the residual toner lid 122 will be described using FIG. 26. FIG. 26 is an exploded perspective view showing the residual toner lid 122 and parts assembled to the residual toner lid 122. The residual toner lid 122 has a rectangular plat plate shape extending in the X axis direction as shown in FIG. 26. The residual toner lid 122 includes grip portions 122a and 122b recessed in the Z2 direction in the neighborhood of a central portion with respect to the X axis direction.

Further, in an end portion of the residual toner lid 122 in the Z2 direction, a flange portion 122c forming an outermost configuration in the XY plane of the residual toner lid 122. Further, the residual toner lid 122 is provided with a projected portion 122d projected in the Z2 direction. The residual toner lid 122 is provided with a rectangular through hole 122e penetrating in the Z axis direction and a recessed portion 122f recessed in the Z2 direction so as to enclose the through hole 122e.

As shown in FIG. 26, to the residual toner lid 122, a light guide 132 is assembled. The light guide 132 is constituted by a transparent material and includes a rectangular plate portion 132a extending along the XY plane perpendicular to the Z axis direction. A cylindrical boss 132b and a rectangular pillar boss 132c which are projected from the plate portion 132a in the Z1 direction are arranged in the X axis direction. Further, two projected portions 132d and 132e are projected from the plate portion 132a in the Z2 direction. At ends of the projected portions 132d and 132e with respect to the Z2 direction, inclined surface portions 132d1 and 132e1 each forming an angle of about 45° with respect to the Z axis direction are provided, respectively.

Further, to the light guide 132, a black seal 133 is mounted in the Z2 direction. The black seal 133 has a sheet shape and has the substantially same size as a size of the plate portion 132a. The black seal 133 is provided with a round through hole 133b and a rectangular through hole 133c which penetrate through the black seal 133 in the Z axis direction.

The black seal 133 is mounted to the plate portion 132a of the light guide 132 by bonding or the like. At this time, the cylindrical boss 132b penetrates through the round through hole 133b, and the rectangular pillar boss 132c penetrates through the rectangular through hole 133c. Thus, the light guide 132 suppresses light from entering into the cylindrical boss 132b and the rectangular pillar boss 132c from directions other than the Z axis direction. The light guide 132 is inserted and engaged into the recessed portion 122f of the residual toner lid 122 in the Z2 direction, and is fixed with no gap by bonding or the like.

### Mounting of residual toner lid to residual toner frame

FIG. 27 is an exploded perspective view for illustrating mounting of the residual toner lid 122 to the residual toner frame 121. As shown in FIG. 27, the residual toner lid 122 is mounted to the residual toner frame 121 in the Z2 direction. The projected portion 122d of the residual toner lid 122 is inserted and engaged into a space 121a of the residual toner frame 121. By this, the residual toner lid 122 is positioned relative to the residual toner frame 121 in the X axis direction and the Y axis direction. In this state, the flange portion 122c of the residual toner lid 122 is mounted to the end surface 121b of the residual toner frame 121 by bonding or the like, so that the residual toner frame 121 and the residual toner lid 122 are integrated with each other.

### Mounting of residual toner unit to cleaning unit

Next, mounting of the residual toner unit 120 to the cleaning unit 60 will be described using FIG. 28 to part (d) of FIG. 29. FIG. 28 is an exploded perspective view showing the mounting of the residual toner unit 120 to the cleaning unit 60. Parts (a) to (d) of FIG. 29 are sectional views for illustrating an operation in a mounting process of the residual toner unit 120 to the cleaning unit 60. Parts (a) to (d) of FIG. 29 each shows a cross section perpendicular to the X axis direction, i.e., a cross section parallel to the YZ plane.

As shown in FIG. 28, the residual toner unit 120 is mounted to the cleaning frame 103 in the Z2 direction. At this time, the cylindrical boss 121c and the boss 121j of the residual toner frame 121 are inserted and engaged into the recessed portions 103g and 103h, respectively, of the cleaning frame 103.

As shown in parts (a) and (b) of FIG. 29, the residual toner unit 120 is moved in the Z2 direction so as to approach the cleaning frame 103 while the cylindrical boss 121c and the boss 121j are guided by the recessed portions 103g and 103h. At this time, a leaf spring 141 provided in the recessed portion 103g of the cleaning frame 103 is disposed in a position overlapping with a movement locus of the cylindrical boss 121c. As shown in part (c) of FIG. 29, the cylindrical boss 121c presses the leaf spring 141 with movement of the residual toner unit 120 in the Z2 direction. By this, the leaf spring 141 is rotated or deformed. When the cylindrical boss 121c gets over the leaf spring 141, the leaf spring 141 is restored to an original position as shown in part (d) of FIG. 29. By this, the cylindrical boss 121c is positioned on the Z2 direction side of the leaf spring 141, and in addition, overlaps with the leaf spring 141 with respect to the Z axis direction. Then, the mounting of the residual toner unit 120 to the cleaning unit 60 is completed.

### Connection between discharge opening and receiving opening

Next, connection between the discharge opening 103e of the cleaning unit 60 and the receiving opening 121h of the residual toner unit 120 will be described using parts (a) to (d) of FIG. 29. As shown in part (a) of FIG. 29, when the residual toner unit 120 is mounted to the cleaning unit 60 in the Z2 direction, the projected portion 129b is abutted against the inclined surface portion 103u1 of the projected portion 103u of the cleaning frame 103.

Further, when the residual toner unit 120 is moved in the Z2 direction, the projected portion 129b of the residual toner shutter 129 is moved on the inclined surface portion 103u1. By this, the residual toner shutter 129 is rotated in an arrow R10 direction.

Next, as shown in part (b) of FIG. 29, the projected portion 114b of the discharge shutter 119 provided to the cleaning frame 103 buts against the inclined surface portion 121d1 of the projected portion 121d of the residual toner frame 121 with respect to the Z axis direction. As shown in part (c) of FIG. 29, when the residual toner unit 120 is further moved in the Z2 direction, the projected portion 114b of the discharge shutter 114 is further moved on the inclined surface portion 121d1 of the discharge shutter 114. By this, the discharge shutter 114 is rotated about the cylindrical portions 114c and 114d in an arrow R11 direction.

As shown in part (d) of FIG. 29, when the residual toner unit 120 is in a positioned state to the cleaning unit 60, the receiving opening 121h of the residual toner frame 121 and the discharge opening 103e of the cleaning frame 103 oppose each other. By this, the receiving opening 121h and the discharge opening 103e are connected to each other, so that delivery of the residual toner becomes possible between the cleaning unit 60 and the residual toner unit 120.

At this time, the elastic seal 123 mounted to the receiving opening 121h and the elastic seal 104 mounted to the discharge opening 103e are pressed to each other, and are crushed against each other, so that the residual toner is sealed.

### Stirring of residual toner by stirring member

Next, stirring of the residual toner in the residual toner unit 120 by the stirring member 124 will be described using FIGS. 30 to part (b) of 32. FIG. 30 is a sectional view showing the residual toner unit 120 in the positioned state to the cleaning unit 60. Incidentally, FIG. 30 shows a cross section perpendicular to the Y axis. FIG. 31 is a perspective view showing the residual toner unit 120 in a state in which the residual toner lid 122 is omitted. Part (a) of FIG. 32 is a sectional view showing a 32A-32A cross section of FIGS. 31, and part (b) of 32 is a sectional view showing a 32B-32B cross section of FIG. 31.

As shown in FIG. 30, when the positioning of the residual toner unit 120 to the cleaning unit 60 is made, the helical gear portion of the stirring gear 127 and the helical gear portion of the second idler gear 118 are engaged with each other, so that a drive-transmittable state is formed.

The photosensitive drum 34 is rotated by the driving force transmitted from the apparatus main assembly A, so that the drum gear 113 is rotated in the R1 direction. When the drum gear 113 is rotated in the R1 direction, the residual toner gear 109 engaging with the drum gear 113 is rotated in the R2 direction. When the residual toner gear 109 is rotated in the R2 direction, the first idler gear 108 engaging with the residual toner gear 109 is rotated in an R3 direction. When the first idler gear 108 is rotated in the R3 direction, the second idler gear 118 engaging with the first idler gear 108 is rotated in an R4 direction. When the second idler gear 118 is rotated in the R4 direction, the stirring gear 127 engaging with the second idler gear 118 is rotated in an R5 direction.

As shown in FIG. 31, when the stirring gear 127 is rotated in the R5 direction, the stirring member 124 is also rotated in the R5 direction together with the stirring gear 127. The stirring sheet 125 mounted to the stirring member 124 is largely bent at the long sheet portion 125b relative to the short sheet portion 125a by the action of the plurality of inclined slits 125c when the stirring sheet 125 is rotated in the R5 direction. For this reason, on the stirring sheet 125, a surface inclined in the X1 direction during rotation is formed, so that the residual toner is conveyed in the X1 direction. Further, at the same time, the stirring sheet 125 is rotated in the R5 direction, so that the residual toner is also conveyed in the Z1 direction which is an upward direction.

Here, as shown in part (a) of FIG. 32, in a region where the receiving opening 121h is disposed in the residual toner frame 121, i.e., on the X2 direction side in the residual toner frame 121, the short sheet portion 125a of the stirring sheet 125 is disposed. The short sheet portion 125a is set to a length of a degree such that the short sheet portion 125a reaches an end surface (bottom) of the space 121a with respect to the Z2 direction, and conveys the residual toner in the Y2 direction which is a direction spaced away from the receiving opening 121h.

Further, as shown in part (b) of FIG. 32, the long sheet portion 125b is set so that an entering mount thereof into the end surface (bottom) of the space 121a with respect to the Z2 direction is larger than that of the short sheet portion 125a. For this reason, the long sheet portion 125b conveys the residual toner in the X1 direction and the Z1 direction while being bent in contact with an inside surface of the residual toner frame 121. Thus, the residual toner flowing into the residual toner unit 120 through the receiving opening 121h is gradually deposited from the end portion of the residual toner frame 121 with respect to the X1 direction.

### Remaining amount detection of residual toner

Next, a constitution for detecting a remaining amount of the residual toner in the residual toner unit 120 will be described using parts (a) and (b) of FIG. 33. Part (a) of FIG. 33 is a sectional view showing the residual toner unit 120 during deposition of the residual toner, and part (b) of FIG. 33 is a sectional view showing the residual toner unit 120 in which the residual toner becomes a full state. Each of parts (a) and (b) of FIG. 33 shows a cross section cut along the XZ plane perpendicular to the Y axis.

As shown in part (a) of FIG. 33, the residual toner is gradually deposited in the residual toner unit 120 from the X1 direction. The apparatus main assembly A (see part (a) of FIG. 1) includes a remaining amount detecting unit 150, and in a state in which the residual toner unit 120 is mounted to the cleaning unit 60, the light guide 132 is disposed below the remaining amount detecting unit 150.

The remaining amount detecting unit 150 includes a light emitting portion 151 for emitting light and a light receiving portion for receiving the light. The light emitting portion 151 opposes the cylindrical boss 132b, and the light receiving portion 152 opposes the rectangular pillar boss 132c. Light L1 emitted from the light emitting portion 151 of the remaining amount detecting unit 150 is incident on an upper end surface 132b1 of the cylindrical boss 132b of the light guide 132 mounted to the residual toner lid 122. The light L1 incident on the cylindrical boss 132b passes through the projected portion 132d and is reflected by the inclined surface portion 132d1, and then is incident on the projected portion 132e through the space 121a of the residual toner unit 120.

Thereafter, the light L1 incident on the projected portion 132e is reflected by the inclined surface portion 132e1 and is emitted from the upper end surface 132c1 of the rectangular pillar boss 132c. The light L1 emitted from the rectangular pillar boss 132c is received by the light receiving portion 152 of the remaining amount detecting unit 150. By this, the remaining amount detecting unit 150 detects that the light passed through the light guide 132.

As described above, the residual toner is deposited in the residual toner unit 120 from the X1 direction, and the light guide 132 is disposed on the X2 direction side of the residual toner unit 120. For this reason, in a state in which the remaining amount detecting unit 150 is capable of receiving the light L1 by the light receiving portion 152, the residual toner is not deposited to the light guide 132, so that the remaining amount detecting unit 150 is capable of detecting that the residual toner in the residual toner unit 120 is not still in the full state.

As shown in part (b) of FIG. 33, when the residual toner is deposited to the light guide 132, the light L1 is blocked by the residual toner between the projected portions 132d and 132e. Then, the light receiving portion 152 of the remaining amount detecting unit 150 cannot detect the light L1. By this, the remaining amount detecting unit 150 is capable of detecting that the residual toner in the residual toner unit 120 in the full state. When the full state of the residual toner in the residual toner unit 120 is detected by the remaining amount detecting unit 150, an operating panel 500 of the apparatus main assembly A displays warning indicating that the residual toner unit 120 is in the full state.

The user confirms this warming, and takes out the process cartridge B from the apparatus main assembly A, and then takes out the residual toner unit 120 from the process cartridge B in the Z1 direction. When the residual toner unit 120 is taken out from the process cartridge B, the receiving opening 121h is sealed by the residual toner shutter 129 in a reverse order to the order described with reference to parts (a) to (d) of FIG. 29. In addition, the discharge opening 103e of the cleaning unit 60 is sealed by the discharge shutter 114 in a reverse order to the order described with reference to parts (a) to (d) of FIG. 29.

As described above, the receiving opening 121h provided in the residual toner frame 121 in this embodiment is provided in a part of the residual toner frame 121 with respect to the X axis direction. Specifically, as shown in FIG. 20, the receiving opening 121h is provided in an end portion of the residual toner frame 121 with respect to the X2 direction. In other words, with respect to the X axis direction, the receiving opening 121h is disposed in a first region (area) AR1 on one side relative to a center (line) CP of the residual toner frame 121 (residual toner unit 120), and is not disposed in a second region (area) AR2 on the other side relative to the center CP.

Further, the detecting opening 121h has a length which is not more than 1/2 of an outer configuration dimension of the residual toner unit 120 with respect to the X axis direction. Preferably, the receiving opening 121h has a length which is not more than 1/3 of the outer configuration dimension of the residual toner unit 120 with respect to the X axis direction. More preferably, the receiving opening 121h has a length which is not more than 1/4 of the outer configuration dimension of the residual toner unit 120 with respect to the X axis direction. Thus, the receiving opening 121h is made shorter than a full length of the residual toner frame 121, so that toner leakage through the receiving opening 121h can be suppressed.

Further, the stirring member 124 is rotatably supported by the residual toner frame 121. The stirring member 124 conveys the residual toner from a first region AR1 side toward a second region AR2 side while stirring the residual toner. By this, the residual toner accommodated in the residual toner unit 120 is suppressed from being localized on the receiving opening 121h side, so that a space for accommodating the residual toner in the residual toner unit 120 can be efficiently utilized.

Further, to the stirring member 124, the stirring gear 127 as a gear portion is provided, and the stirring gear 127 is disposed in the second region AR2. Thus, the stirring gear 127 is disposed in a position apart from the receiving opening 121h, so that deposition of the residual toner on the stirring gear 117 is suppressed even when the residual toner is leaked out through the receiving opening 121h, and thus, inconveniences of the stirring member 124 can be suppressed.

Further, the residual toner lid 122 of the residual toner unit 120 is provided with the light guide 132 for guiding the light L1 emitted from the light emitting portion 151 of the remaining amount detecting unit 150 and the light guide 132 is disposed in the second region AR2. The residual toner accommodated in the residual toner unit 120 is gradually deposited from the X1 direction side, i.e., from the second region AR2 side, so that by disposing the light guide 132 in the first region AR1, the full state of the residual toner can be detected.

Further, as shown in FIG. 4, in an end portion of the cleaning frame 103 of the process cartridge B with respect to the X2 direction, the contact (point) unit 310 is disposed. That is, the contact unit 310 is disposed in the first region AR1. Thus, with respect to the X axis direction, the contact unit 310 is disposed on a non-driving side opposite from a driving side where the stirring gear 127 and the like are disposed so that a left-right weight balance of the process cartridge B can be achieved and thus a mounting/demounting operation property can be improved.

Further, as shown in FIG. 9, as viewed in the X axis direction, the residual toner unit 120 is disposed on a side opposite from the developing roller 16 while sandwiching the photosensitive drum 43 therebetween. For this reason, the process cartridge B can be downsized with respect to a height direction (Z axis direction), and in addition, the space for accommodating the process cartridge B provided in the apparatus main assembly A can be saved.

Here, as shown in FIG. 9, as viewed in the X axis direction, a rectilinear line passing through a center 12a of the charging roller 12 and the rotational axis E which is a center of the photosensitive drum 43 is defined as a first rectilinear line LN1. Further, a rectilinear line passing through a contact (point) C1 between the charging roller 12 and the photosensitive drum 43 and perpendicular to the first rectilinear line LN1 is defined as a second rectilinear line LN2. Of four regions into which a whole region is divided by the first rectilinear line LN1 and the second rectilinear line LN2, a region where the developing roller 16 and the charging roller 12 are absent is only a region P1. At this time, the receiving opening 121h is disposed only in the region P1. The receiving opening 121his thus disposed, so that the residual toner is conveyed in a space-saved region, and thus residual toner conveyance efficiency can be improved.

Further, as described with reference to FIGS. 28 to part (d) of 29, the residual toner unit 120 is detachably mounted relative to the cleaning frame 103 in the Z axis direction. The Z axis direction is a direction crossing (perpendicular to) both the X axis direction which is the rotational axis E of the photosensitive drum 43 and a J1 direction which is a mounting direction of the process cartridge B to the apparatus main assembly A. The residual toner unit 120 is mounted to and demounted from the cleaning frame 103 in the Z axis direction different from the J1 direction in which the process cartridge B is mounted to the apparatus main assembly A, so that erroneous mounting/demounting of the residual toner unit 120 is suppressed, and thus usability can be improved.

Thus, the residual toner unit 120 is detachably mounted to the cleaning frame 103. For this reason, compared with a constitution in which the residual toner unit 120 is detachably mounted to the apparatus main assembly A, a constitution provided to the apparatus main assembly A and for conveying the residual toner can be omitted, so that the apparatus main assembly A can be downsized.

The residual toner generates in proportion to an amount of the toner used, and therefore, when the toner cartridge C is upsized, the residual toner unit 120 may also be upsized. The residual toner unit 120 in this embodiment is mounted to the cleaning frame 103 so as to be exchangeable, and a residual toner accommodating space used in a general-purpose use method may only be needed to be ensured, so that the residual toner unit 120 can be downsized. Further, the toner cartridge C can be increased in volume while suppressing a size of the residual toner unit 120. Thus, according to this embodiment, the process cartridge B can be developed.

### Second embodiment

Next, a second embodiment of the present disclosure will be described. In the first embodiment, the constitution in which the residual toner unit 120 is mounted to and demounted from the cleaning unit 60 in the Z axis direction was employed, but in this embodiment, a residual toner unit was confirmed to be detachably mountable to a cleaning unit in the X axis direction. For this reason, as regards constituent elements similar to those in the first embodiment, these elements will be described by being omitted from illustration or by adding the same reference numerals or symbols to the drawings.

### Cleaning unit

First, a constitution of a cleaning unit 160 in the second embodiment will be described.

The cleaning unit 160 has the constitution similar to that in the embodiment 1 except for a constitution for supporting a residual toner unit 1120 (see FIG. 42) described alter so as to be detachably mountable thereto and a constitution for conveying the residual toner.

FIG. 34 is a sectional view showing a cleaning frame 1103 of the cleaning unit 160 in the second embodiment. Incidentally, FIG. 34 is the sectional view out along a plane passing through a residual toner chamber 1103b of the cleaning frame 1103. Part (a) of FIG. 35 is a perspective view showing the cleaning frame 1103, and part (b) of FIG. 35 is an enlarge perspective view showing a residual toner discharging member 1103x and a seal member 1104. FIG. 36 is a perspective view showing the cleaning frame 1103.

As shown in FIG. 34, the cleaning frame 1103 as a frame of the cleaning unit 160 in this embodiment includes the residual toner chamber 1103b in which the residual toner is conveyed. The residual toner chamber 1103b includes a rectilinear line portion 1103b1 extending in the X above-described direction, a curved portion 1103b2 curved in a U-shape, and a discharging portion 1103b3 formed by the residual toner discharging member 1103x. The curved portion 1103b2 connects an end portion of the rectilinear line portion 1103b1 with respect to the X2 direction and an end portion of the discharging portion 1103b3 with respect to the X2 direction.

The residual toner discharging member 1103x has a cylindrical shape and is projected to a space 1103f formed by the cleaning frame 1103. Into the space 1103f, the residual toner unit 1120 described later is inserted. The residual toner discharging member 1103x is provided with a discharge opening 1103e which is a rectangular through hole extending in the X1 direction and positioned on the Z2 direction side (lower side) as shown in parts (a) and (b) of FIG. 35.

Incidentally, in this embodiment, the rectilinear line portion 1103b1 and the curved portion 1103b2 of the residual toner chamber 1103b are formed by the cleaning frame 1103, but the present disclosure is not limited thereto. For example, by extending the residual toner discharging member 1103x, the rectilinear line portion 1103b1, the curved portion 1103b2, and the discharging portion 1103b3 of the residual toner chamber 1103b may also be formed by the residual toner discharging member 1103x. In this case, a portion forming the rectilinear line portion 1103b1 of the residual toner discharging member 1103x is constituted so as to penetrate through the cleaning frame 1103 in the X axis direction.

Further, in an end portion of the residual toner discharging member 1103x with respect to the X1 direction, a rib 1103x1 projected in the Z1 direction is provided. In an end portion of the rib 1103x1 with respect to the X1 direction, a chamfered portion 1103x2 is provided.

To the residual toner discharging member 1103x, a seal member 1104 is mounted so as to enclose the discharge opening 1103e. Further, on the X2 direction side of the discharge opening 1103e of the residual toner discharging member 1103x, an annular rib 1103x3 and a rib 1103x4 are provided. The annular rib 1103x3 is formed in a circular shape so as to cover an outer periphery of the residual toner discharging member 1103x, and the rib 1103x4 is projected in the Z1 direction, and in addition, extends in the X1 direction from the annular rib 1103x3.

As shown in FIG. 36, on an inside surface of the cleaning frame 1103 with respect to the Y direction, a pressing member 1119 projected in the Y2 direction is provided. The pressing member 1119 is projected in the Y2 direction by an unshown urging spring and is supported by the cleaning frame 1103 so as to be movable in the Y axis direction. The pressing member 1119 includes chamfered portions 1119a and 1119b in opposite ends thereof with respect to the X axis direction.

### Mounting of discharge shutter

Next, mounting of a discharge shutter 1114 to the residual toner discharging member 1103x will be described using FIG. 37 to part (b) of FIG. 38. FIG. 37 is an exploded perspective view showing the residual toner discharging member 1103x and the discharge shutter 1114. Part (a) of FIG. 38 is a perspective view showing the discharge shutter 1114, and part (b) of FIG. 38 is a sectional view showing the discharge shutter 1114.

Incidentally, part (b) of FIG. 38 is the sectional view cut along the XZ plane passing through a center of the discharge shutter 1114.

As shown in FIG. 37, to the residual toner discharging member 1103x, a compression spring 1115 and the discharge shutter 1114 are mounted. The compression spring 1115 is a coil spring, and an inner diameter of the compression spring 1115 is larger than an outer diameter of a cylindrical portion of the residual toner discharging member 1103x. An outer diameter of the compression spring 1115 is smaller than an outer diameter of the annular rib 1103x3.

The discharge shutter 1114 has a cylindrical shape about an axis extending in the X axis direction and includes an inner diameter portion 1114a and a flange 1114b projected to an outside thereof with respect to a radial direction. The flange 1114b is provided in an end portion of the discharge shutter 1114 with respect to the X1 direction.

As shown in part (a) of FIG. 38, the inner diameter portion 1114a of the discharge shutter 1114 is provided with a groove portion 1114c recessed in the Z1 direction, and the groove portion 1114c extends in the X axis direction. On an end portion side of the groove portion 1114c with respect to the X2 direction, a claw portion 1114d is provided so as to oppose the flange 1114b with respect to the X axis direction. The claw portion 1114d is projected in the Z2 direction and is provided with a chamfered portion 1114d1 in an end portion thereof with respect to the X1 direction as shown in part (b) of FIG. 38.

As shown in FIG. 37, the compression spring 1115 is engaged with an outer peripheral surface of the residual toner discharging member 1103x in the X2 direction. Further, the discharge shutter 1114 is engaged with the residual toner discharging member 1103x in the X2 direction so that the inner diameter portion 1114a thereof opposes the outer peripheral surface of the residual toner discharging member 1103x. The rib 1113x1 of the cleaning frame 1103 enters the groove portion 1114c of the discharge shutter 1114, and the discharge shutter 1114 is engaged with the residual toner discharging member 1103x in the X2 direction while being rotation-restricted. The compression spring 1115 is compressed between the annular rib 1103x3 and the discharge shutter 1114.

When the discharge shutter 1114 is further moved in the X2 direction, the rib 1103a4 of the cleaning frame 1103 enters the groove portion 1114c of the discharge shutter 1114. By this, the discharge shutter 1114 is engaged with the residual toner discharging member 1103x in the X2 direction while being rotation-restricted.

Next, the claw portion 1114d of the claw portion 1114d of the discharge shutter 1114 is abutted against the rib 1103x1 in the X axis direction. The chamfered portion 1114d1 of the claw portion 1114d and the chamfered portion 1103x2 of the rib 1103x1 are abutted against each other, so that the claw portion 1114d is elastically deformed in the Z1 direction. Then, the rib 1103x1 gets over the claw portion 1114d with respect to the X axis direction, so that as viewed in the X axis direction, the rib 1103x1 and the claw portion 1114d overlap with each other.

The discharge shutter 1114 is urged in the X1 direction by the compression spring 1115, and is abutted against the rib 1103x1, so that the discharge shutter 1114 is positioned relative to the residual toner discharging member 1103x with respect to the X axis direction. At this time, with the discharge opening 1103e provided in the residual toner discharging member 1103x, the discharge shutter 1114 overlaps with respect to the X axis direction. Then, the seal member 1104 is crushed by the discharge shutter 1111, so that the residual toner in the residual toner discharging member 1103x is sealed.

### Mounting of residual toner conveying member

Next, mounting of a residual toner conveying member 1106 in this embodiment will be described using FIGS. 39 to 41. FIG. 39 is a perspective view showing the residual toner conveying member 1106. FIG. 40 is an exploded perspective view showing assembling of a conveying gear 1109 to the cleaning frame 1103. FIG. 41 is a sectional view showing the residual toner conveying member 1106 in a state in which the residual toner conveying member 1106 is assembled with the residual toner chamber 1103b. Incidentally, FIG. 41 shows a cross section passing through a center line of the residual toner discharging member 1103x.

The residual toner conveying member 1106 is constituted by a helical metal coil spring and includes a coil portion 1106a as shown in FIG. 39. In one end of the residual toner conveying member 1106, an end axis portion 1106b passing through an axis of a coil portion 1106a and is perpendicular to the axis is provided.

As shown in FIG. 41, the residual toner conveying member 1106 is mounted to the residual toner chamber 1103b in a bent state. Next, to the cleaning frame 1103, as shown in FIG. 40, the seal member 111 and the conveying gear 1109 are mounted. On an end surface of the cleaning frame 1103 with respect to the X1 direction, a through hole 1103c and a cylindrical portion 1103s are provided similarly as in the above-described embodiment.

The conveying gear 1109 includes a disk-shaped helical gear portion 1109a perpendicular to the X axis direction, a first cylindrical portion 1109b projected in the X2 direction, and a second cylindrical portion 1109c smaller in diameter than the first cylindrical portion 1109b. The first cylindrical portion 1109b is projected from the helical gear portion 1109a in the X2 direction, and the second cylindrical portion 1109c is projected from the first cylindrical portion 1109b in the X2 direction. Centers of the helical gear portion 1109a, the first cylindrical portion 1109b, and the second cylindrical portion 1109c are provided coaxially with each other. In an end portion of the second cylindrical portion 1109c with respect to the X2 direction, a slit portion 1109d recessed in the X1 direction is provided.

The seal member 111 is assembled to the cylindrical portion 1113e while being crushed toward an inside thereof in a radial direction. Next, the conveying gear 1109 is assembled to the cleaning frame 1103 in the X2 direction. The second cylindrical portion 1109c of the conveying gear 1109 penetrates through a through hole of the seal member 111 and the through hole 1103c of the cleaning frame 1103. Then, the first cylindrical portion 1109b of the conveying gear 1109 is inserted and engaged with the inner diameter portion 1103s1 of the cylindrical portion 1103s, so that the seal member 111 is crushed in the X2 direction.

The slit portion 1109d in an end of the second cylindrical portion 1109c generates through the through hole 1103c and is projected into the residual toner chamber 1103b, and thus is engaged with the end axis portion 1106b of the residual toner conveying member 1106. By this, the residual toner conveying member 1106 becomes rotatable integrally with the conveying gear 1109.

Thereafter, similarly as in the first embodiment, the side cover 112 (see FIG. 17) is mounted to the cleaning frame 1103, and the conveying gear 1109 is rotatably supported by the cleaning frame 1103. Further, similarly as in the first embodiment, the conveying gear 1109 is engaged with the drum gear 113, the first idler gear 108, and a second idler gear 1118 so as to be drive-transmittable to each other.

Thus, the driving force inputted to the conveying gear 1109 is transmittable to the residual toner conveying member 1106. Here, as shown in FIG. 41, the second idler gear 1118 includes a helical gear portion engaging with the first idler gear 108 and a spur gear portion 1118a formed coaxially and integrally with the helical gear portion.

### Residual toner unit

Next, the residual toner unit 1120 in this embodiment will be described using FIG. 42. FIG. 42 is an exploded perspective view showing the residual toner unit 1120 in this embodiment. As shown in FIG. 42, the residual toner unit 1120 as a residual toner accommodating portion includes a residual toner frame 1121 and a residual toner lid 1122, and the residual toner lid 1122 is connected to the residual toner frame 1121. The residual toner frame 1121 has a trough shape recessed in the Z2 direction and includes a receiving opening 1121h which is a circular through hole in an end surface thereof with respect to the X2 direction.

To an end surface of the residual toner frame 1121 with respect to the X2 direction, the seal member 1123 is mounted by bonding or the like so as to enclose the receiving opening 1121h. The seal member 1123 has a cylindrical thin plate shape and is constituted by, for example, a foam material or the like, such as a sponge. Further, on the Z1 direction side of the receiving opening 1121h, two wall portions 1121b and 1121c projected in the X1 direction are provided and disposed and arranged in the Y axis direction.

The wall portions 1121b and 1121c are provided with U-shaped grooves 1121b1 and 1121c1, respectively, and each of the U-shaped grooves 1121b1 and 1121c1 has a U-character groove shape recessed in the Z2 direction. On the Y2 direction side of the wall portion 1121b, a projected portion 1121d projected in the X1 direction is provided. The projected portion 1121d is provided with a U-shaped groove 1121d1 constituting an arc including an axis in the X axis direction, and the U-shaped groove 1121d has a U-character groove shape recessed in the Z2 direction.

In a side surface of the residual toner frame 1121 with respect to the X1 direction, a through hole 1121k coaxial with an axis of an arcuate portion of the U-shaped groove 1121d1 is provided. The through hole 1121k is disposed in the substantially same position as the through hole 121k (see part (b) of FIG. 20) in the first embodiment in a cross section perpendicular to the X axis. On a side surface of the residual toner frame 1121 with respect to the X1 direction, a cylindrical projection 1121m having the same shape as the cylindrical projection 121m in the first embodiment is provided.

Further, from the side surface of the residual toner frame 1121 with respect to the X1 direction, a projected portion 1121f projected in the X1 direction is provided, and the projected portion 1121f is provided on the Y1 direction side than the cylindrical projection 1121m. The projected portion 1121fis provided with a recessed portion 1121f1 recessed in the Y2 direction. Further, in an end portion of the projected portion 1121f with respect to the X1 direction, a projected portion 1121f2 projected toward the Y1 direction surface is provided, and in a free end portion of the projected portion 1121f2, an arcuate portion 1121f3 is provided. The projected portion 1121f has the same shape on a cross section perpendicular to the Z axis direction.

### Residual toner shutter

Next, a residual toner shutter 1129 for sealing the receiving opening 1121h will be described using FIG. 42. As shown in FIG. 42, the residual toner shutter 1129 is mounted to the residual toner frame 1121 so as to be positioned on the X direction side of the seal member 1123. The residual toner shutter 1129 includes a round flat plate portion 1129a extending along the YZ plane and a cylindrical portion 1129b disposed on the Z1 direction side of the flat plate portion 1129a. The cylindrical portion 1129b extends in the Y axis direction. The cylindrical portion 1129b includes shaft portions 1129b1 and 1129b2 constituting end portions thereof with respect to the Y1 direction and the Y2 direction, respectively. To the shaft portion 1129b1, a torsion coil spring 1180 is provided.

The torsion coil spring 1130 includes a coil portion 1130a, a shaft portion 1130b provided in an end portion thereof in the Y1 direction, and a shaft portion 1130c provided on an end portion thereof in the Y2 direction. To the shaft portion 1129b1 of the residual toner shutter 1129, the coil portion 1130a of the torsion coil spring 1130 is inserted and engaged in the Y2 direction. Further, the shaft portions 1129b1 and 1129b2 of the residual toner shutter 1129 are inserted and engaged with the U-shaped grooves 1121b1 and 1121b2, respectively, of the residual toner frame 1121.

The shaft portion 1130c of the torsion coil spring 1130 is abutted against a surface of the flat plate portion 1129a on the X1 direction side. The shaft portion 1130b of the torsion coil spring 1130 is abutted against an end surface of the wall portion 1121b with respect to the X1 direction. At this time, the torsion coil spring 1130 is in a charge state, and on the residual toner shutter 1129, a rotational force about the cylindrical portion 1129b relative to the seal member 1123 acts. The seal member 1123 is pressed and crushed by the flat plate portion 1129a of the residual toner shutter 1129, so that the receiving opening is sealed by the residual toner shutter 1129.

When the flat plate portion 1129a is pressed in the X1 direction, the residual toner shutter 1129 becomes rotatable about the cylindrical portion 1129b against an urging force of the torsion coil spring 1130.

Further, to the residual toner frame 1121, a stirring member 1124 is mounted similarly as in the first embodiment.

The stirring member 1124 includes a pillar portion 1124c formed in a rectangular shape in cross section and extending in the X axis direction. Further, the stirring member 124 includes a boss portion 1124a provided on an end surface of the pillar portion 1124c with respect to the X2 direction and a boss portion 1124b provided on an end surface of the pillar portion 1124c with respect to the X1 direction. These boss portions 1124a and 1124b are each formed in a cylindrical shape, and in addition, are disposed coaxially with each other. In an end portion of the boss portion 1124b with respect to the X1 direction, a D-cut portion 1124b1 is provided similarly as in the first embodiment. Incidentally, to the stirring member 1124, a stirring sheet 1125 having a function similar to that of the stirring sheet 125 in the first embodiment.

The boss portion 1124b of the stirring member 1124 penetrates through the through hole 1121k of the residual toner frame 1121, and the boss portion 1124a of the stirring member 1124 is engaged with the U-shaped groove 1121b1.

Thus, the stirring member 1124 is supported rotatably about axes of the boss portions 1124a and 1124b by the residual toner frame 1121. To the D-cut portion of the boss portion 1124b of the stirring member 1124, a stirring gear 1127 is mounted. By this, the stirring gear 1127 is integrally rotatable with the stirring member 1124. The stirring gear 1127 is a cylindrical spur gear.

The residual toner lid 1122 has a flat plate shape and is provided in a Z1 direction end portion thereof with a rib 1122d forming an outermost configuration in the XY plane of the residual toner lid 1122. Further, the residual toner lid 1122 includes a first projection 1122a, a second projection 1122b, and a third projection 1122c provided in an end portion thereof with respect to the X1 direction. These first to third projections 1122a, 1122b, and 1122c are projected in the Z2 direction, and in addition, are arranged in the Y axis direction.

The residual toner lid 1122 is connected to the residual toner frame 1121 by mounting the rib 1122d to the residual toner frame 1121 by bonding or the like. At this time, the first projection 1122a, the second projection 1122b, and the third projection 1122c are engaged into the U-shaped grooves 1121b1, 1121c1, and 1121d1, respectively. The first projection 1122a and the second projection 1122b restricts motion of the cylindrical portion 1129b of the residual toner shutter 1129 in the Z axis direction. The third projection 1122c restricts motion of the boss portion 1124a of the stirring member 1124 in the Z axis direction.

Thus, the stirring member 1124 and the residual toner shutter 1129 become a state in which these members are positioned and supported in the residual toner unit 1120.

### Mounting of residual toner unit

Next, mounting of the residual toner unit 1120 to the cleaning unit 160 will be described using FIGS. 43 to 45. FIG. 43 is an exploded perspective view showing a state in which the residual toner unit 1120 is mounted to the cleaning unit 160 in the Z2 direction. Part (a) of FIG. 44 is a plain view showing a state in which the residual toner unit 1120 is mounted to the cleaning unit 160 in the X2 direction. Part (b) of FIG. 44 is a plan view showing a state in which mounting of the residual toner unit 1120 to the cleaning unit 160 in the Z2 direction is completed. FIG. 45 is a sectional view showing a state in which the mounting of the residual toner unit 1120 to the cleaning unit 160 is completed.

As shown in FIG. 43, when the residual toner unit 1120 is mounted to the cleaning unit 160, first, the residual toner unit 1120 is inserted in the space 1103f of the cleaning frame 1103 in the Z2 direction. At this time, the residual toner unit 1120 is inserted into the space 1103f so as not to interfere with the discharge shutter 1114. Thus, an operation for moving the residual toner unit 1120 in the Z2 direction as a crossing direction relative to the cleaning frame 1103 is referred to as a first operation.

An outer configuration dimension of the residual toner frame 1121 with respect to the Y axis direction is substantially the same as a length of the space 1103f in the Y axis direction. For this reason, the residual toner unit 1120 is inserted into the space 1103f, so that the residual toner unit 1120 is positioned by the cleaning frame 1103 with respect to the Y axis direction. Further, a bottom of the space 1103f has a shape corresponding to a bottom of the residual toner unit 120. For this reason, the residual toner unit 1120 is positioned by the cleaning frame 1103 with respect to the Z axis direction.

Further, as shown in part (a) of FIG. 44, the residual toner unit 1120 inserted into the space 1103f so that the pressing member 1119 is engaged in the recessed portion 1121f1 of the residual toner frame 1121. When the residual toner unit 1120 is inserted into the space 1103f, the stirring gear 1127 of the residual toner unit 1120 is engaged with the spur gear portion 1118a of the second idler gear 1118.

Next, as shown in part (b) of FIGS. 44 and 45, the residual toner unit 1120 is pressed into the X2 direction. Thus, an operation performed after the above-described first operation and for moving the residual toner unit 1120 in the X2 direction (direction of the rotational axis E) relative to the cleaning frame 1103 is referred to as a second operation. Then, as shown in FIG. 45, the residual toner discharging member 1103x supported by the cleaning frame 1103 enters the residual toner frame 1121 through the receiving opening 1121h. The residual toner discharging member 1103x contacts the residual toner shutter 1129, so that the residual toner shutter 1129 is rotated bout the cylindrical portion 1129b against an urging force of the torsion coil spring 1130 (see FIG. 42).

Further, the discharge shutter 1114 is moved in the X2 direction against an urging force of the compression spring 1115 by being pressed by a side surface of the residual toner frame 1121. By this, the discharge opening 1103e of the residual toner discharging member 1103x is not covered with the discharge shutter 1114, and thus is opened.

In this state, the discharge opening 1103e of the residual toner discharging member 1103x wholly enters an inside of the residual toner frame 1121. Further, as shown in parts (a) and (b) of FIG. 44, the pressing member 1119 is pressed by the arcuate portion 1121f3 and is moved in the Y1 direction against an urging force of an unshown urging spring by movement of the residual toner unit 1120 in the X2 direction. Then, the pressing member 1119 is moved in the Y2 direction by the urging force of the urging spring and is abutted against the arcuate portion 1121f3 after the arcuate portion 1121f3 passes through the pressing member 1119 in the X2 direction.

The residual toner unit 1120 receives the urging force in the X2 direction from the pressing member 1119 through the arcuate portion 1121f3 and receives the urging force in the X1 direction from the discharge shutter 1114. The urging force in the X1 direction received by the residual toner unit 1120 from the discharge shutter is not so larger than that the pressing member 1119 is moved in the Y1 direction by the arcuate portion 1121f3 of the residual toner unit 1120. Thus, the residual toner unit 1120 is positioned relative to the cleaning frame 1103 with respect to the X axis direction, so that the mounting of the residual toner unit 1120 to the cleaning frame 1103 is completed.

In other words, the residual toner unit 1120 is mounted to the cleaning frame 1103 by performing the first operation and the second operation.

Incidentally, even when the residual toner unit 1120 is moved in the X2 direction after being inserted in the space 1103f, engagement between the stirring gear 1127 and the spur gear portion 1118a of the second idler gear 1118 is maintained. This is because the stirring gear 1127 and the spur gear portion 1118a are constituted by spur gears.

Thereafter, the photosensitive drum 43 is rotated by a driving force transmitted from the apparatus main assembly A, whereby the stirring member 1124 and the residual toner conveying member 1106 are rotated. The residual toner scraped off from the photosensitive drum 43 by the cleaning blade 17 (see FIG. 3) is sent to the rectilinear line portion 1103b1 (see FIG. 34) of the residual toner chamber 1103b of the cleaning frame 1103 by a self-weight thereof.

When the residual toner conveying member 1106 is rotated, the residual toner in the residual toner chamber 1103b is conveyed toward the discharge opening 1103e, so that the residual toner is dropped into the residual toner frame 1121 by free fall thereof. The stirring member 1124 in the residual toner frame 1121 receives the driving force from the second idler gear 1118 and is rotated in the R5 direction (see FIG. 42) similarly as in the first embodiment. The residual toner in the residual toner frame 1121 is conveyed in the X1 direction by the stirring member 1124 and is deposited from the X1 direction side. Then, by the remaining amount detecting unit 150 (see part (a) of FIG. 33) similar to that in the first embodiment, it is possible to detect that the residual toner in the residual toner unit 1120 is in the full state.

As described above, the receiving opening 1121h provided in the residual toner frame 1121 in this embodiment is provided in a part of the residual toner frame 1121 with respect to the X axis direction. Specifically, as shown in FIG. 42, the receiving opening 1121h is provided in the side surface of the residual toner frame 1121 with respect to the X2 direction. In other words, with respect to the X axis direction, the receiving opening 121h is disposed in a first region (area) AR11 on one side relative to a center (line) CP of the residual toner frame 1121 (residual toner unit 1120), and is not disposed in a second region (area) AR12 on the other side relative to the center CP.

Further, the detecting opening 1121h has a length which is not more than 1/2 of an outer configuration dimension of the residual toner unit 1120 with respect to the X axis direction. Preferably, the receiving opening 1121h has a length which is not more than 1/3 of the outer configuration dimension of the residual toner unit 1120 with respect to the X axis direction. More preferably, the receiving opening 1121h has a length which is not more than 1/4 of the outer configuration dimension of the residual toner unit 1120 with respect to the X axis direction. Thus, the receiving opening 1121h is made shorter than a full length of the residual toner frame 1121, so that toner leakage through the receiving opening 1121h can be suppressed.

Further, the stirring member 1124 is rotatably supported by the residual toner frame 1121. The stirring member 1124 conveys the residual toner from a first region AR11 side toward a second region AR12 side while stirring the residual toner. By this, the residual toner accommodated in the residual toner unit 1120 is suppressed from being localized on the receiving opening 1121h side, so that a space for accommodating the residual toner in the residual toner unit 1120 can be efficiently utilized.

Further, to the stirring member 1124, the stirring gear 1127 as a gear portion is provided, and the stirring gear 1127 is disposed in the second region AR12. Thus, the stirring gear 1127 is disposed in a position apart from the receiving opening 1121h, so that deposition of the residual toner on the stirring gear 1117 is suppressed even when the residual toner is leaked out through the receiving opening 1121h, and thus, inconveniences of the stirring member 1124 can be suppressed.

Further, the residual toner lid 1122 of the residual toner unit 1120 is provided with the light guide 132 for guiding the light L1 emitted from the light emitting portion 151 of the remaining amount detecting unit 150 similarly as in the first embodiment. The light guide 132 is disposed in the second region AR12. The residual toner accommodated in the residual toner unit 1120 is gradually deposited from the X1 direction side, i.e., from the second region AR12 side, so that by disposing the light guide 132 in the first region AR11, the full state of the residual toner can be detected.

Further, similarly as in the first embodiment, in an end portion of the cleaning frame 1103 of the process cartridge B with respect to the X2 direction, the contact (point) unit 310 is disposed (see FIG. 4). That is, the contact unit 310 is disposed in the first region AR11. Thus, with respect to the X axis direction, the contact unit 310 is disposed on a non-driving side opposite from a driving side where the stirring gear 1127 and the like are disposed so that a left-right weight balance of the process cartridge B can be achieved and thus a mounting/demounting operation property can be improved.

Further, similarly as in the first embodiment, as viewed in the X axis direction, the residual toner unit 1120 is disposed on a side opposite from the developing roller 16 while sandwiching the photosensitive drum 43 therebetween (see FIG. 9). For this reason, the process cartridge B can be downsized with respect to a height direction (Z axis direction), and in addition, the space for accommodating the process cartridge B provided in the apparatus main assembly A can be saved.

Incidentally, as viewed in the receiving opening 1121h in the second embodiment may also be disposed only in the region P1. The receiving opening 1121h is thus disposed, so that the residual toner is conveyed in a space-saved region, and thus residual toner conveyance efficiency can be improved.

Further, as described with reference to FIG. 43 to part (b) of FIG. 44, the residual toner unit 1120 is moved relative to the cleaning frame 1103 in the Z2 direction, and thereafter is moved in the X2 direction, so that the residual toner unit 1120 is mounted to the cleaning frame 1103. The residual toner unit 1120 is moved relative to the cleaning frame 1103 in the Z2 direction and the X2 direction which are different from the J1 direction in which the process cartridge B is mounted to the apparatus main assembly A, so that erroneous mounting/demounting of the residual toner unit 1120 is suppressed, and thus usability can be improved.

Thus, the residual toner unit 1120 is detachably mounted to the cleaning frame 1103. For this reason, compared with a constitution in which the residual toner unit 1120 is detachably mounted to the apparatus main assembly A, a constitution provided to the apparatus main assembly A and for conveying the residual toner can be omitted, so that the apparatus main assembly A can be downsized.

### Other embodiments

Incidentally, even in either of the above-described embodiments, the residual toner on the photosensitive drum 43 is removed by the cleaning blade 17, but the present disclosure is not limited thereto. For example, instead of the cleaning blade 17, another cleaning member such as a cleaning brush may also be applied.

Further, even in either of the above-described embodiments, the receiving opening 121h or 1121h were disposed in the first region AR1 or AR11, but the present disclosure is not limited thereto. For example, the receiving openings 121h and 1121h may be disposed in the second regions AR2 and AR12, respectively, or may also be disposed so as to overlap with the centers CP of the residual toner units 120 and 1120, respectively. By this, it is possible to suppress contamination of both the contact unit 310 and the stirring gear 127 or 1127 with the toner. Depending on arrangement of the receiving opening 121h or 1121h, the conveying direction of the residual toner by the stirring member 124 or 1124 may also be changed.

Further, even in either of the above-described embodiments, the contact unit 310 was disposed in the first region AR1 or AR11, but the present disclosure is not limited thereto. For example, the contact unit 310 may also be disposed in the second region AR2 or AR12. Further, the stirring gears 127 and 1127 were disposed in the second regions AR2 and AR12, respectively, but the present disclosure is not limited thereto. For example, the stirring gears 127 and 1127 may also be disposed in the first regions AR1 and AR11, respectively.

Further, in the first embodiment, the receiving opening 121h was disposed only in the region P1 shown in FIG. 9, but the present disclosure is not limited thereto. For example, the receiving opening 121h may also be disposed extending from the region P1 to a region adjacent to the region P1.

Further, in the first embodiment, the residual toner unit 120 was mounted to and demounted from the cleaning frame 103 in the Z axis direction, but the present disclosure is not limited thereto. For example, the residual toner unit 120 may also be mounted to and demounted from the cleaning frame 103 in the Y axis direction or a direction perpendicular to the X axis.

Further, in the first embodiment, the residual toner conveying member 106 has the screw shape, but the present disclosure is not limited thereto. For example, instead of the residual toner conveying member 106, a metal coil or a sheet including a slit may also be applied.

Further, in the second embodiment, the residual toner conveying member 1106 was constituted by the metal coil, but the present disclosure is not limited thereto. For example, instead of the residual toner conveying member 1106, a screw or a sheet including a slit may also be applied.

Further, even in either of the above-described embodiments, the residual toner in the residual toner unit 120 or 1120 was conveyed by the stirring member 124 or 1124, but the present disclosure is not limited thereto. For example, instead of the stirring member 124 or 1124, a single screw or a plurality of screws, or a metal coil may also be applied.

Further, even in either of the above-described embodiments, the residual toner in the residual toner unit 120 or 1120 was detected by the remaining amount detecting unit 150 constituted by the light sensor, but the present disclosure is not limited thereto. For example, the remaining amount detecting unit 150 may also be constituted by a weight sensor for detecting a weight of the residual toner unit 120 or 1120, or a sensor of electrostatic capacitance type.

Further, even in either of the above-described embodiments, the process cartridge B and the toner cartridge C were constituted as separate members, but the present disclosure is not limited thereto. For example, the toner cartridge C is omitted, and a toner accommodating portion for accommodating the toner may also be provided integrally with the process cartridge B.

Further, the process cartridge B was constituted by integrally assembling the cleaning unit 60 and the developing unit 20, but the present disclosure is not limited thereto. For example, the developing unit 20 may also be constituted so as to be detachably mountable to the cleaning unit 60.

Further, the residual toner conveying constitution in the first embodiment and the residual toner conveying constitution in the second embodiment may also be replaced with each other or used in combination.

### Summary of the present disclosure

In the present disclosure, at least the following contents.

(Constitution 1)

A cartridge comprising:

a frame;

photosensitive drum supported by the frame so as to be rotatable about a rotational axis thereof;

a cleaning member configured to remove residual toner on the photosensitive drum;

a charging roller configured to electrically charge a surface of the photosensitive drum;

a developing roller configured to develop an electrostatic latent image on the photosensitive drum by supplying toner to the photosensitive drum;

a residual toner conveying member configured to convey the residual toner removed by the cleaning member in a direction of the rotational axis; and

a residual toner accommodating portion configured to accommodate the residual toner conveyed by the residual toner conveying member and detachably mounted to the frame,

wherein the residual toner accommodating portion includes a receiving opening, in a part thereof in the direction of the rotational axis, for receiving the residual toner conveyed by the residual toner conveying member.

(Constitution 2)

A cartridge comprising:

a frame;

a photosensitive drum supported by the frame so as to be rotatable about a rotational axis thereof;

a cleaning member configured to remove residual toner on the photosensitive member;

a charging roller configured to electrically charge a surface of the photosensitive drum;

a developing roller configured to develop an electrostatic latent image on the photosensitive drum by supplying toner to the photosensitive drum;

a residual toner conveying member configured to convey the residual toner removed by the cleaning member in a direction of the rotational axis; and

a residual toner accommodating portion configured to accommodate the residual toner conveyed by the residual toner conveying member and detachably mounted to the frame,

wherein the residual toner accommodating portion includes a receiving opening for receiving the residual toner conveyed by the residual toner conveying member, and

wherein as viewed in the direction of the rotational axis, of four regions obtained by division with a first rectilinear line passing through a center of the charging roller and a center of the photosensitive drum and a second rectilinear passing through a contact point between the charging roller and the photosensitive drum and perpendicular to the first rectilinear line, the receiving opening is provided only in the region in which the developing roller and the charging roller are absent.

(Constitution 3)

The cartridge according to the constitution 2, wherein the receiving opening is provided in a part of the residual toner accommodating portion in the direction of the rotation example.

(Constitution 4)

The cartridge according to any one of the constitutions 1 to 3, wherein in the direction of the rotational axis, the receiving opening has a length which is not more than 1/3 of an outer configuration dimension of the residual toner accommodating portion.

(Constitution 5)

The cartridge according to any one of the constitutions 1 to 4, wherein in the direction of the rotational axis, the receiving opening is provided in a first region on one side of the residual toner accommodating portion with respect to a center of the residual toner accommodating portion but is not provided in a second region on the other side of the residual toner accommodating portion with respect to the center of the residual toner accommodating portion.

(Constitution 6)

The cartridge according to the constitution, further comprising a stirring member configured to convey the residual toner, accommodated in the residual toner accommodating portion, from the first region toward the second region while stirring the residual toner.

(Constitution 7)

The cartridge according to the constitution, further comprising a gear portion mounted to the stirring member,

wherein the gear portion is provided in the second region.

(Constitution 8)

The cartridge according to the constitution 6 or 7, wherein the residual toner accommodating portion includes a light guide for guiding light for detecting the residual toner accommodated in the residual toner accommodating portion, and

wherein the light guide is provided in the first region.

(Constitution 9)

The cartridge according to any one of the constitutions 5 to 8, further comprising a contact point unit to which power is supplied from a main assembly to which the cartridge is mounted,

wherein the contact point unit is provided in the first region.

(Constitution 10)

The cartridge according to any one of the constitutions 1 to 9, wherein as viewed in the direction of the rotational axis, the residual toner accommodating portion is provided on a side opposite from the developing roller while sandwiching the photosensitive drum therebetween.

(Constitution 11)

The cartridge according to any one of the constitutions 1 to 10, wherein the residual toner accommodating portion is detachably mounted to the frame in a crossing direction crossing the direction of the rotational axis.

(Constitution 12)

The cartridge according to the constitution 11, wherein the crossing direction is a direction crossing both the direction of the rotation axis and a mounting direction in which the cartridge is mounted to a main assembly.

(Constitution 13)

The cartridge according to any one of the constitutions 1 to 10, wherein the residual toner accommodating portion is mounted to the frame by performing a first operation in which the residual toner accommodating portion is moved in a crossing direction crossing the direction of the rotational axis and a second operation which is performed after the first operation and in which the residual toner accommodating portion is moved in the direction of the rotational axis relative to the frame.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-030775, filed on February 27, 2025, which is hereby incorporated by reference herein in its entirety.

What is claimed is:

1. A cartridge comprising:
a frame;
a photosensitive drum supported by the frame so as to be rotatable about a rotational axis thereof;
a cleaning member configured to remove residual toner on the photosensitive drum;
a charging roller configured to electrically charge a surface of the photosensitive drum;
a developing roller configured to develop an electrostatic latent image on the photosensitive drum by supplying toner to the photosensitive drum;
a residual toner conveying member configured to convey the residual toner removed by the cleaning member in a direction of the rotational axis; and
a residual toner accommodating portion configured to accommodate the residual toner conveyed by the residual toner conveying member and detachably mounted to the frame,
wherein the residual toner accommodating portion includes a receiving opening, in a part thereof in the direction of the rotational axis, for receiving the residual toner conveyed by the residual toner conveying member.

2. The cartridge according to claim 1, wherein in the direction of the rotational axis, the receiving opening has a length which is not more than 1/3 of an outer configuration dimension of the residual toner accommodating portion.

3. The cartridge according to claim 1, wherein in the direction of the rotational axis, the receiving opening is provided in a first region on one side of the residual toner accommodating portion with respect to a center of the residual toner accommodating portion but is not provided in a second region on the other side of the residual toner accommodating portion with respect to the center of the residual toner accommodating portion.

4. The cartridge according to claim 3, further comprising a stirring member configured to convey the residual toner, accommodated in the residual toner accommodating portion, from the first region toward the second region while stirring the residual toner.

5. The cartridge according to claim 4, further comprising a gear portion mounted to the stirring member,
wherein the gear portion is provided in the second region.

6. The cartridge according to claim 4, wherein the residual toner accommodating portion includes a light guide for guiding light for detecting the residual toner accommodated in the residual toner accommodating portion, and
wherein the light guide is provided in the first region.

7. The cartridge according to claim 3, further comprising a contact point unit to which power is supplied from a main assembly to which the cartridge is mounted,
wherein the contact point unit is provided in the first region.

8. The cartridge according to claim 1, wherein as viewed in the direction of the rotational axis, the residual toner accommodating portion is provided on a side opposite from the developing roller while sandwiching the photosensitive drum therebetween.

9. The cartridge according to claim 1, wherein the residual toner accommodating portion is detachably mounted to the frame in a crossing direction crossing the direction of the rotational axis.

10. The cartridge according to claim 9, wherein the crossing direction is a direction crossing both the direction of the rotation axis and a mounting direction in which the cartridge is mounted to a main assembly.

11. The cartridge according to claim 1, wherein the residual toner accommodating portion is mounted to the frame by performing a first operation in which the residual toner accommodating portion is moved in a crossing direction crossing the direction of the rotational axis and a second operation which is performed after the first operation and in which the residual toner accommodating portion is moved in the direction of the rotational axis relative to the frame.

12. A cartridge comprising:
a frame;
a photosensitive drum supported by the frame so as to be rotatable about a rotational axis thereof;
a cleaning member configured to remove residual toner on the photosensitive drum;
a charging roller configured to electrically charge a surface of the photosensitive drum;
a developing roller configured to develop an electrostatic latent image on the photosensitive drum by supplying toner to the photosensitive drum;
a residual toner conveying member configured to convey the residual toner, removed by the cleaning member in a direction of the rotational axis; and
a residual toner accommodating portion configured to accommodate the residual toner conveyed by the residual toner conveying member and detachably mounted to the frame,
wherein the residual toner accommodating portion includes a receiving opening for receiving the residual toner conveyed by the residual toner conveying member, and
wherein as viewed in the direction of the rotational axis, of four regions obtained by division with a first rectilinear line passing through a center of the charging roller and a center of the photosensitive drum and a second rectilinear passing through a contact point between the charging roller and the photosensitive drum and perpendicular to the first rectilinear line, the receiving opening is provided only in the region in which the developing roller and the charging roller are absent.

13. The cartridge according to claim 12, wherein the receiving opening is provided in a part of the residual toner accommodating portion in the direction of the rotational axis.
